(19) United States
(12) Patent Application Publication
(10) Pub. No.: US 2026/0299878 A1
(43) Pub. Date: Oct. 1, 2026

(54) Multi-Zone Setup And Configuration Of Multi-Player Playback Devices

(71) Applicant: Sonos, Inc., Goleta, CA (US)

(72) Inventors: Chris Meyer, Carlsbad, CA (US); Travis Brown, Charlotte, NC (US); Jillian Garber, Seattle, WA (US); Jeffrey David, Boston, MA (US); Tani Hossain, Atlanta, GA (US); Steven Beckhardt, Santa Barbara, CA (US)

(21) Appl. No.: 19/552,944

(22) Filed: Feb. 27, 2026

Related U.S. Application Data
(60) Provisional application No. 63/778,979, filed on Mar. 27, 2025.
(60) Provisional application No. 63/778,990, filed on Mar. 27, 2025.

(51) Int. Cl. G06F 3/16; H04R 3/12; H04R 27/00; H04S 3/00; H04S 7/00

(52) U.S. Cl. CPC G06F 3/165; H04R 3/12; H04R 27/00; H04S 3/008; H04S 7/30; H04R 2227/005; H04S 2400/05

(57) ABSTRACT

Disclosed embodiments relate to Multi-Player Playback Devices, including the configuration, management, and operation thereof in connection with adding Multi-Player Playback Devices to playback zones in several implementation scenarios, assigning audio outputs to logical players, and assigning audio channels to audio outputs based on the implementation scenario. Embodiments include graphical user interfaces and functions related thereto as well as Multi-Player Playback Devices with application programming interfaces and functions related thereto.

### CROSS REFERENCE TO RELATED APPLICATIONS

This application claims priority to the following applications: (i) U.S. Provisional App. 63/778,979 titled “User Interface For Setup And Configuration Of Multi-Zone Playback Device,” filed on Mar. 27, 2025, and currently pending; and (ii) U.S. Provisional App. 63/778,990 titled “Multi-Zone Setup And Configuration Of Multi-Player Playback Devices,” filed on Mar. 27, 2025, and currently pending. The entire contents of U.S. Provisional Apps. 63/778,979 and 63/778,990 are incorporated herein by reference.

The present application is also related to and incorporates by reference the entire contents of the following applications: (i) U.S. Prov. App. 63/571,312 titled “Multi-Instance Architecture For Multi-Player Playback Device” (23-1007p), filed on Mar. 28, 2024, and currently pending; (ii) Int'l App. PCT/US2023/034181 titled “State Exchange Information Exchange Among Connected Devices” (23-0306-PCT) filed on Sep. 29, 2023, and published as WO 2024/073086 on Apr. 4, 2024; (iii) Int'l App. PCT/US2023/034170 titled “Playback System Architecture and Area Zone Configurations” (21-0703-PCT) filed on Sep. 29, 2023, and published as WO 2024/073078 on Apr. 4, 2024; (iv) U.S. application Ser. No. 18/478,063 titled “Multichannel Content Distribution” (22-0207) filed Sep. 29, 2023, and currently pending; (v) U.S. application Ser. No. 18/476,193 titled “Playback Systems with Dynamic Forward Error Correction” (22-0401), filed on Sep. 27, 2023, and currently pending; (vi) U.S. Prov. App. 63/502,347 titled “Area Zones” (22-1002p), filed on May 15, 2023, and now expired; (vii) U.S. application Ser. No. 18/001,160 titled “Control with Distributed Command Processing” (20-0612), filed Dec. 8, 2022, and issued as U.S. Pat. No. 12,075,109 on Aug. 27, 2024; (viii) U.S. Prov. App. 63/377,978, titled “Broker/Subscriber Model for Information Sharing and Management Among Connected Devices” (22-0606Ap), filed on Sep. 30, 2022, and now expired; (ix) U.S. Prov. App. 63/377,979, titled “Multiple Broker Deployment for Information Sharing and Management Among Connected Devices” (22-0606Bp), filed on Sep. 30, 2022, and now expired; (x) U.S. Prov. App. 63/377,948 titled “Playback System Architecture” (21-0703p), filed Sep. 30, 2022, and now expired; (xi) Int'l App. PCT/US2021/036392 titled “Control with Distributed Command Processing” (20-0612-PCT) filed Jun. 8, 2021, and published as WO 2021/2524823 on Dec. 16, 2021; and (xii) U.S. Prov. App. 63/112,459 titled “Control with Distributed Command Processing” (20-0612p), filed on Nov. 11, 2020, and now expired.

Aspects of the features and functions disclosed and described in the above-identified applications can be used in combination with the examples disclosed and described herein (and with each other in some instances) to improve the functionality and performance of playback devices, both individually and configured into playback systems comprising multiple playback devices, including but not limited to Multi-Player Playback Devices and systems comprising Multi-Player Playback Devices.

### FIELD OF THE DISCLOSURE

The present disclosure is related to consumer goods and, in some more particular examples, to methods, systems, products, features, services, and other elements relating to media playback systems, media playback devices, methods of operating media playback systems and devices, and various features and aspects thereof.

### BACKGROUND

Options for accessing and listening to digital audio in an out-loud setting were limited until in 2002, when SONOS, Inc. began development of a new type of playback system. Sonos then filed one of its first patent applications in 2003, titled “Method for Synchronizing Audio Playback between Multiple Networked Devices,” and began offering its first media playback systems for sale in 2005. The Sonos Wireless Home Sound System enables people to experience music from many sources via one or more networked playback devices. Through a software control application installed on a controller (e.g., smartphone, tablet, computer, voice input device), individuals can play most any music they like in any room having a networked playback device. Media content (e.g., songs, podcasts, video sound) can be streamed to playback devices such that each room with a playback device can play back corresponding different media content. In addition, rooms can be grouped together for synchronous playback of the same media content, and/or the same media content can be heard in all rooms synchronously.

### BRIEF DESCRIPTION OF THE DRAWINGS

Features, aspects, and advantages of the presently disclosed technology may be better understood with regard to the following description, appended claims, and accompanying drawings, as listed below. A person skilled in the relevant art will understand that the features shown in the drawings are for purposes of illustrations, and variations, including different and/or additional features and arrangements thereof, are possible.

FIG. 1A shows a partial cutaway view of an environment having a media playback system configured in accordance with aspects of the disclosed technology.

FIG. 1B shows a schematic diagram of the media playback system of FIG. 1A and one or more networks.

FIG. 1C shows a block diagram of a playback device.

FIG. 1D shows a block diagram of a playback device.

FIG. 1E shows a block diagram of a network microphone device.

FIG. 1F shows a block diagram of a network microphone device.

FIG. 1G shows a block diagram of a playback device.

FIG. 1H shows a partially schematic diagram of a control device.

FIG. 1-I through 1L show schematic diagrams of corresponding media playback system zones.

FIG. 1M shows a schematic diagram of media playback system areas.

FIG. 2A shows a front isometric view of a playback device configured in accordance with aspects of the disclosed technology.

FIG. 2B shows a front isometric view of the playback device of FIG. 3A without a grille.

FIG. 2C shows an exploded view of the playback device of FIG. 2A.

FIG. 3A shows a front view of a network microphone device configured in accordance with aspects of the disclosed technology.

FIG. 3B shows a side isometric view of the network microphone device of FIG. 3A.

FIG. 3C shows an exploded view of the network microphone device of FIGS. 3A and 3B.

FIG. 3D shows an enlarged view of a portion of FIG. 3B.

FIG. 3E shows a block diagram of the network microphone device of FIGS. 3A-3D.

FIG. 3F shows a schematic diagram of an example voice input.

FIGS. 4A-4D show schematic diagrams of a control device in various stages of operation in accordance with aspects of the disclosed technology.

FIG. 5 shows front view of a control device.

FIG. 6 shows a message flow diagram of a media playback system.

FIG. 7 shows a functional block diagram of an example Multi-Player Playback Device according to some embodiments.

FIG. 8A shows example Graphical User Interface screens for selecting a configuration type and naming a first zone during setup of a Multi-Player Playback Device according to some embodiments.

FIG. 8B shows example Graphical User Interface screens for selecting and assigning outputs to a zone during setup of a Multi-Player Playback Device according to some embodiments.

FIG. 8C shows example Graphical User Interface screens for configuring default channel assignments for a home theater setup during configuration of a Multi-Player Playback Device according to some embodiments.

FIG. 8D shows example Graphical User Interface screens for assigning specific audio channels to individual outputs in a custom home theater configuration according to some embodiments.

FIG. 8E shows example Graphical User Interface screens for configuring distributed audio zones using available audio outputs according to some embodiments.

FIG. 8F shows an example Graphical User Interface screen and a Multi-Player Playback Device in connection with identifying and confirming audio output connections according to some embodiments.

FIG. 8G shows example Graphical User Interface screens for adding audio outputs of a Multi-Player Playback Device and a separate zone player to an existing playback zone according to some embodiments.

FIG. 8H shows example Graphical User Interface screens for separating playback devices from an existing zone according to some embodiments.

FIG. 8I shows example Graphical User Interface screens for selecting and configuring audio outputs of a Multi-Player Playback Device for a zone according to some embodiments.

FIG. 8J shows example Graphical User Interface screens for managing system settings and hiding unused audio outputs of a Multi-Player Playback Device according to some embodiments.

FIG. 8K shows example Graphical User Interface screens for configuring a bonded home theater setup using multiple Multi-Player Playback Devices according to some embodiments.

FIGS. 9A-9D show flowcharts illustrating aspects of an example method for configuring various aspects of a Multi-Player Playback Device according some embodiments.

FIGS. 10A-10B show flowcharts illustrating aspects of an example method for configuring multiple Multi-Player Playback Devices into a single home theater playback zone according to some embodiments.

FIGS. 11A-11F show flowcharts illustrating aspects of an example method for using application programming interfaces to configure a Multi-Player Playback Device according to some embodiments.

FIG. 12 shows a flowchart illustrating aspects of a method for configuring home theater playback zones using application programming interfaces according to some embodiments.

The drawings are for the purpose of illustrating example configurations, but those of ordinary skill in the art will understand that the technology disclosed herein is not limited to the arrangements and/or instrumentality shown in the drawings.

### DETAILED DESCRIPTION

### I. Overview

Existing playback devices, examples of which include Sonos's intelligent playback devices, can be used to implement different types of groupings of playback devices configured to play audio content together with each other in a groupwise fashion. Playback groupings implemented with intelligent playback devices such as the playback devices available from Sonos are very flexible in terms of configuration options and the ability to play many different types of audio content, thereby enabling many different groupwise configurations for listening to many different types of audio content in many different types of listening environments. The introduction of new Multi-Player Playback Devices and the addition of logical player entities has enabled even more sophisticated playback groupings and configuration options.

Although these new Multi-Player Playback Devices and logical player entities provide more sophisticated playback grouping and configuration options as compared to existing playback devices, these new Multi-Player Playback Devices and logical player entities also present unique technical challenges because they implement a fundamentally different architecture compared to traditional playback devices.

When implementing traditional playback devices, there is typically a one-to-one relationship between the hardware device and an audio stream such that a traditional playback device plays only one audio stream (which audio stream may be a multi-channel audio stream). By contrast, a Multi-Player Playback Device implements a one-to-potentially-many relationship between the hardware device and an audio stream via the use of logical player entities, where a single physical device can implement multiple logical players that each play different audio streams (where each audio stream may be a multi-channel audio stream). Further, one logical player can include audio outputs from several Multi-Player Playback Devices, thereby introducing further complexity.

This one-to-potentially-many relationship between a Multi-Player Playback Device and logical players for audio streams requires more sophisticated configuration interfaces and management systems compared to traditional playback devices. The increased complexity arises from the need to properly assign and manage multiple logical players within a single physical device while maintaining system stability and avoiding resource conflicts.

The present application discloses improved techniques for configuring Multi-Player Playback Devices through complementary Graphical User Interfaces (GUIs) implemented by controller devices and Application Programming Interfaces (APIs) implemented by the Multi-Player Playback Devices. The GUIs and APIs enable flexible configuration of the Multi-Player Playback Device's independently configurable audio outputs into logical players that can be assigned to play specific audio streams in different playback zones.

The disclosed GUI implementations guide users through configuration processes for assigning physical audio outputs of Multi-Player Playback Devices to logical players, and further assign audio channels of an audio stream to individual physical audio outputs of Multi-Player Playback Devices. The GUI enables users to select configuration types (e.g., distributed audio, home theater, or both), name zones, assign specific outputs to zones, configure audio channel assignments, identify output connections, manage system settings, and implement bonded configurations using multiple Multi-Player Playback Devices.

For example, in one implementation, a controller device displays selectable configuration processes within a graphical user interface. Each configuration process, when selected, launches a different process for assigning audio outputs to audio channels within playback zones. After receiving zone selections, the controller obtains and displays available physical audio outputs of the Multi-Player Playback Device, and causes the Multi-Player Playback Device to implement logical players for the zones, assign the selected physical audio outputs to the logical player, and in some examples also assign individual audio channels of a multi-channel audio stream to individual physical audio outputs of the Multi-Player Playback Device that have been assigned to the logical player that has been configured to play the multi-channel audio stream.

The disclosed API implementations enable the Multi-Player Playback Device to maintain and update one or more configuration files that store settings for each physical audio output, including logical player and audio channel assignments. The configuration files, which can be accessible via one or more APIs, store logical player assignments, audio channel assignments, and zone assignments for each physical audio output of the Multi-Player Playback Device. The APIs implement sophisticated validation procedures to verify that configuration commands/instructions received from the controller device (e.g., via the disclosed GUI screens) comply with system limitations, detect potential conflicts, confirm hardware capabilities, and maintain system stability during configuration changes.

For example, in one implementation, a Multi-Player Playback Device maintains a configuration file storing settings including whether each audio output is assigned to a logical player and, for assigned outputs, the logical player assignment, audio channel assignment, and zone assignment. The Multi-Player Playback Device implements APIs that enable accessing and updating the configuration file in response to configuration commands received from controller devices.

Together, the GUI and API implementations solve several technical challenges unique to Multi-Player Playback Devices. First, they enable management of the complex one-to-potentially-many relationship between the physical Multi-Player Playback Device and one or more corresponding logical players to which the Multi-Player Playback Device has been assigned. Second, the GUI and API implementations facilitate flexible routing of different audio channels of an audio stream to different outputs while maintaining proper allocation and assignment of physical resources, e.g., audio outputs and their corresponding amplifiers, physical inputs (e.g., HDMI inputs in some instances), and computing resources for processing multi-channel streams (including sophisticated surround sound processing in some instances). Third, the GUI and API implementations coordinate configuration changes across multiple Multi-Player Playback Devices in bonded scenarios (i.e., where two or more Multi-Player Playback Devices have been bonded together to implement a single logical player) while preserving playback stability, for example, by enabling independent assignment of physical audio outputs such that configuring and assigning one audio output of a Multi-Player Playback Device does not affect the configuration or operation of other audio outputs of the Multi-Player Playback Device.

The disclosed systems and methods can be particularly advantageous in scenarios requiring flexible audio routing. For example, in a retail store environment, different areas can have tailored playlists matched to products or demographics, with storewide paging mixed into all zones. In a hotel environment, each guest room can play different content while common areas play ambient music, with the ability to quickly reconfigure zones for special events.

These implementations enable quick and easy changes between different configurations without requiring physical connection changes. In a listening area having speakers distributed throughout and connected to one or more Multi-Player Playback Devices, different audio content can be flexibly routed to each speaker to support different listening scenarios, and readily reconfigured between scenarios without disconnecting or reconnecting any physical connections. Moreover, because each of the physical audio outputs of a Multi-Player Playback Device is independently configurable via the disclosed GUI and API techniques, a first playback zone can be reconfigured independently of a second playback zone even in scenarios where a single physical Multi-Player Playback Device has physical audio outputs that have been assigned to both the first and second playback zones.

The following sections describe various aspects of Multi-Player Playback Devices, controller devices, graphical user interfaces, application programming interfaces, and methods of configuring and operating Multi-Player Playback Devices in more detail. While certain examples are described in the context of specific environments like homes, retail stores, and hotels, the technologies described herein may be implemented in other types of environments where multi-zone audio playback may be desirable.

### A. Relevant Nomenclature

Given the new concepts described herein, certain terminology is introduced and used for explaining various example features and embodiments. However, it should be understood that such terminology and the use thereof may be uniquely applicable in at least some respects to the examples described herein, such as when describing both existing concepts and new concepts. However, in other situations, the terminology may be more broadly applicable to other examples, depending on the context.

### i. Playback Device

To help illustrate aspects of some embodiments, a playback device as used herein sometimes refers to a single, physical hardware device that is configured to play audio. Such a playback device includes one or more network interfaces, one or more processors, and tangible, non-transitory computer-readable media storing program instructions that are executed by the one or more processors to cause the playback device to perform certain playback device features and functions.

In some embodiments, a playback device includes integrated speakers. In other embodiments, a playback device includes speaker outputs that connect to external speakers. In still further embodiments, a playback device includes a combination of integrated speakers and speaker outputs that connect to external speakers.

In some instances, a playback device may be (or may include) a set of headphones. In some instances, a playback device may be (or may include) a smartphone, tablet computer, laptop/desktop computer, smart television, or other type of device configurable to play audio content.

In some embodiments, a playback device comprises one or more microphones configured to receive voice commands. In some instances, playback devices with microphones are referred to herein as Networked Microphone Devices (NMDs). In some NMD embodiments, the NMD is configured to perform any (or all) of the playback device functions disclosed herein.

Additional details about playback devices consistent with some example embodiments are disclosed and described herein.

### ii. Logical Player

A logical player as used herein sometimes refers to a logical playback entity implemented by one or more physical playback devices to act as a single entity to play one stream of audio. In some instances where the one stream of audio comprises multichannel audio having two or more channels and the player includes two or more channel outputs, playing the multichannel audio includes the player playing the two or more channels via two or more corresponding channel outputs. In some instances, a single physical playback device implements a single logical player. In other instances, several physical playback devices may be configured to implement a single logical player. In still further instances, one physical playback device (i.e., a Multi-Player Playback Device) may implement several logical players.

Additional details about logical players consistent with some example embodiments are disclosed and described herein.

### iii. Multi-player Playback Device

A Multi-Player Playback Device as used herein refers to a type of physical playback device comprising multiple configurable audio outputs, one or more processors, and tangible, non-transitory computer readable media storing program instructions that are executed by the one or more processors to cause the Multi-Player Playback Device to perform the Multi-Player Playback Device features and functions described herein. In scenarios where a playback device might be referred to as a zone player, the Multi-Player Playback Device may sometimes be referred to as a Multi-Zone Player.

In operation, the multiple audio outputs can be grouped together in different combinations to implement one or more logical players. In some embodiments, a single Multi-Player Playback Device is configurable to implement one or more logical players (e.g., from one to eight logical players). Multi-Player Playback Devices according to some embodiments include eight configurable audio outputs. Multi-Player Playback Devices according to other embodiments include fewer than eight configurable audio outputs or more than eight configurable audio outputs. For example, in some embodiments, a Multi-Player Playback Device may include anywhere from two to six, eight, twelve, sixteen, eighteen, twenty-four, or more configurable audio outputs. Multi-Player Playback Devices with more or fewer audio outputs than those specifically identified herein are possible as well.

Additional details about Multi-Player Playback Devices consistent with some example embodiments are disclosed and described herein and also in U.S. Provisional App. 63/502,347, titled “Area Zones,” referred to as Docket No. 22-1002p, filed on May 15, 2023, the contents of which are incorporated herein by reference.

### iv. Playback Entity

A playback entity as used herein sometimes refers to a logical or physical entity configured to play audio. Playback entities include physical playback devices, physical Multi-Player Playback Devices, and logical players that are implemented via one or more Multi-Player Playback Devices.

Additional details about playback entities consistent with some example embodiments are disclosed and described herein and also in U.S. Provisional App. 63/502,347, titled “Area Zones,” referred to as Docket No. 22-1002p, filed on May 15, 2023, the contents of which are incorporated herein by reference.

### v. Zone

As another example, a zone (sometimes referred to herein as a playback zone or a bonded zone) as used herein sometimes refers to a logical container of one or more logical or physical playback entities that are managed together. In some examples, a zone can be a semi-permanent collection of the one or more playback entities. In some instances, and in some of the examples described herein, a zone may include only a single playback entity (e.g., only a single, physical playback device). Thus, in operation, a zone may include any one or more playback entities managed as a logical zone entity, including, for example, (i) a single playback entity/device managed as a logical zone entity, (ii) a group of playback entities/devices managed as a logical zone entity, including but not limited to any of (a) a bonded zone that includes two or more playback entities/devices configured to play the same audio, (b) a bonded pair of two playback entities/devices configured to play the same audio, (c) a stereo pair of two playback devices where one of the playback entities/devices is configured to play a left channel of stereo audio content and the other playback device is configured to play a right channel of stereo audio content, or (d) a home theater zone that includes two or more playback entities/devices configured to play home theater and/or surround sound audio content.

In this manner, in some examples, a zone is a type of logical entity implemented by one or more playback entities (e.g., playback devices). When the zone includes two or more playback entities, the two or more playback entities play one stream of audio content. In some instances, the one stream of audio content played by the zone comprises multichannel audio. In some zone scenarios that include two or more playback devices where the one stream of audio content comprises multichannel audio, each playback device (of the two or more physical playback devices) may be configured to play a different channel of the multichannel audio content.

For example, a first physical playback device in the zone may be configured to play a left channel of the audio content and a second physical playback device in the zone may be configured to play a right channel of the audio content. This type of example zone configuration is sometimes referred to as a stereo pair.

In another example, a first playback device in the zone may play a left channel, a second playback device in the zone may play a right channel, and a third playback device in the zone may play a subwoofer channel. This type of example zone configuration is sometimes referred to as a home theater zone.

In some existing zone configurations, each of the individual playback entities/devices within the zone communicate with each other in a fully connected control plane configuration to exchange commands, configuration information, events, and state information to each other via dedicated websocket connections between each pair of playback devices within the zone.

Additional details about zones consistent with some example embodiments are disclosed and described herein and in U.S. Provisional App. 63/502,347, titled “Area Zones,” referred to as Docket No. 22-1002p, filed on May 15, 2023, the contents of which are incorporated herein by reference.

### vi. Playback Group

A playback group (sometimes referred to herein simply as a group) is a logical container of two or more logical or physical playback entities. In some examples, a group can be a temporary collection of the one or more playback entities. Logical and physical entities that can grouped into a playback group include: (i) a zone, (ii) a playback device, (iii) a Multi-Player Playback Device, and/or (iii) a logical player.

A playback group can differ from a zone in a few ways. First, a zone can include one or more logical or physical playback entities (e.g., playback devices, logical players, etc.), whereas a playback group can include two or more logical or physical playback entities and/or zones. Second, when one or more playback devices are configured into a zone, the playback system treats the zone as a single logical entity even though the zone may include several physical playback devices and/or logical players. By contrast, when two or more playback entities are configured into a group, the playback system manages each playback entity separately even though each of the playback entities within the playback group are playing the same audio stream.

Similar to playback devices configured into a zone, all of the playback entities within a playback group are configured to play the same audio stream. In some instances, the audio stream comprises multichannel audio. In some scenarios where the audio stream comprises multichannel audio, each zone, playback device, Multi-Player Playback Device, or logical player in the playback group is configured to play the same set of audio channels.

In some example playback group implementations, the playback group includes a group coordinator and one or more group members. The group coordinator sources audio for the playback group and manages certain configuration and control functions for the group member(s) in the playback group. However, other playback group implementations may distribute audio among the group and handle configuration and control functions differently.

Similar to a zone configuration (described above), and in contrast to an Area Zone configuration (described further herein), each of the individual playback devices within a playback group communicate with each other in a fully-connected configuration to exchange commands, configuration information, events, and state information with each other via dedicated websocket connections (or similar communication links/sessions) between each of the playback devices within the playback group. For example, a playback group with four playback devices in some playback group configurations would include six dedicated websocket connections (or similar communication links/sessions) for a fully-connected mesh between all four playback devices, e.g., dedicated connections between (i) playback device 1 and playback 2, (ii) playback device 1 and playback device 3, (iii) playback device 1 and playback device 4, (iv) playback device 2 and playback device 3, (v) playback device 2 and playback device 4, and (v) playback device 3 and playback device 4.

Additional details about playback groups consistent with some example embodiments are disclosed and described herein and in U.S. Provisional App. 63/502,347, titled “Area Zones,” referred to as Docket No. 22-1002p, filed on May 15, 2023, the contents of which are incorporated herein by reference.

### vii. Controller Device

A controller device (sometimes referred to herein as a controller or a control device) is a computing device or computing system with one or more processors and tangible, non-transitory computer readable media storing program instructions executable by the one or more processors to execute the controller device features and functions described herein. In some scenarios, a controller device is a smartphone, tablet computer, laptop computer, desktop computer, smartwatch, or similar computing device configured to execute a software user interface for configuring and controlling playback entities within a playback system. In some scenarios, a controller device may include one or more cloud server systems configured to communicate with one or more playback entities to configure and control the playback system.

In operation, user inputs associated with commands for configuring and controlling playback entities within a playback system can take a variety of forms, including but not limited to (i) physical inputs (e.g., actuating physical controls like knobs, sliders, buttons and so forth) (ii) software user interface inputs (e.g., inputs on a touch screen or similar graphical user interface), (iii) voice inputs, (iv) inputs received from another playback entity in the playback system (e.g., in the form of signaling from the playback entity to the controller in connection with effectuating configuration and control commands) and/or (v) any other type of input in any other form now known or later developed that is sufficient for conveying commands for configuring and controlling playback entities.

Additional details about area controller devices consistent with some example embodiments are disclosed and described herein and in U.S. Provisional App. 63/502,347, titled “Area Zones,” referred to as Docket No. 22-1002p, filed on May 15, 2023, the contents of which are incorporated herein by reference.

### B. Related Art

The above-described example configurations as well as additional and alternative example configurations are described in more detail herein. Aspects of the features and functions implemented in the example configurations disclosed herein differ from prior implementations in several ways.

For example, with respect to streaming audio content and playback timing to individual playback devices, U.S. application Ser. No. 10/816,217, titled “System And Method For Synchronizing Operations Among A Plurality Of Independently Clocked Digital Data Processing Devices,” referred to as Docket No. 04-0401, filed on Apr. 1, 2004, and issued on Jul. 31, 2012, as U.S. Pat. No. 8,234,395, describes, inter alia, independently-clocked playback devices that are configured to play audio content in synchrony with each other based on playback timing and clock timing information. However, U.S. application Ser. No. 10/816,217 does not describe the GUI and API features and embodiments disclosed herein to facilitate the configuration of the playback configuration scenarios described herein, including but not limited the configuration and control of playback zone configurations with Multi-Player Playback Devices. The entire contents of U.S. application Ser. No. 10/816,217 are incorporated herein by reference.

Similarly, with respect to groupwise control of groups of playback devices within a playback system, U.S. application Ser. No. 10/861,653, titled “Method And Apparatus For Controlling Multimedia Players In A Multi-Zone System,” referred to as Docket No. 04-0601, filed on Jun. 5, 2004, and issued on Aug. 4, 2009, as U.S. Pat. No. 7,571,014, describes, inter alia, groupwise control of multiple playback devices, including groupwise volume control of playback devices configured within a group of playback devices configured to play audio content in synchrony with each other, sometimes referred to as a synchrony group. However, U.S. application Ser. No. 10/861,653 does not describe the GUI and API features and embodiments disclosed herein to facilitate the configuration of the playback configuration scenarios described herein, including but not limited the configuration and control of playback zone configurations with Multi-Player Playback Devices. The entire contents of U.S. application Ser. No. 10/861,653 are incorporated herein by reference.

Other aspects of groupwise control of groups of playback devices are described in U.S. application Ser. No. 13/910,608, titled “Satellite Volume Control,” referred to as Docket No. 13-0413, filed on June. 5, 2013, and issued on Sep. 6, 2016, as U.S. Pat. No. 9,438,193. For example, U.S. application Ser. No. 13/910,608 discloses, inter alia, controlling playback volume of grouped playback devices, including propagating a volume adjustment received via a first playback device to other playback devices that have been grouped with the first playback device. However, U.S. application Ser. No. 13/910,608 does not describe the GUI and API features and embodiments disclosed herein to facilitate the configuration of the playback configuration scenarios described herein, including but not limited the configuration and control of playback zone configurations with Multi-Player Playback Devices. The entire contents of U.S. application Ser. No. 13/910,608 are incorporated herein by reference.

Further, several earlier-filed applications describe aspects of specialized groupings of playback devices within a playback system. For example, U.S. application Ser. No. 13/013,740, titled “Controlling and grouping in a multi-zone media system,” referred to as Docket No. 11-0101, filed on Jan. 25, 2011, and issued on Dec. 1, 2015, as U.S. Pat. No. 9,202,509, describes, inter alia, configuring and operating two playback devices in a “paired” configuration such as a “stereo pair” configuration, where one playback device is configured to play a right stereo channel of audio content and the other playback device is configured to play a left stereo channel of audio content.

Similarly, U.S. application Ser. No. 13/083,499, titled “Multi-Channel Pairing In A Media System,” referred to as Docket No. 11-0401, filed on Apr. 8, 2011, and issued on Jul. 22, 2014, as U.S. Pat. No. 8,788,080, describes, inter alia, configuring and operating multiple playback devices in a consolidated mode, where two or more playback devices can be grouped into a consolidated playback device which can then be further grouped with one or more other playback devices and/or one or more other consolidated playback devices.

Further, U.S. application Ser. No. 13/632,731, titled, “Providing A Multi-Channel And A Multi-Zone Audio Environment,” referred to as Docket No. 12-0802, filed on Oct. 1, 2012, and issued on Dec. 6, 2016, as U.S. Pat. No. 9,516,440, describes, inter alia, configuring playback devices to play different types of audio content (e.g., home theater audio vs. music) according to different playback timing arrangements (e.g., with low-latency vs. with ordinary latency).

Additionally, U.S. App. Ser. No. 14/731,119, titled, “Dynamic Bonding of Playback Devices,” referred to as Docket No. 15-0301, filed on Jun. 4, 2015, and issued on Jan. 9, 2018, as U.S. Pat. No. 9,864,571, discloses, inter alia, dynamic bonding scenarios and playback devices that are “sharable” among different zones. And U.S. App. Ser. No. 14/997,269, titled, “System Limits Based on Known Triggers,” referred to as Docket 15-1104, filed on Jan. 15, 2016, and issued on Feb. 20, 2018, as U.S. Pat. No. 9,898,245, describes, inter alia, methods of setting up multiple playback devices.

Further still, U.S. Provisional App. 63/377,948, titled “Playback System Architecture,” referred to as Docket No. 21-0703p, filed on Sep. 30, 2022, describes, inter alia, multi-tier hierarchical playback systems comprising several playback devices, including methods and processes of distributing audio and control signaling between and among playback devices with the multi-tier hierarchical playback system.

However, U.S. application Ser. Nos. 13/013,740; 13/083,499; 13/632,731; 14/731,119; 14/997,269; and 63/377,948 do not describe the GUI and API features and embodiments disclosed herein to facilitate the configuration of the playback configuration scenarios described herein, including but not limited the configuration and control of playback zone configurations with Multi-Player Playback Devices. The entire contents of U.S. application Ser. Nos. 13/013,740; 13/083,499; 13/632,731; 14/731,119; 14/997,269; and 63/377,948 are incorporated herein by reference.

Additionally, several other advancements over time have improved the overall functionality and usability of playback devices configured in groups for synchronous playback of audio content.

With respect to managing groups of playback devices configured for groupwise playback of audio content, U.S. application Ser. No. 14/042,001, titled “Coordinator Device for Paired or Consolidated Players,” referred to as Docket No. 13-0812, filed on Dec. 30, 2013, and issued on Mar. 15, 2016, as U.S. Pat. No. 9,288,596, and U.S. application Ser. No. 14/041,989, titled “Group Coordinator Device Selection,” referred to as Docket No. 13-0815, filed on Sep. 30, 2013, and issued on May 16, 2017, as U.S. Pat. No. 9,654,545 disclose, inter alia, certain techniques whereby individual playback devices configured to operate in a groupwise manner decide which playback device should function as a group coordinator for the group of playback devices.

U.S. application Ser. No. 14/988,524, titled, “Multiple-Device Setup,” referred to as Docket No. 15-1103, filed Jan. 5, 2016, and issued May 28, 2019, as U.S. Pat. No. 10,303,422, discloses, inter alia, techniques for adding several new playback devices to a playback system at the same time, including, in scenarios when two or more of the same type of playback devices are detected during setup, causing one of the two or more playback devices to emit a sound that enables a user to identify the one playback device in connection with playback system configuration and setup.

U.S. application Ser. No. 16/119,516, titled, “Media Playback System with Virtual Line-In,” referred to as Docket No. 18-0406, filed on Aug. 31, 2018, and issued on Oct. 22, 2019, as U.S. Pat. No. 10,452,345, and U.S. application Ser. No. 16/119,642, titled, “Interoperability Of Native Media Playback System With Virtual Line-In,” referred to as Docket No. 18-0503, filed on Aug. 31, 2018, and issued on May 12, 2020, as U.S. Pat. No. 10,649,718, (both of which claim priority to U.S. Prov. App. 62/672,020, titled “Media Playback System with Virtual Line-In,” referred to as Docket No. 18-0406p, filed on May 15, 2018, and now expired) describe, inter alia, scenarios where one playback device in one playback system coordinates aspects of playback and control of another playback device in a different playback system in connection with facilitating interoperability between to two different playback systems.

U.S. application Ser. No. 16/415,783, titled, “Wireless Multi-Channel Headphone Systems and Methods,” referred to as Docket No. 19-0303, filed on May 17, 2019, and issued on Nov. 16, 2021, as U.S. Pat. No. 11,178,504, describes, inter alia, a surround sound controller and one or more wireless headphones that switch between operating in various modes that have different latency characteristics. For example, in a first mode, the surround sound controller uses a first Modulation and Coding Scheme (MCS) to transmit first surround sound audio information to a first pair of headphones, and in a second mode, the surround sound controller uses a second MCS to transmit (a) the first surround sound audio information to the first pair of headphones and (b) second surround sound audio information to a second pair of headphones.

However, U.S. application Ser. Nos. 13/489,674; 14/042,001; 14/041,989; 14/988,524; 16/119,516; 16/119,642; 62/672,020; and 16/415,783 do not describe the GUI and API features and embodiments disclosed herein to facilitate the configuration of the playback configuration scenarios described herein, including but not limited the configuration and control of playback zone configurations with Multi-Player Playback Devices. The entire contents of U.S. application Ser. Nos. 13/489,674; 14/042,001; 14/041,989; 14/988,524; 16/119,516; 16/119,642; 62/672,020; and 16/415,783 are incorporated herein by reference.

Further, some advancements over time have improved the sound quality of audio content played by playback devices via methods of calibrating playback settings (e.g., audio playback settings) for playback devices based on acoustic characteristics of the listening environment in which the playback devices are situated. At a high level, calibrating playback settings includes, inter alia, determining one or more acoustic characteristics of the listening environment, and adjusting one or more audio playback settings (e.g., equalization settings, relative loudness, playing timing delays, and/or perhaps other settings) based on the acoustic characteristics.

For example, U.S. application Ser. No. 15/211,822, titled, “Spatial Audio Correction,” referred to as Docket No. 16-0402, filed on Jul. 15, 2016, and issued on Oct. 17, 2017, as U.S. Pat. No. 9,794,710 describes, inter alia, determining a spatial and/or spectral calibration for one or more playback devices within a listening area. Similarly, U.S. application Ser. No. 16/115,524, titled “Playback Device Calibration,” referred to as Docket No. 18-0401, filed on Aug. 28, 2018, and issued on May 21, 2019, as U.S. Pat. No. 10,299,061 describes, inter alia, calibrating a playback device within a room so that the audio output by the playback device accounts for (e.g., offsets) acoustic characteristics of that room, thereby improving sound of the audio playback experienced by a listener within the room.

Additionally, U.S. application Ser. No. 15/630,214, titled, “Immersive Audio in a Media Playback System,” referred to as Docket No. 16-0504, filed on Jun. 22, 2017, and issued on Jul. 17, 2018, as U.S. Pat. No. 10,028,069 describes, inter alia, processes that include obtaining audio responses from several different playback devices in a media playback system. For example, a first playback device at a first time plays back calibration audio while a microphone device records the calibration audio being played back. A second playback device at a second time plays back the calibration audio while the microphone device records the calibration audio being played. The process is repeated until every playback device in the media playback system has played the calibration audio and had its response recorded.

Further, Int'l App. PCT/US22/77233, titled “Audio Parameter Adjustment Based on Playback Device Separation Distance,” referred to as Docket No. 21-0605-PCT, and published as WO 2023/056336 on Apr. 6, 2023, disclosed, inter alia, applying a low frequency filter to two or more devices in a zone based on a distance between the devices.

However, application Sers. No. 15/211,822; 16/115,524; 15/630,214; and PCT/US22/77233 do not describe the GUI and API features and embodiments disclosed herein to facilitate the configuration of the playback configuration scenarios described herein, including but not limited the configuration and control of playback zone configurations with Multi-Player Playback Devices. The entire contents of application Ser. No. 15/211,822; 16/115,524; 15/630,214; and PCT/US22/77233 are incorporated herein by reference.

While some examples described herein may refer to functions performed by given actors such as “users,” “listeners,” and/or other entities, it should be understood that this is for purposes of explanation only. The claims should not be interpreted to require action by any such example actor unless explicitly required by the language of the claims themselves.

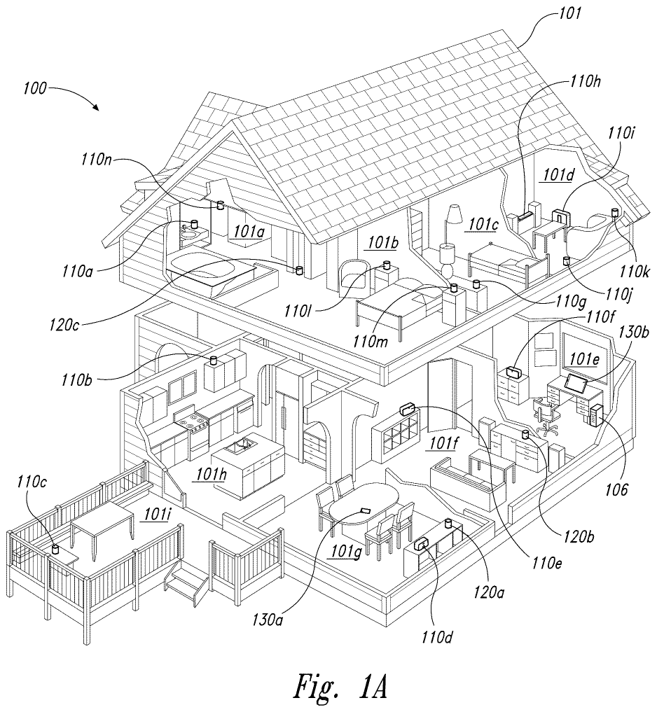

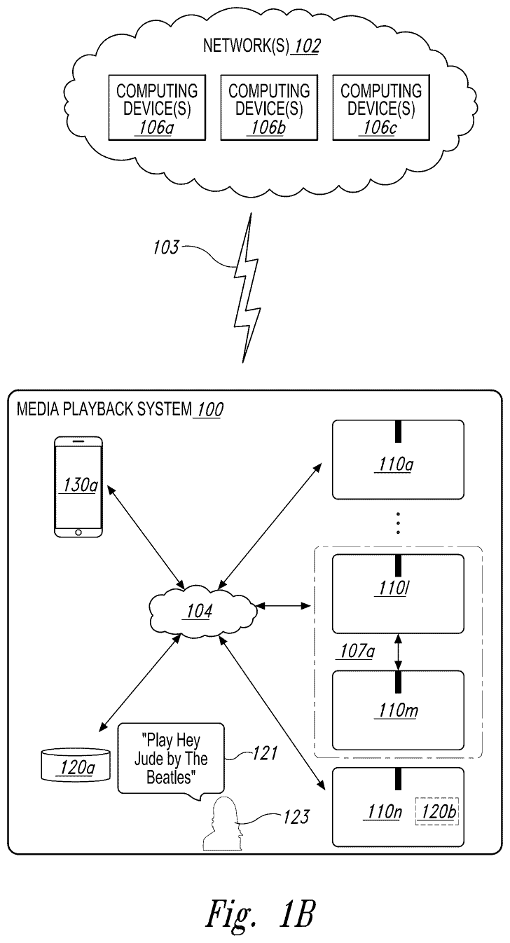

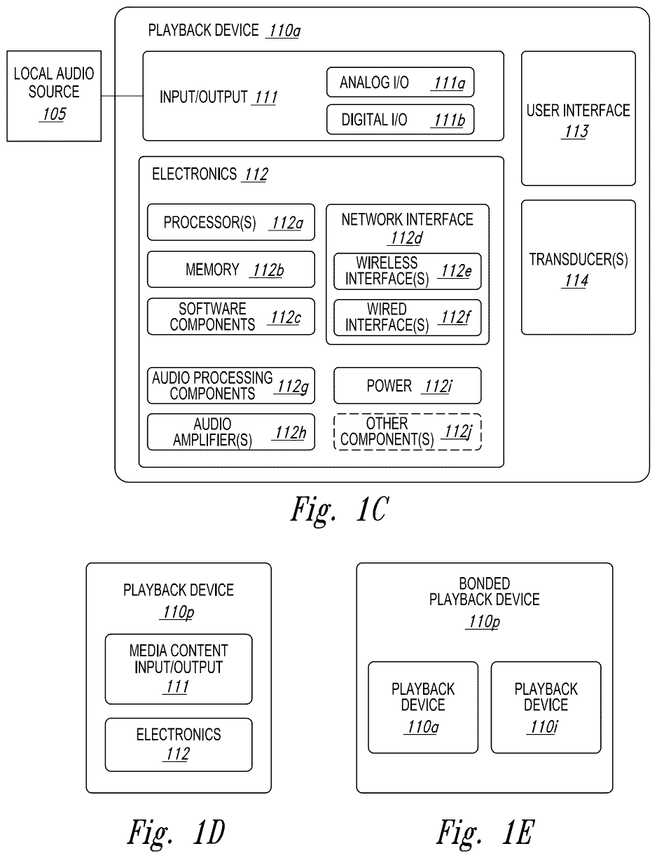

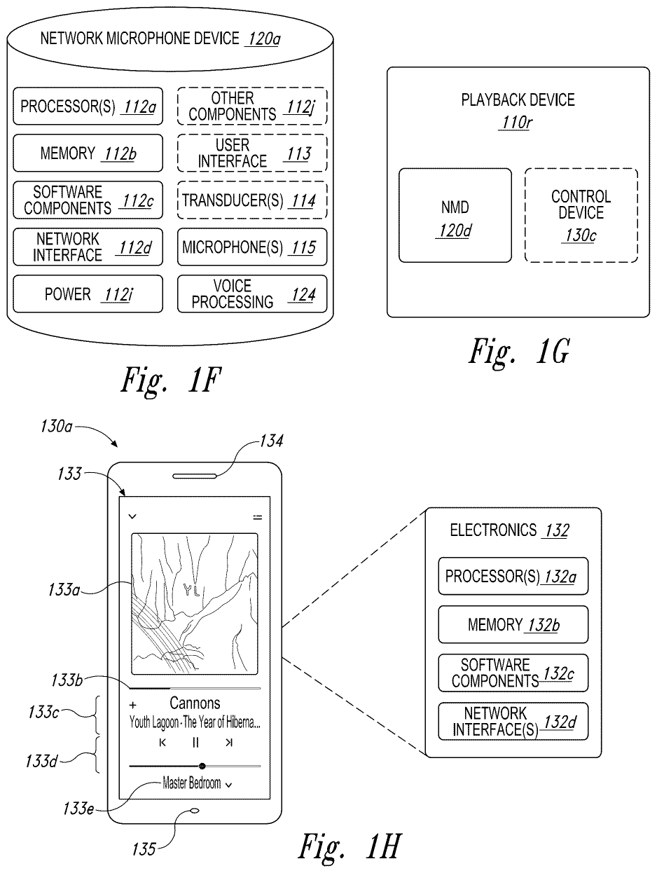

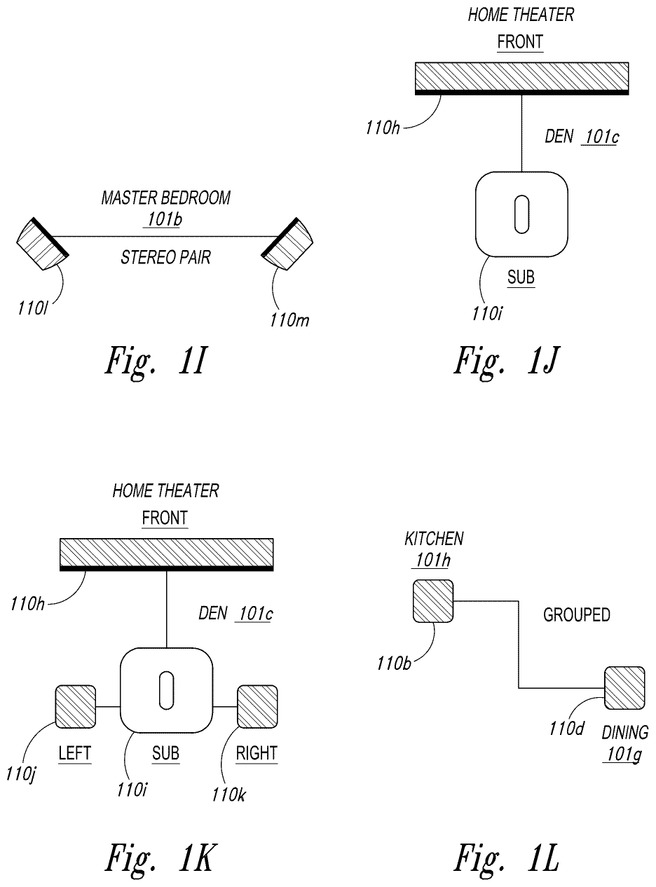

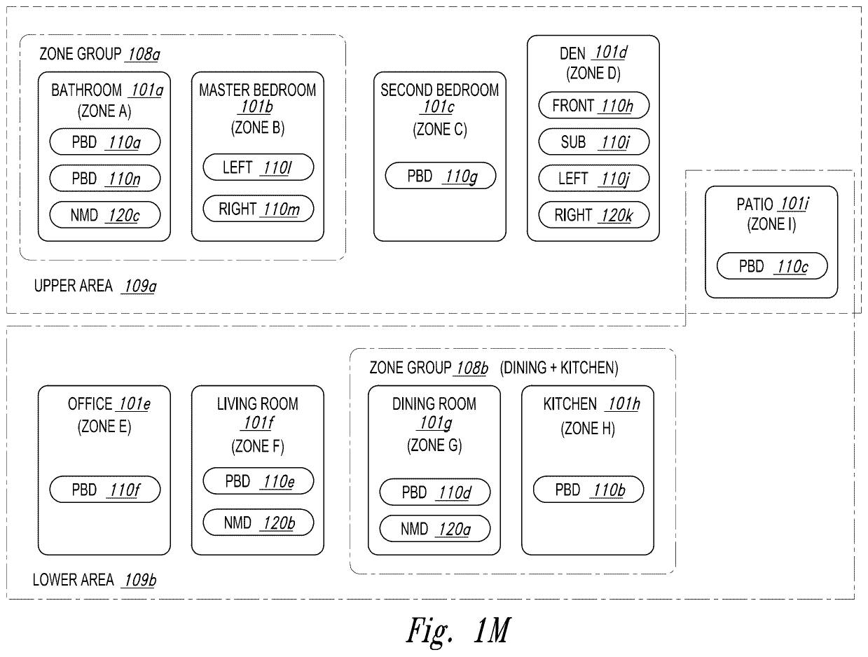

In the Figures, identical reference numbers identify generally similar, and/or identical, elements. To facilitate the discussion of any particular element, the most significant digit or digits of a reference number refers to the Figure in which that element is first introduced. For example, element 110a is first introduced and discussed with reference to FIG. 1A. Many of the details, dimensions, angles and other features shown in the Figures are merely illustrative of particular example configurations of the disclosed technology. Accordingly, other example configurations can have other details, dimensions, angles and features without departing from the spirit or scope of the disclosure. In addition, those of ordinary skill in the art will appreciate that further example configurations of the various disclosed technologies can be practiced without several of the details described below.

### II. Suitable Operating Environment

FIG. 1A is a partial cutaway view of a media playback system 100 distributed in an environment 101 (e.g., a house). The media playback system 100 comprises one or more playback devices 110 (identified individually as playback devices 110a-n), one or more network microphone devices (“NMDs”), 120 (identified individually as NMDs 120a-c), and one or more control devices 130 (identified individually as control devices 130a and 130b).

As used herein the term “playback device” can generally refer to a network device configured to receive, process, and output data of a media playback system. For example, a playback device can be a network device that receives and processes audio content. In some example configurations, a playback device includes one or more transducers or speakers powered by one or more amplifiers. In other example configurations, however, a playback device includes one of (or neither of) the speaker and the amplifier. For instance, a playback device can comprise one or more amplifiers configured to drive one or more speakers external to the playback device via a corresponding wire or cable.

Moreover, as used herein the term NMD (i.e., a “network microphone device”) can generally refer to a network device that is configured for audio detection. In some example configurations, an NMD is a stand-alone device configured primarily for audio detection. In other example configurations, an NMD is incorporated into a playback device (or vice versa).

The term “control device” can generally refer to a network device configured to perform functions relevant to facilitating user access, control, and/or configuration of the media playback system 100.

Each of the playback devices 110 is configured to receive audio signals or data from one or more media sources (e.g., one or more remote servers, one or more local devices) and play back the received audio signals or data as sound. The one or more NMDs 120 are configured to receive spoken word commands, and the one or more control devices 130 are configured to receive user input. In response to the received spoken word commands and/or user input, the media playback system 100 can play back audio via one or more of the playback devices 110. In certain example configurations, the playback devices 110 are configured to commence playback of media content in response to a trigger. For instance, one or more of the playback devices 110 can be configured to play back a morning playlist upon detection of an associated trigger condition (e.g., presence of a user in a kitchen, detection of a coffee machine operation). In some example configurations, for example, the media playback system 100 is configured to play back audio from a first playback device (e.g., the playback device 100a) in synchrony with a second playback device (e.g., the playback device 100b). Interactions between the playback devices 110, NMDs 120, and/or control devices 130 of the media playback system 100 configured in accordance with the various example configurations of the disclosure are described in greater detail below with respect to FIGS. 1B-1L.

In the illustrated embodiment of FIG. 1A, the environment 101 comprises a household having several rooms, spaces, and/or playback zones, including (clockwise from upper left) a master bathroom 101a, a master bedroom 101b, a second bedroom 101c, a family room or den 101d, an office 101e, a living room 101f, a dining room 101g, a kitchen 101h, and an outdoor patio 101i. While certain example configurations and examples are described below in the context of a home environment, the technologies described herein may be implemented in other types of environments. In some example configurations, for example, the media playback system 100 can be implemented in one or more commercial settings (e.g., a restaurant, mall, airport, hotel, a retail or other store), one or more vehicles (e.g., a sports utility vehicle, bus, car, a ship, a boat, an airplane), multiple environments (e.g., a combination of home and vehicle environments), and/or another suitable environment where multi-zone audio may be desirable.

The media playback system 100 can comprise one or more playback zones, some of which may correspond to the rooms in the environment 101. The media playback system 100 can be established with one or more playback zones, after which additional zones may be added, or removed to form, for example, the configuration shown in FIG. 1A. Each zone may be given a name according to a different room or space such as the office 101e, master bathroom 101a, master bedroom 101b, the second bedroom 101c, kitchen 101h, dining room 101g, living room 101f, and/or the patio 101i. In some aspects, a single playback zone may include multiple rooms or spaces. In certain aspects, a single room or space may include multiple playback zones.

In the illustrated embodiment of FIG. 1A, the master bathroom 101a, the second bedroom 101c, the office 101e, the living room 101f, the dining room 101g, the kitchen 101h, and the outdoor patio 101i each include one playback device 110, and the master bedroom 101b and the den 101d include a plurality of playback devices 110. In the master bedroom 101b, the playback devices 110l and 110m may be configured, for example, to play back audio content in synchrony as individual ones of playback devices 110, as a bonded playback zone, as a consolidated playback device, and/or any combination thereof. Similarly, in the den 101d, the playback devices 110h-j can be configured, for instance, to play back audio content in synchrony as individual ones of playback devices 110, as one or more bonded playback devices, and/or as one or more consolidated playback devices. Additional details regarding bonded and consolidated playback devices are described below with respect to, for example, FIGS. 1B and 1E and 1I-1M.

In some aspects, one or more of the playback zones in the environment 101 may each be playing different audio content. For instance, a user may be grilling on the patio 101i and listening to hip hop music being played by the playback device 110c while another user is preparing food in the kitchen 101h and listening to classical music played by the playback device 110b. In another example, a playback zone may play the same audio content in synchrony with another playback zone. For instance, the user may be in the office 101e listening to the playback device 110f playing back the same hip hop music being played back by playback device 110c on the patio 101i. In some aspects, the playback devices 110c and 110f play back the hip hop music in synchrony such that the user perceives that the audio content is being played seamlessly (or at least substantially seamlessly) while moving between different playback zones. Additional details regarding audio playback synchronization among playback devices and/or zones can be found, for example, in U.S. Pat. No. 8,234,395 entitled, “System and method for synchronizing operations among a plurality of independently clocked digital data processing devices,” which is incorporated herein by reference in its entirety.

### A. Suitable Media Playback System

FIG. 1B is a schematic diagram of the media playback system 100 and a cloud network 102. For ease of illustration, certain devices of the media playback system 100 and the cloud network 102 are omitted from FIG. 1B. One or more communications links 103 (referred to hereinafter as “the links 103”) communicatively couple the media playback system 100 and the cloud network 102.

The links 103 can comprise, for example, one or more wired networks, one or more wireless networks, one or more wide area networks (WAN), one or more local area networks (LAN), one or more personal area networks (PAN), one or more telecommunication networks (e.g., one or more Global System for Mobiles (GSM) networks, Code Division Multiple Access (CDMA) networks, Long-Term Evolution (LTE) networks, 5G communication network networks, and/or other suitable data transmission protocol networks), etc. The cloud network 102 is configured to deliver media content (e.g., audio content, video content, photographs, social media content) to the media playback system 100 in response to a request transmitted from the media playback system 100 via the links 103. In some example configurations, the cloud network 102 is further configured to receive data (e.g., voice input data) from the media playback system 100 and correspondingly transmit commands and/or media content to the media playback system 100.

The cloud network 102 comprises computing devices 106 (identified separately as a first computing device 106a, a second computing device 106b, and a third computing device 106c). The computing devices 106 can comprise individual computers or servers, such as, for example, a media streaming service server storing audio and/or other media content, a voice service server, a social media server, a media playback system control server, etc. In some example configurations, one or more of the computing devices 106 comprise modules of a single computer or server. In certain example configurations, one or more of the computing devices 106 comprise one or more modules, computers, and/or servers. Moreover, while the cloud network 102 is described above in the context of a single cloud network, in some example configurations the cloud network 102 comprises a plurality of cloud networks comprising communicatively coupled computing devices. Furthermore, while the cloud network 102 is shown in FIG. 1B as having three of the computing devices 106, in some example configurations, the cloud network 102 comprises fewer (or more than) three computing devices 106.

The media playback system 100 is configured to receive media content from the networks 102 via the links 103. The received media content can comprise, for example, a Uniform Resource Identifier (URI) and/or a Uniform Resource Locator (URL). For instance, in some examples, the media playback system 100 can stream, download, or otherwise obtain data from a URI or a URL corresponding to the received media content. A network 104 communicatively couples the links 103 and at least a portion of the devices (e.g., one or more of the playback devices 110, NMDs 120, and/or control devices 130) of the media playback system 100. The network 104 can include, for example, a wireless network (e.g., a WiFi network, a Bluetooth, a Z-Wave network, a ZigBee, and/or other suitable wireless communication protocol network) and/or a wired network (e.g., a network comprising Ethernet, Universal Serial Bus (USB), and/or another suitable wired communication). As those of ordinary skill in the art will appreciate, as used herein, “WiFi” can refer to several different communication protocols including, for example, Institute of Electrical and Electronics Engineers (IEEE) 802.11a, 802.11b, 802.11g, 802.11n, 802.11ac, 802.11ac, 802.11ad, 802.11af, 802.11ah, 802.11ai, 802.11aj, 802.11aq, 802.11ax, 802.11ay, 802.15, etc. transmitted at 2.4 Gigahertz (GHz), 5 GHz, and/or another suitable frequency.

In some example configurations, the network 104 comprises a dedicated communication network that the media playback system 100 uses to transmit messages between individual devices and/or to transmit media content to and from media content sources (e.g., one or more of the computing devices 106). In certain example configurations, the network 104 is configured to be accessible only to devices in the media playback system 100, thereby reducing interference and competition with other household devices. In other example configurations, however, the network 104 comprises an existing household communication network (e.g., a household WiFi network). In some example configurations, the links 103 and the network 104 comprise one or more of the same networks. In some aspects, for example, the links 103 and the network 104 comprise a telecommunication network (e.g., an LTE network, a 5G network). Moreover, in some example configurations, the media playback system 100 is implemented without the network 104, and devices comprising the media playback system 100 can communicate with each other, for example, via one or more direct connections, PANs, telecommunication networks, and/or other suitable communications links.

In some example configurations, audio content sources may be regularly added or removed from the media playback system 100. In some example configurations, for example, the media playback system 100 performs an indexing of media items when one or more media content sources are updated, added to, and/or removed from the media playback system 100. The media playback system 100 can scan identifiable media items in some or all folders and/or directories accessible to the playback devices 110, and generate or update a media content database comprising metadata (e.g., title, artist, album, track length) and other associated information (e.g., URIs, URLs) for each identifiable media item found. In some example configurations, for example, the media content database is stored on one or more of the playback devices 110, network microphone devices 120, and/or control devices 130.

In the illustrated embodiment of FIG. 1B, the playback devices 110l and 110m comprise a group 107a. The playback devices 110l and 110m can be positioned in different rooms in a household and be grouped together in the group 107a on a temporary or permanent basis based on user input received at the control device 130a and/or another control device 130 in the media playback system 100. When arranged in the group 107a, the playback devices 110l and 110m can be configured to play back the same or similar audio content in synchrony from one or more audio content sources. In certain example configurations, for example, the group 107a comprises a bonded zone in which the playback devices 110l and 110m comprise left audio and right audio channels, respectively, of multi-channel audio content, thereby producing or enhancing a stereo effect of the audio content. In some example configurations, the group 107a includes additional playback devices 110. In other example configurations, however, the media playback system 100 omits the group 107a and/or other grouped arrangements of the playback devices 110. Additional details regarding groups and other arrangements of playback devices are described in further detail below with respect to FIG. 1-I through IM.

The media playback system 100 includes the NMDs 120a and 120d, each comprising one or more microphones configured to receive voice utterances from a user. In the illustrated embodiment of FIG. 1B, the NMD 120a is a standalone device and the NMD 120d is integrated into the playback device 110n. The NMD 120a, for example, is configured to receive voice input 121 from a user 123. In some example configurations, the NMD 120a transmits data associated with the received voice input 121 to a voice assistant service (VAS) configured to (i) process the received voice input data and (ii) transmit a corresponding command to the media playback system 100. In some aspects, for example, the computing device 106c comprises one or more modules and/or servers of a VAS (e.g., a VAS operated by one or more of SONOS®, AMAZON®, GOOGLE® APPLE®, MICROSOFT®). The computing device 106c can receive the voice input data from the NMD 120a via the network 104 and the links 103. In response to receiving the voice input data, the computing device 106c processes the voice input data (i.e., “Play Hey Jude by The Beatles”), and determines that the processed voice input includes a command to play a song (e.g., “Hey Jude”). The computing device 106c accordingly transmits commands to the media playback system 100 to play back “Hey Jude” by the Beatles from a suitable media service (e.g., via one or more of the computing devices 106) on one or more of the playback devices 110.

### B. Suitable Playback Devices

FIG. 1C is a block diagram of the playback device 110a comprising an input/output 111. The input/output 111 can include an analog I/O 111a (e.g., one or more wires, cables, and/or other suitable communications links configured to carry analog signals) and/or a digital I/O 111b (e.g., one or more wires, cables, or other suitable communications links configured to carry digital signals). In some example configurations, the analog I/O 111a is an audio line-in input connection comprising, for example, an auto-detecting 3.5 mm audio line-in connection. In some example configurations, the digital I/O 111b comprises a Sony/Philips Digital Interface Format (S/PDIF) communication interface and/or cable and/or a Toshiba Link (TOSLINK) cable. In some example configurations, the digital I/O 111b comprises a High-Definition Multimedia Interface (HDMI) interface and/or cable. In some example configurations, the digital I/O 111b includes one or more wireless communications links comprising, for example, a radio frequency (RF), infrared, WiFi, Bluetooth, or another suitable communication protocol. In certain example configurations, the analog I/O 111a and the digital I/O 111b comprise interfaces (e.g., ports, plugs, jacks) configured to receive connectors of cables transmitting analog and digital signals, respectively, without necessarily including cables.

The playback device 110a, for example, can receive media content (e.g., audio content comprising music and/or other sounds) from a local audio source 105 via the input/output 111 (e.g., a cable, a wire, a PAN, a Bluetooth connection, an ad hoc wired or wireless communication network, and/or another suitable communications link). The local audio source 105 can comprise, for example, a mobile device (e.g., a smartphone, a tablet, a laptop computer) or another suitable audio component (e.g., a television, a desktop computer, an amplifier, a phonograph, a Blu-ray player, a memory storing digital media files). In some aspects, the local audio source 105 includes local music libraries on a smartphone, a computer, a networked-attached storage (NAS), and/or another suitable device configured to store media files. In certain example configurations, one or more of the playback devices 110, NMDs 120, and/or control devices 130 comprise the local audio source 105. In other example configurations, however, the media playback system omits the local audio source 105 altogether. In some example configurations, the playback device 110a does not include an input/output 111 and receives all audio content via the network 104.

The playback device 110a further comprises electronics 112, a user interface 113 (e.g., one or more buttons, knobs, dials, touch-sensitive surfaces, displays, touchscreens), and one or more transducers 114 (referred to hereinafter as “the transducers 114”). The electronics 112 is configured to receive audio from an audio source (e.g., the local audio source 105) via the input/output 111, one or more of the computing devices 106a-c via the network 104 (FIG. 1B)), amplify the received audio, and output the amplified audio for playback via one or more of the transducers 114. In some example configurations, the playback device 110a optionally includes one or more microphones 115 (e.g., a single microphone, a plurality of microphones, a microphone array) (hereinafter referred to as “the microphones 115”). In certain example configurations, for example, the playback device 110a having one or more of the optional microphones 115 can operate as an NMD configured to receive voice input from a user and correspondingly perform one or more operations based on the received voice input.

In the illustrated embodiment of FIG. 1C, the electronics 112 comprise one or more processors 112a (referred to hereinafter as “the processors 112a”), memory 112b, software components 112c, a network interface 112d, one or more audio processing components 112g (referred to hereinafter as “the audio components 112g”), one or more audio amplifiers 112h (referred to hereinafter as “the amplifiers 112h”), and power 112i (e.g., one or more power supplies, power cables, power receptacles, batteries, induction coils, Power-over Ethernet (POE) interfaces, and/or other suitable sources of electric power). In some example configurations, the electronics 112 optionally include one or more other components 112j (e.g., one or more sensors, video displays, touchscreens, battery charging bases).

The processors 112a can comprise clock-driven computing component(s) configured to process data, and the memory 112b can comprise a computer-readable medium (e.g., a tangible, non-transitory computer-readable medium, data storage loaded with one or more of the software components 112c) configured to store instructions for performing various operations and/or functions. The processors 112a are configured to execute the instructions stored on the memory 112b to perform one or more of the operations. The operations can include, for example, causing the playback device 110a to retrieve audio information from an audio source (e.g., one or more of the computing devices 106a-c (FIG. 1B)), and/or another one of the playback devices 110. In some example configurations, the operations further include causing the playback device 110a to send audio information to another one of the playback devices 110a and/or another device (e.g., one of the NMDs 120). Certain example configurations include operations causing the playback device 110a to pair with another of the one or more playback devices 110 to enable a multi-channel audio environment (e.g., a stereo pair, a bonded zone).

The processors 112a can be further configured to perform operations causing the playback device 110a to synchronize playback of audio content with another of the one or more playback devices 110. As those of ordinary skill in the art will appreciate, during synchronous playback of audio content on a plurality of playback devices, a listener will preferably be unable to perceive time-delay differences between playback of the audio content by the playback device 110a and the other one or more other playback devices 110. Additional details regarding audio playback synchronization among playback devices can be found, for example, in U.S. Pat. No. 8,234,395, which was incorporated by reference above.

In some example configurations, the memory 112b is further configured to store data associated with the playback device 110a, such as one or more zones and/or zone groups of which the playback device 110a is a member, audio sources accessible to the playback device 110a, and/or a playback queue that the playback device 110a (and/or another of the one or more playback devices) can be associated with. The stored data can comprise one or more state variables that are periodically updated and used to describe a state of the playback device 110a. The memory 112b can also include data associated with a state of one or more of the other devices (e.g., the playback devices 110, NMDs 120, control devices 130) of the media playback system 100. In some aspects, for example, the state data is shared during predetermined intervals of time (e.g., every 5 seconds, every 10 seconds, every 60 seconds) among at least a portion of the devices of the media playback system 100, so that one or more of the devices have the most recent data associated with the media playback system 100.

The network interface 112d is configured to facilitate a transmission of data between the playback device 110a and one or more other devices on a data network such as, for example, the links 103 and/or the network 104 (FIG. 1B). The network interface 112d is configured to transmit and receive data corresponding to media content (e.g., audio content, video content, text, photographs) and other signals (e.g., non-transitory signals) comprising digital packet data including an Internet Protocol (IP)-based source address and/or an IP-based destination address. The network interface 112d can parse the digital packet data such that the electronics 112 properly receives and processes the data destined for the playback device 110a.

In the illustrated embodiment of FIG. 1C, the network interface 112d comprises one or more wireless interfaces 112e (referred to hereinafter as “the wireless interface 112e”). The wireless interface 112e (e.g., a suitable interface comprising one or more antennae) can be configured to wirelessly communicate with one or more other devices (e.g., one or more of the other playback devices 110, NMDs 120, and/or control devices 130) that are communicatively coupled to the network 104 (FIG. 1B) in accordance with a suitable wireless communication protocol (e.g., WiFi, Bluetooth, LTE). In some example configurations, the network interface 112d optionally includes a wired interface 112f (e.g., an interface or receptacle configured to receive a network cable such as an Ethernet, a USB-A, USB-C, and/or Thunderbolt cable) configured to communicate over a wired connection with other devices in accordance with a suitable wired communication protocol. In certain example configurations, the network interface 112d includes the wired interface 112f and excludes the wireless interface 112e. In some example configurations, the electronics 112 excludes the network interface 112d altogether and transmits and receives media content and/or other data via another communication path (e.g., the input/output 111).

The audio processing components 112g are configured to process and/or filter data comprising media content received by the electronics 112 (e.g., via the input/output 111 and/or the network interface 112d) to produce output audio signals. In some example configurations, the audio processing components 112g comprise, for example, one or more digital-to-analog converters (DAC), audio preprocessing components, audio enhancement components, digital signal processors (DSPs), and/or other suitable audio processing components, modules, circuits, etc. In certain example configurations, one or more of the audio processing components 112g can comprise one or more subcomponents of the processors 112a. In some example configurations, the electronics 112 omits the audio processing components 112g. In some aspects, for example, the processors 112a execute instructions stored on the memory 112b to perform audio processing operations to produce the output audio signals.

The amplifiers 112h are configured to receive and amplify the audio output signals produced by the audio processing components 112g and/or the processors 112a. The amplifiers 112h can comprise electronic devices and/or components configured to amplify audio signals to levels sufficient for driving one or more of the transducers 114. In some example configurations, for example, the amplifiers 112h include one or more switching or class-D power amplifiers. In other example configurations, however, the amplifiers include one or more other types of power amplifiers (e.g., linear gain power amplifiers, class-A amplifiers, class-B amplifiers, class-AB amplifiers, class-C amplifiers, class-D amplifiers, class-E amplifiers, class-F amplifiers, class-G and/or class H amplifiers, and/or another suitable type of power amplifier). In certain example configurations, the amplifiers 112h comprise a suitable combination of two or more of the foregoing types of power amplifiers. Moreover, in some example configurations, individual ones of the amplifiers 112h correspond to individual ones of the transducers 114. In other example configurations, however, the electronics 112 includes a single one of the amplifiers 112h configured to output amplified audio signals to a plurality of the transducers 114. In some other example configurations, the electronics 112 omits the amplifiers 112h.

The transducers 114 (e.g., one or more speakers and/or speaker drivers) receive the amplified audio signals from the amplifier 112h and render or output the amplified audio signals as sound (e.g., audible sound waves having a frequency between about 20 Hertz (Hz) and 20 kilohertz (kHz)). In some example configurations, the transducers 114 can comprise a single transducer. In other example configurations, however, the transducers 114 comprise a plurality of audio transducers. In some example configurations, the transducers 114 comprise more than one type of transducer. For example, the transducers 114 can include one or more low frequency transducers (e.g., subwoofers, woofers), mid-range frequency transducers (e.g., mid-range transducers, mid-woofers), and one or more high frequency transducers (e.g., one or more tweeters). As used herein, “low frequency” can generally refer to audible frequencies below about 500 Hz, “mid-range frequency” can generally refer to audible frequencies between about 500 Hz and about 2 kHz, and “high frequency” can generally refer to audible frequencies above 2 kHz. In certain example configurations, however, one or more of the transducers 114 comprise transducers that do not adhere to the foregoing frequency ranges. For example, one of the transducers 114 may comprise a mid-woofer transducer configured to output sound at frequencies between about 200 Hz and about 5 kHz.

By way of illustration, SONOS, Inc. presently offers (or has offered) for sale certain playback devices including, for example, a “SONOS ONE,” “PLAY:1,” “PLAY:3,” “PLAY:5,” “PLAYBAR,” “PLAYBASE,” “CONNECT:AMP,” “CONNECT,” and “SUB.” Other suitable playback devices may additionally or alternatively be used to implement the playback devices of example configurations disclosed herein. Additionally, one of ordinary skilled in the art will appreciate that a playback device is not limited to the examples described herein or to SONOS product offerings. In some example configurations, for example, one or more playback devices 110 comprises wired or wireless headphones (e.g., over-the-ear headphones, on-ear headphones, in-ear earphones). In other example configurations, one or more of the playback devices 110 comprise a docking station and/or an interface configured to interact with a docking station for personal mobile media playback devices. In certain example configurations, a playback device may be integral to another device or component such as a television, a lighting fixture, or some other device for indoor or outdoor use. In some example configurations, a playback device omits a user interface and/or one or more transducers. For example, FIG. 1D is a block diagram of a playback device 110p comprising the input/output 111 and electronics 112 without the user interface 113 or transducers 114.

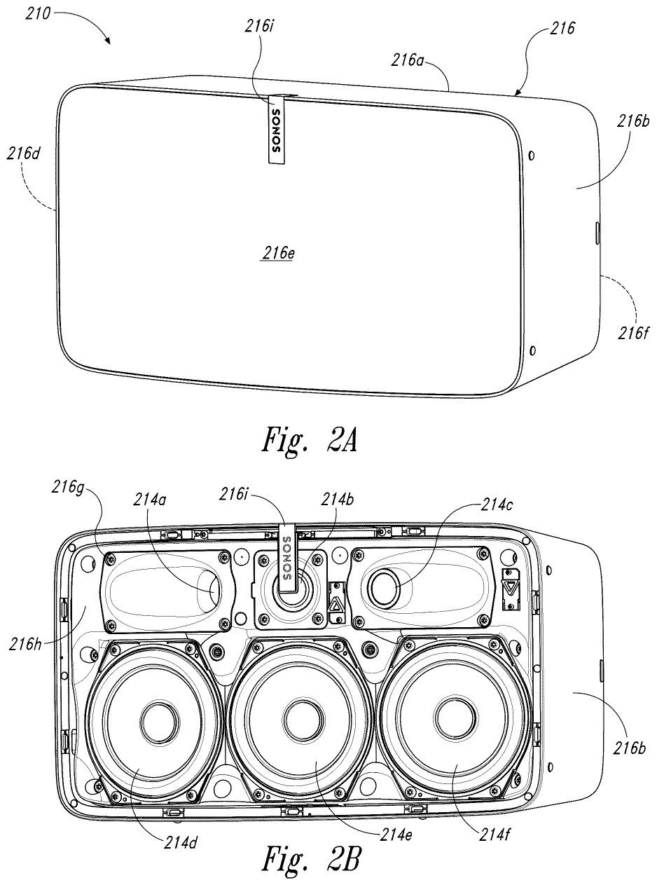

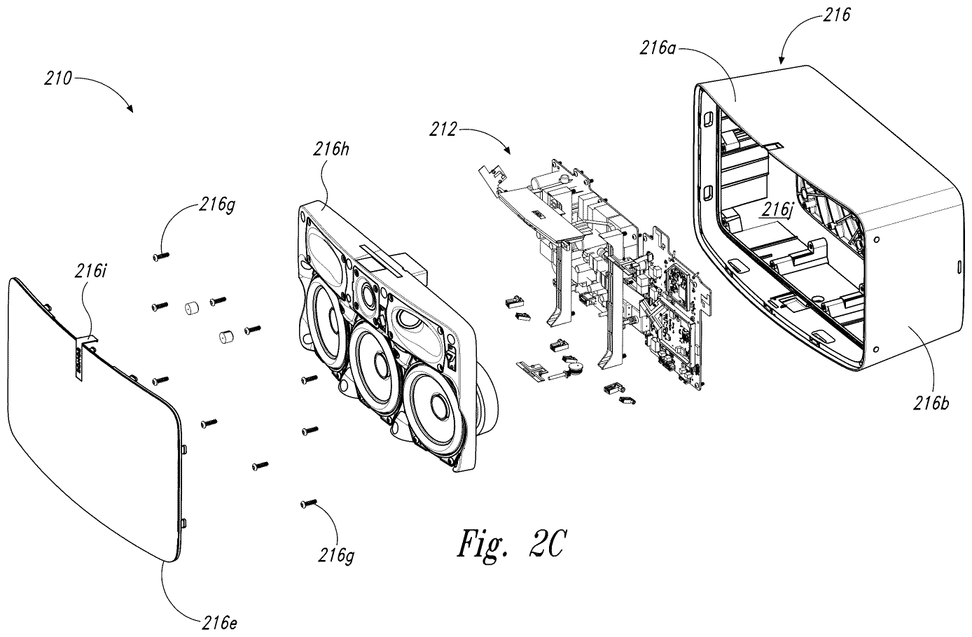

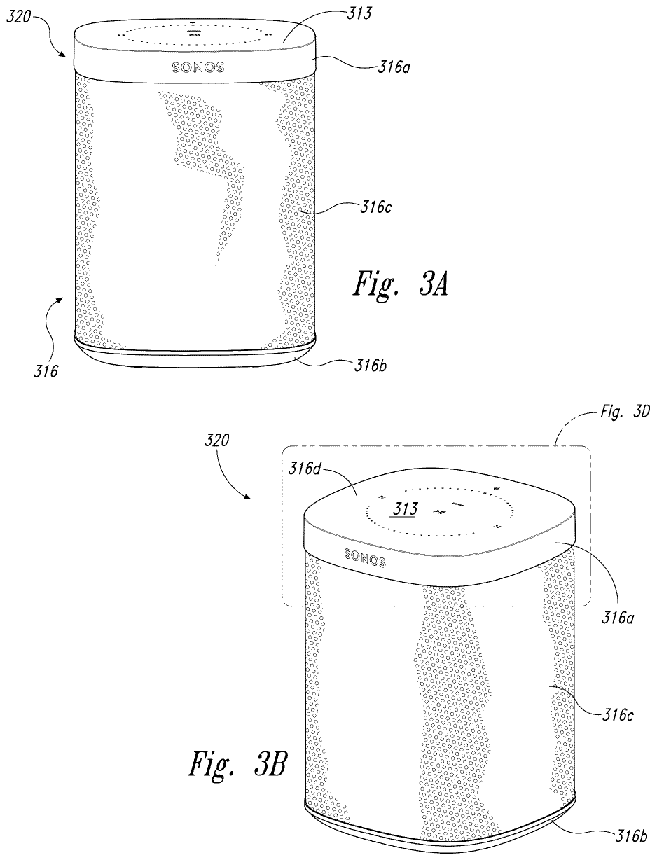

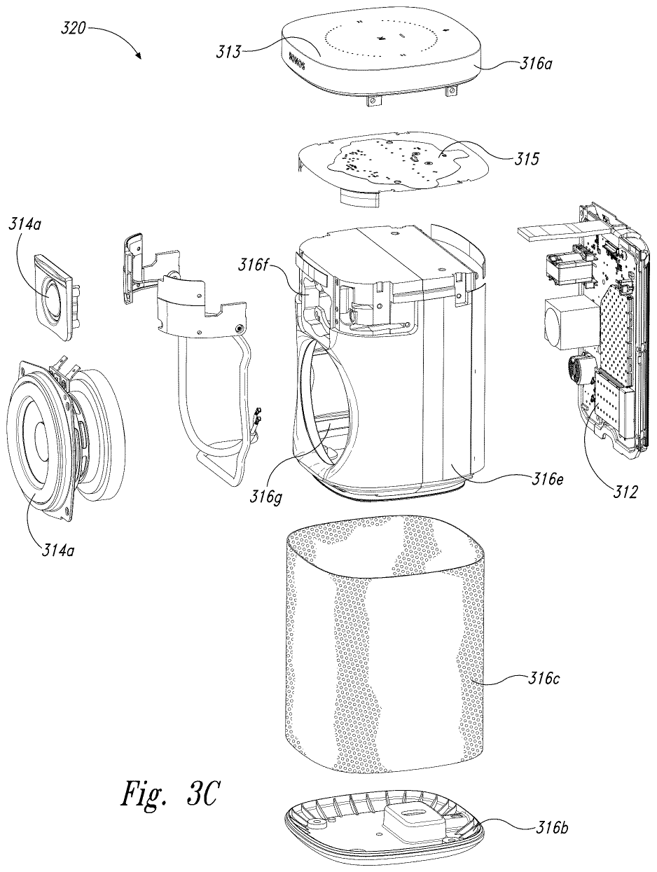

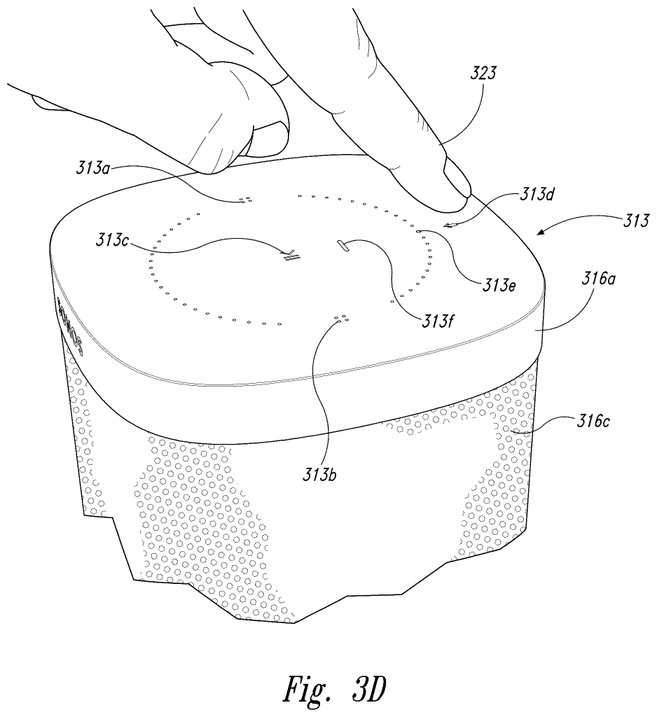

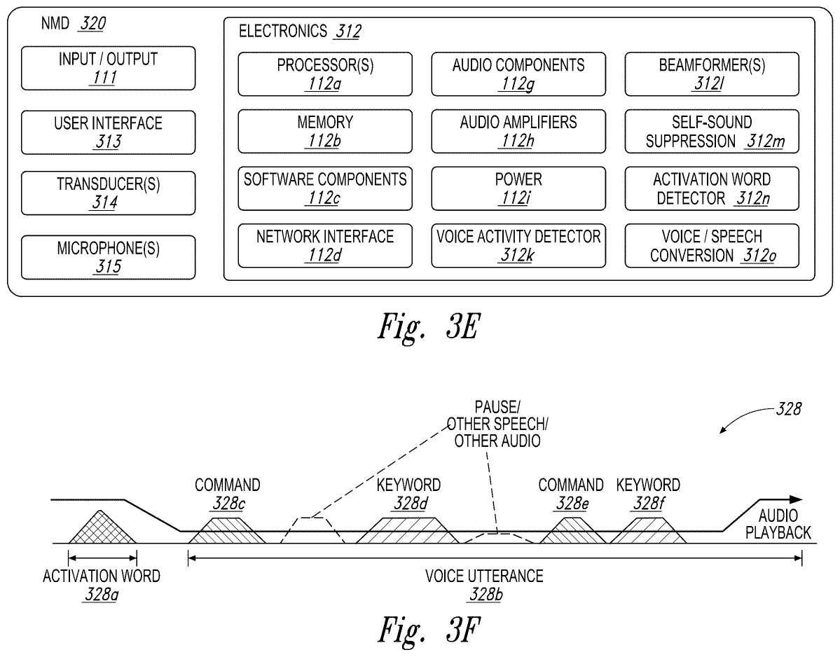

FIG. 1E is a block diagram of a bonded playback device 110q comprising the playback device 110a (FIG. 1C) sonically bonded with the playback device 110i (e.g., a subwoofer) (FIG. 1A). In the illustrated embodiment, the playback devices 110a and 110i are separate ones of the playback devices 110 housed in separate enclosures. In some example configurations, however, the bonded playback device 110q comprises a single enclosure housing both the playback devices 110a and 110i. The bonded playback device 110q can be configured to process and reproduce sound differently than an unbonded playback device (e.g., the playback device 110a of FIG. 1C) and/or paired or bonded playback devices (e.g., the playback devices 110l and 110m of FIG. 1B). In some example configurations, for example, the playback device 110a is full-range playback device configured to render low frequency, mid-range frequency, and high frequency audio content, and the playback device 110i is a subwoofer configured to render low frequency audio content. In some aspects, the playback device 110a, when bonded with the first playback device, is configured to render only the mid-range and high frequency components of a particular audio content, while the playback device 110i renders the low frequency component of the particular audio content. In some example configurations, the bonded playback device 110q includes additional playback devices and/or another bonded playback device. Additional playback device example configurations are described in further detail below with respect to FIGS. 2A-3D.

### C. Suitable Network Microphone Devices (NMDs)

FIG. 1F is a block diagram of the NMD 120a (FIGS. 1A and 1B). The NMD 120a includes one or more voice processing components 124 (hereinafter “the voice components 124”) and several components described with respect to the playback device 110a (FIG. 1C) including the processors 112a, the memory 112b, and the microphones 115. The NMD 120a optionally comprises other components also included in the playback device 110a (FIG. 1C), such as the user interface 113 and/or the transducers 114. In some example configurations, the NMD 120a is configured as a media playback device (e.g., one or more of the playback devices 110), and further includes, for example, one or more of the audio processing components 112g (FIG. 1C), the transducers 114, and/or other playback device components. In certain example configurations, the NMD 120a comprises an Internet of Things (IoT) device such as, for example, a thermostat, alarm panel, fire and/or smoke detector, etc. In some example configurations, the NMD 120a comprises the microphones 115, the voice processing 124, and only a portion of the components of the electronics 112 described above with respect to FIG. 1B. In some aspects, for example, the NMD 120a includes the processor 112a and the memory 112b (FIG. 1B), while omitting one or more other components of the electronics 112. In some example configurations, the NMD 120a includes additional components (e.g., one or more sensors, cameras, thermometers, barometers, hygrometers).

In some example configurations, an NMD can be integrated into a playback device. FIG. 1G is a block diagram of a playback device 110r comprising an NMD 120d. The playback device 110r can comprise many or all of the components of the playback device 110a and further include the microphones 115 and voice processing 124 (FIG. 1F). The playback device 110r optionally includes an integrated control device 130c. The control device 130c can comprise, for example, a user interface (e.g., the user interface 113 of FIG. 1B) configured to receive user input (e.g., touch input, voice input) without a separate control device. In other example configurations, however, the playback device 110r receives commands from another control device (e.g., the control device 130a of FIG. 1B). Additional NMD example configurations are described in further detail below with respect to FIGS. 3A-3F.

Referring again to FIG. 1F, the microphones 115 are configured to acquire, capture, and/or receive sound from an environment (e.g., the environment 101 of FIG. 1A) and/or a room in which the NMD 120a is positioned. The received sound can include, for example, vocal utterances, audio played back by the NMD 120a and/or another playback device, background voices, ambient sounds, etc. The microphones 115 convert the received sound into electrical signals to produce microphone data. The voice processing 124 receives and analyzes the microphone data to determine whether a voice input is present in the microphone data. The voice input can comprise, for example, an activation word followed by an utterance including a user request. As those of ordinary skill in the art will appreciate, an activation word is a word or other audio cue that signifying a user voice input. For instance, in querying the AMAZON® VAS, a user might speak the activation word “Alexa.” Other examples include “Ok, Google” for invoking the GOOGLE® VAS and “Hey, Siri” for invoking the APPLE® VAS.

After detecting the activation word, voice processing 124 monitors the microphone data for an accompanying user request in the voice input. The user request may include, for example, a command to control a third-party device, such as a thermostat (e.g., NEST® thermostat), an illumination device (e.g., a PHILIPS HUE® lighting device), or a media playback device (e.g., a Sonos® playback device). For example, a user might speak the activation word “Alexa” followed by the utterance “set the thermostat to 68 degrees” to set a temperature in a home (e.g., the environment 101 of FIG. 1A). The user might speak the same activation word followed by the utterance “turn on the living room” to turn on illumination devices in a living room area of the home. The user may similarly speak an activation word followed by a request to play a particular song, an album, or a playlist of music on a playback device in the home. Additional description regarding receiving and processing voice input data can be found in further detail below with respect to FIGS. 3A-3F.

### D. Suitable Control Devices

FIG. 1H is a partially schematic diagram of the control device 130a (FIGS. 1A and 1B). As used herein, the term “control device” can be used interchangeably with “controller” or “control system.” Among other features, the control device 130a is configured to receive user input related to the media playback system 100 and, in response, cause one or more devices in the media playback system 100 to perform an action(s) or operation(s) corresponding to the user input. In the illustrated embodiment, the control device 130a comprises a smartphone (e.g., an iPhone™, an Android phone) on which media playback system controller application software is installed. In some example configurations, the control device 130a comprises, for example, a tablet (e.g., an iPad™), a computer (e.g., a laptop computer, a desktop computer), and/or another suitable device (e.g., a television, an automobile audio head unit, an IoT device). In certain example configurations, the control device 130a comprises a dedicated controller for the media playback system 100. In other example configurations, as described above with respect to FIG. 1G, the control device 130a is integrated into another device in the media playback system 100 (e.g., one more of the playback devices 110, NMDs 120, and/or other suitable devices configured to communicate over a network).

The control device 130a includes electronics 132, a user interface 133, one or more speakers 134, and one or more microphones 135. The electronics 132 comprise one or more processors 132a (referred to hereinafter as “the processors 132a”), a memory 132b, software components 132c, and a network interface 132d. The processor 132a can be configured to perform functions relevant to facilitating user access, control, and configuration of the media playback system 100. The memory 132b can comprise data storage that can be loaded with one or more of the software components executable by the processor 302 to perform those functions. The software components 132c can comprise applications and/or other executable software configured to facilitate control of the media playback system 100. The memory 112b can be configured to store, for example, the software components 132c, media playback system controller application software, and/or other data associated with the media playback system 100 and the user.

The network interface 132d is configured to facilitate network communications between the control device 130a and one or more other devices in the media playback system 100, and/or one or more remote devices. In some example configurations, the network interface 132d is configured to operate according to one or more suitable communication industry standards (e.g., infrared, radio, wired standards including IEEE 802.3, wireless standards including IEEE 802.11a, 802.11b, 802.11g, 802.11n, 802.11ac, 802.15, 4G, LTE). The network interface 132d can be configured, for example, to transmit data to and/or receive data from the playback devices 110, the NMDs 120, other ones of the control devices 130, one of the computing devices 106 of FIG. 1B, devices comprising one or more other media playback systems, etc. The transmitted and/or received data can include, for example, playback device control commands, state variables, playback zone and/or zone group configurations. For instance, based on user input received at the user interface 133, the network interface 132d can transmit a playback device control command (e.g., volume control, audio playback control, audio content selection) from the control device 304 to one or more of playback devices. The network interface 132d can also transmit and/or receive configuration changes such as, for example, adding/removing one or more playback devices to/from a zone, adding/removing one or more zones to/from a zone group, forming a bonded or consolidated player, separating one or more playback devices from a bonded or consolidated player, among others. Additional description of zones and groups can be found below with respect to FIG. 1-I through 1M.

The user interface 133 is configured to receive user input and can facilitate ‘control of the media playback system 100. The user interface 133 includes media content art 133a (e.g., album art, lyrics, videos), a playback status indicator 133b (e.g., an elapsed and/or remaining time indicator), media content information region 133c, a playback control region 133d, and a zone indicator 133e. The media content information region 133c can include a display of relevant information (e.g., title, artist, album, genre, release year) about media content currently playing and/or media content in a queue or playlist. The playback control region 133d can include selectable (e.g., via touch input and/or via a cursor or another suitable selector) icons to cause one or more playback devices in a selected playback zone or zone group to perform playback actions such as, for example, play or pause, fast forward, rewind, skip to next, skip to previous, enter/exit shuffle mode, enter/exit repeat mode, enter/exit cross fade mode, etc. The playback control region 133d may also include selectable icons to modify equalization settings, playback volume, and/or other suitable playback actions. In the illustrated embodiment, the user interface 133 comprises a display presented on a touch screen interface of a smartphone (e.g., an iPhone™, an Android phone). In some example configurations, however, user interfaces of varying formats, styles, and interactive sequences may alternatively be implemented on one or more network devices to provide comparable control access to a media playback system.

The one or more speakers 134 (e.g., one or more transducers) can be configured to output sound to the user of the control device 130a. In some example configurations, the one or more speakers comprise individual transducers configured to correspondingly output low frequencies, mid-range frequencies, and/or high frequencies. In some aspects, for example, the control device 130a is configured as a playback device (e.g., one of the playback devices 110). Similarly, in some example configurations the control device 130a is configured as an NMD (e.g., one of the NMDs 120), receiving voice commands and other sounds via the one or more microphones 135.

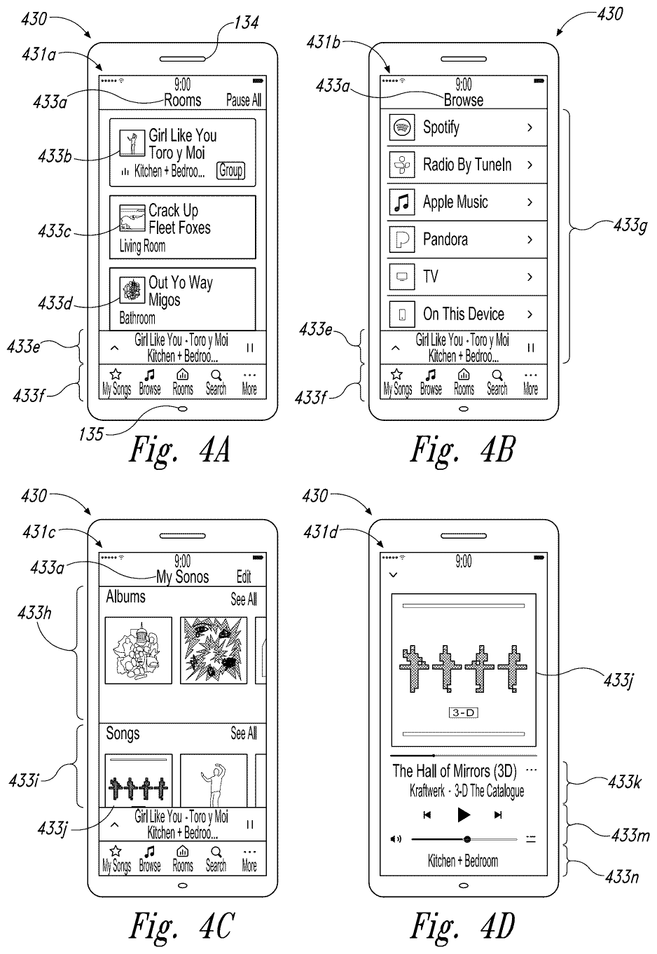

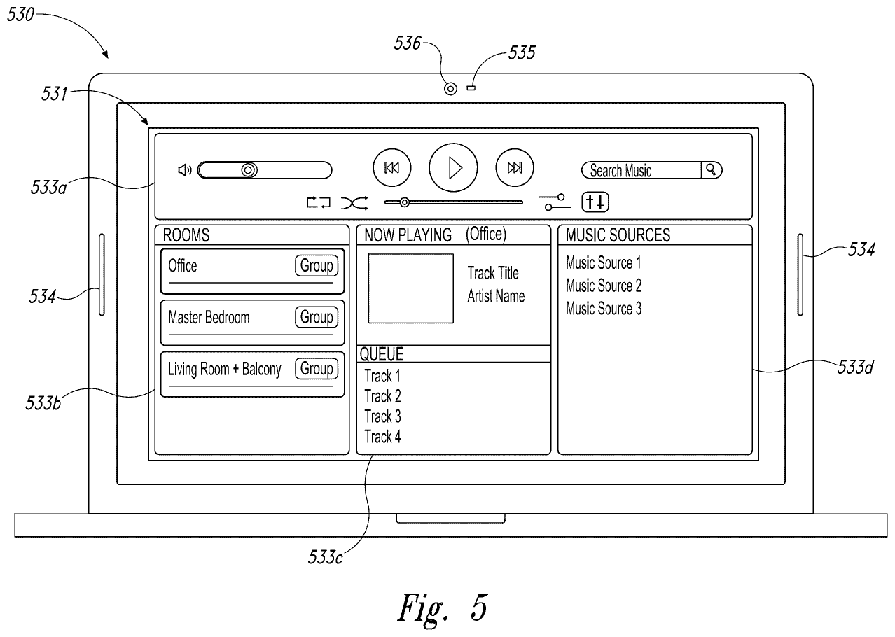

The one or more microphones 135 can comprise, for example, one or more condenser microphones, electret condenser microphones, dynamic microphones, and/or other suitable types of microphones or transducers. In some example configurations, two or more of the microphones 135 are arranged to capture location information of an audio source (e.g., voice, audible sound) and/or configured to facilitate filtering of background noise. Moreover, in certain example configurations, the control device 130a is configured to operate as playback device and an NMD. In other example configurations, however, the control device 130a omits the one or more speakers 134 and/or the one or more microphones 135. For instance, the control device 130a may comprise a device (e.g., a thermostat, an IoT device, a network device) comprising a portion of the electronics 132 and the user interface 133 (e.g., a touch screen) without any speakers or microphones. Additional control device example configurations are described in further detail below with respect to FIGS. 4A-4D and 5.

### E. Suitable Playback Device Configurations

FIGS. 1-1 through 1M show example configurations of playback devices in zones and zone groups. Referring first to FIG. 1M, in one example, a single playback device may belong to a zone. For example, the playback device 110g in the second bedroom 101c (FIG. 1A) may belong to Zone C. In some implementations described below, multiple playback devices may be “bonded” to form a “bonded pair” which together form a single zone. For example, the playback device 110l (e.g., a left playback device) can be bonded to the playback device 110l (e.g., a left playback device) to form Zone A. Bonded playback devices may have different playback responsibilities (e.g., channel responsibilities). In another implementation described below, multiple playback devices may be merged to form a single zone. For example, the playback device 110h (e.g., a front playback device) may be merged with the playback device 110i (e.g., a subwoofer), and the playback devices 110j and 110k (e.g., left and right surround speakers, respectively) to form a single Zone D. In another example, the playback devices 110g and 110h can be merged to form a merged group or a zone group 108b. The merged playback devices 110g and 110h may not be specifically assigned different playback responsibilities. That is, the merged playback devices 110h and 110i may, aside from playing audio content in synchrony, each play audio content as they would if they were not merged.

Each zone in the media playback system 100 may be provided for control as a single user interface (UI) entity. For example, Zone A may be provided as a single entity named Master Bathroom. Zone B may be provided as a single entity named Master Bedroom. Zone C may be provided as a single entity named Second Bedroom.

Playback devices that are bonded may have different playback responsibilities, such as responsibilities for certain audio channels. For example, as shown in FIG. 1-I, the playback devices 110l and 110m may be bonded so as to produce or enhance a stereo effect of audio content. In this example, the playback device 110l may be configured to play a left channel audio component, while the playback device 110k may be configured to play a right channel audio component. In some implementations, such stereo bonding may be referred to as “pairing.”

Additionally, bonded playback devices may have additional and/or different respective speaker drivers. As shown in FIG. 1J, the playback device 110h named Front may be bonded with the playback device 110i named SUB. The Front device 110h can be configured to render a range of mid to high frequencies and the SUB device 110i can be configured render low frequencies. When unbonded, however, the Front device 110h can be configured render a full range of frequencies. As another example, FIG. 1K shows the Front and SUB devices 110h and 110i further bonded with Left and Right playback devices 110j and 110k, respectively. In some implementations, the Right and Left devices 110j and 102k can be configured to form surround or “satellite” channels of a home theater system. The bonded playback devices 110h, 110i, 110j, and 110k may form a single Zone D (FIG. 1M).

Playback devices that are merged may not have assigned playback responsibilities, and may each render the full range of audio content the respective playback device is capable of. Nevertheless, merged devices may be represented as a single UI entity (i.e., a zone, as discussed above). For instance, the playback devices 110a and 110n in the master bathroom have the single UI entity of Zone A. In one embodiment, the playback devices 110a and 110n may each output the full range of audio content each respective playback devices 110a and 110n are capable of, in synchrony.

In some example configurations, an NMD is bonded or merged with another device so as to form a zone. For example, the NMD 120b may be bonded with the playback device 110e, which together form Zone F, named Living Room. In other example configurations, a stand-alone network microphone device may be in a zone by itself. In other example configurations, however, a stand-alone network microphone device may not be associated with a zone. Additional details regarding associating network microphone devices and playback devices as designated or default devices may be found, for example, in previously referenced U.S. patent application Ser. No. 15/438,749.

Zones of individual, bonded, and/or merged devices may be grouped to form a zone group. For example, referring to FIG. 1M, Zone A may be grouped with Zone B to form a zone group 108a that includes the two zones. Similarly, Zone G may be grouped with Zone H to form the zone group 108b. As another example, Zone A may be grouped with one or more other Zones C-I. The Zones A-I may be grouped and ungrouped in numerous ways. For example, three, four, five, or more (e.g., all) of the Zones A-I may be grouped. When grouped, the zones of individual and/or bonded playback devices may play back audio in synchrony with one another, as described in previously referenced U.S. Pat. No. 8,234,395. Playback devices may be dynamically grouped and ungrouped to form new or different groups that synchronously play back audio content.

In various implementations, the zones in an environment may be the default name of a zone within the group or a combination of the names of the zones within a zone group. For example, Zone Group 108b can be assigned a name such as “Dining +Kitchen”, as shown in FIG. 1M. In some example configurations, a zone group may be given a unique name selected by a user.

Certain data may be stored in a memory of a playback device (e.g., the memory 112b of FIG. 1C) as one or more state variables that are periodically updated and used to describe the state of a playback zone, the playback device(s), and/or a zone group associated therewith. The memory may also include the data associated with the state of the other devices of the media system, and shared from time to time among the devices so that one or more of the devices have the most recent data associated with the system.

In some example configurations, the memory may store instances of various variable types associated with the states. Variables instances may be stored with identifiers (e.g., tags) corresponding to type. For example, certain identifiers may be a first type “a1” to identify playback device(s) of a zone, a second type “b1” to identify playback device(s) that may be bonded in the zone, and a third type “c1” to identify a zone group to which the zone may belong. As a related example, identifiers associated with the second bedroom 101c may indicate that the playback device is the only playback device of the Zone C and not in a zone group. Identifiers associated with the Den may indicate that the Den is not grouped with other zones but includes bonded playback devices 110h-110k. Identifiers associated with the Dining Room may indicate that the Dining Room is part of the Dining +Kitchen zone group 108b and that devices 110b and 110d are grouped (FIG. 1L). Identifiers associated with the Kitchen may indicate the same or similar information by virtue of the Kitchen being part of the Dining +Kitchen zone group 108b. Other example zone variables and identifiers are described below.

In yet another example, the media playback system 100 may variables or identifiers representing other associations of zones and zone groups, such as identifiers associated with Areas, as shown in FIG. 1M. An area may involve a cluster of zone groups and/or zones not within a zone group. For instance, FIG. 1M shows an Upper Area 109a including Zones A-D, and a Lower Area 109b including Zones E-I. In one aspect, an Area may be used to invoke a cluster of zone groups and/or zones that share one or more zones and/or zone groups of another cluster. In another aspect, this differs from a zone group, which does not share a zone with another zone group. Further examples of techniques for implementing Areas may be found, for example, in U.S. application Ser. No. 15/682,506 filed Aug. 21, 2017, and titled “Room Association Based on Name,” and U.S. Pat. No. 8,483,853 filed Sep. 11, 2007, and titled “Controlling and manipulating groupings in a multi-zone media system.” Each of these applications is incorporated herein by reference in its entirety. In some example configurations, the media playback system 100 may not implement Areas, in which case the system may not store variables associated with Areas.

III. Example Systems and Devices

FIG. 2A is a front isometric view of a playback device 210 configured in accordance with aspects of the disclosed technology. FIG. 2B is a front isometric view of the playback device 210 without a grille 216e. FIG. 2C is an exploded view of the playback device 210. Referring to FIGS. 2A-2C together, the playback device 210 comprises a housing 216 that includes an upper portion 216a, a right or first side portion 216b, a lower portion 216c, a left or second side portion 216d, the grille 216e, and a rear portion 216f. A plurality of fasteners 216g (e.g., one or more screws, rivets, clips) attaches a frame 216h to the housing 216. A cavity 216j (FIG. 2C) in the housing 216 is configured to receive the frame 216h and electronics 212. The frame 216h is configured to carry a plurality of transducers 214 (identified individually in FIG. 2B as transducers 214a-f). The electronics 212 (e.g., the electronics 112 of FIG. 1C) is configured to receive audio content from an audio source and send electrical signals corresponding to the audio content to the transducers 214 for playback.

The transducers 214 are configured to receive the electrical signals from the electronics 112, and further configured to convert the received electrical signals into audible sound during playback. For instance, the transducers 214a-c (e.g., tweeters) can be configured to output high frequency sound (e.g., sound waves having a frequency greater than about 2 kHz). The transducers 214d-f (e.g., mid-woofers, woofers, midrange speakers) can be configured output sound at frequencies lower than the transducers 214a-c (e.g., sound waves having a frequency lower than about 2 kHz). In some example configurations, the playback device 210 includes a number of transducers different than those illustrated in FIGS. 2A-2C. For example, as described in further detail below with respect to FIGS. 3A-3C, the playback device 210 can include fewer than six transducers (e.g., one, two, three). In other example configurations, however, the playback device 210 includes more than six transducers (e.g., nine, ten). Moreover, in some example configurations, all or a portion of the transducers 214 are configured to operate as a phased array to desirably adjust (e.g., narrow or widen) a radiation pattern of the transducers 214, thereby altering a user's perception of the sound emitted from the playback device 210.

In the illustrated embodiment of FIGS. 2A-2C, a filter 216i is axially aligned with the transducer 214b. The filter 216i can be configured to desirably attenuate a predetermined range of frequencies that the transducer 214b outputs to improve sound quality and a perceived sound stage output collectively by the transducers 214. In some example configurations, however, the playback device 210 omits the filter 216i. In other example configurations, the playback device 210 includes one or more additional filters aligned with the transducers 214b and/or at least another of the transducers 214.

FIGS. 3A and 3B are front and right isometric side views, respectively, of an NMD 320 configured in accordance with example configurations of the disclosed technology. FIG. 3C is an exploded view of the NMD 320. FIG. 3D is an enlarged view of a portion of FIG. 3B including a user interface 313 of the NMD 320. Referring first to FIGS. 3A-3C, the NMD 320 includes a housing 316 comprising an upper portion 316a, a lower portion 316b and an intermediate portion 316c (e.g., a grille). A plurality of ports, holes or apertures 316d in the upper portion 316a allow sound to pass through to one or more microphones 315 (FIG. 3C) positioned within the housing 316. The one or more microphones 315 are configured to received sound via the apertures 316d and produce electrical signals based on the received sound. In the illustrated embodiment, a frame 316e (FIG. 3C) of the housing 316 surrounds cavities 316f and 316g configured to house, respectively, a first transducer 314a (e.g., a tweeter) and a second transducer 314b (e.g., a mid-woofer, a midrange speaker, a woofer). In other example configurations, however, the NMD 320 includes a single transducer, or more than two (e.g., two, five, six) transducers. In certain example configurations, the NMD 320 omits the transducers 314a and 314b altogether.

Electronics 312 (FIG. 3C) includes components configured to drive the transducers 314a and 314b, and further configured to analyze audio information corresponding to the electrical signals produced by the one or more microphones 315. In some example configurations, for example, the electronics 312 comprises many or all of the components of the electronics 112 described above with respect to FIG. 1C. In certain example configurations, the electronics 312 includes components described above with respect to FIG. 1F such as, for example, the one or more processors 112a, the memory 112b, the software components 112c, the network interface 112d, etc. In some example configurations, the electronics 312 includes additional suitable components (e.g., proximity or other sensors).

Referring to FIG. 3D, the user interface 313 includes a plurality of control surfaces (e.g., buttons, knobs, capacitive surfaces) including a first control surface 313a (e.g., a previous control), a second control surface 313b (e.g., a next control), and a third control surface 313c (e.g., a play and/or pause control). A fourth control surface 313d is configured to receive touch input corresponding to activation and deactivation of the one or microphones 315. A first indicator 313e (e.g., one or more light emitting diodes (LEDs) or another suitable illuminator) can be configured to illuminate only when the one or more microphones 315 are activated. A second indicator 313f (e.g., one or more LEDs) can be configured to remain solid during normal operation and to blink or otherwise change from solid to indicate a detection of voice activity. In some example configurations, the user interface 313 includes additional or fewer control surfaces and illuminators. In one embodiment, for example, the user interface 313 includes the first indicator 313e, omitting the second indicator 313f. Moreover, in certain example configurations, the NMD 320 comprises a playback device and a control device, and the user interface 313 comprises the user interface of the control device.

Referring to FIGS. 3A-3D together, the NMD 320 is configured to receive voice commands from one or more adjacent users via the one or more microphones 315. As described above with respect to FIG. 1B, the one or more microphones 315 can acquire, capture, or record sound in a vicinity (e.g., a region within 10m or less of the NMD 320) and transmit electrical signals corresponding to the recorded sound to the electronics 312. The electronics 312 can process the electrical signals and can analyze the resulting audio data to determine a presence of one or more voice commands (e.g., one or more activation words). In some example configurations, for example, after detection of one or more suitable voice commands, the NMD 320 is configured to transmit a portion of the recorded audio data to another device and/or a remote server (e.g., one or more of the computing devices 106 of FIG. 1B) for further analysis. The remote server can analyze the audio data, determine an appropriate action based on the voice command, and transmit a message to the NMD 320 to perform the appropriate action. For instance, a user may speak “Sonos, play Michael Jackson.” The NMD 320 can, via the one or more microphones 315, record the user's voice utterance, determine the presence of a voice command, and transmit the audio data having the voice command to a remote server (e.g., one or more of the remote computing devices 106 of FIG. 1B, one or more servers of a VAS and/or another suitable service). The remote server can analyze the audio data and determine an action corresponding to the command. The remote server can then transmit a command to the NMD 320 to perform the determined action (e.g., play back audio content related to Michael Jackson). The NMD 320 can receive the command and play back the audio content related to Michael Jackson from a media content source. As described above with respect to FIG. 1B, suitable content sources can include a device or storage communicatively coupled to the NMD 320 via a LAN (e.g., the network 104 of FIG. 1B), a remote server (e.g., one or more of the remote computing devices 106 of FIG. 1B), etc. In certain example configurations, however, the NMD 320 determines and/or performs one or more actions corresponding to the one or more voice commands without intervention or involvement of an external device, computer, or server.

FIG. 3E is a functional block diagram showing additional features of the NMD 320 in accordance with aspects of the disclosure. The NMD 320 includes components configured to facilitate voice command capture including voice activity detector component(s) 312k, beam former components 312l, acoustic echo cancellation (AEC) and/or self-sound suppression components 312m, activation word detector components 312n, and voice/speech conversion components 312o (e.g., voice-to-text and text-to-voice). In the illustrated embodiment of FIG. 3E, the foregoing components 312k-312o are shown as separate components. In some example configurations, however, one or more of the components 312k-312o are subcomponents of the processors 112a.

The beamforming and self-sound suppression components 312l and 312m are configured to detect an audio signal and determine aspects of voice input represented in the detected audio signal, such as the direction, amplitude, frequency spectrum, etc. The voice activity detector activity components 312k are operably coupled with the beamforming and AEC components 312l and 312m and are configured to determine a direction and/or directions from which voice activity is likely to have occurred in the detected audio signal. Potential speech directions can be identified by monitoring metrics which distinguish speech from other sounds. Such metrics can include, for example, energy within the speech band relative to background noise and entropy within the speech band, which is measure of spectral structure. As those of ordinary skill in the art will appreciate, speech typically has a lower entropy than most common background noise. The activation word detector components 312n are configured to monitor and analyze received audio to determine if any activation words (e.g., wake words) are present in the received audio. The activation word detector components 312n may analyze the received audio using an activation word detection algorithm. If the activation word detector 312n detects an activation word, the NMD 320 may process voice input contained in the received audio. Example activation word detection algorithms accept audio as input and provide an indication of whether an activation word is present in the audio. Many first-and third-party activation word detection algorithms are known and commercially available. For instance, operators of a voice service may make their algorithm available for use in third-party devices. Alternatively, an algorithm may be trained to detect certain activation words. In some example configurations, the activation word detector 312n runs multiple activation word detection algorithms on the received audio simultaneously (or substantially simultaneously). As noted above, different voice services (e.g., AMAZON's ALEXA®, APPLE's SIRI®, or MICROSOFT's CORTANA®) can each use a different activation word for invoking their respective voice service. To support multiple services, the activation word detector 312n may run the received audio through the activation word detection algorithm for each supported voice service in parallel.

The speech/text conversion components 312o may facilitate processing by converting speech in the voice input to text. In some example configurations, the electronics 312 can include voice recognition software that is trained to a particular user or a particular set of users associated with a household. Such voice recognition software may implement voice-processing algorithms that are tuned to specific voice profile(s). Tuning to specific voice profiles may require less computationally intensive algorithms than traditional voice activity services, which typically sample from a broad base of users and diverse requests that are not targeted to media playback systems.

FIG. 3F is a schematic diagram of an example voice input 328 captured by the NMD 320 in accordance with aspects of the disclosure. The voice input 328 can include an activation word portion 328a and a voice utterance portion 328b. In some example configurations, the activation word 557a can be a known activation word, such as “Alexa,” which is associated with AMAZON's ALEXA®. In other example configurations, however, the voice input 328 may not include an activation word. In some example configurations, a network microphone device may output an audible and/or visible response upon detection of the activation word portion 328a. In addition, or alternately, an NMD may output an audible and/or visible response after processing a voice input and/or a series of voice inputs.

The voice utterance portion 328b may include, for example, one or more spoken commands (identified individually as a first command 328c and a second command 328e) and one or more spoken keywords (identified individually as a first keyword 328d and a second keyword 328f). In one example, the first command 328c can be a command to play music, such as a specific song, album, playlist, etc. In this example, the keywords may be one or words identifying one or more zones in which the music is to be played, such as the Living Room and the Dining Room shown in FIG. 1A. In some examples, the voice utterance portion 328b can include other information, such as detected pauses (e.g., periods of non-speech) between words spoken by a user, as shown in FIG. 3F. The pauses may demarcate the locations of separate commands, keywords, or other information spoke by the user within the voice utterance portion 328b.

In some example configurations, the media playback system 100 is configured to temporarily reduce the volume of audio content that it is playing while detecting the activation word portion 557a. The media playback system 100 may restore the volume after processing the voice input 328, as shown in FIG. 3F. Such a process can be referred to as ducking, examples of which are disclosed in U.S. patent application Ser. No. 15/438,749, incorporated by reference herein in its entirety.

FIGS. 4A-4D are schematic diagrams of a control device 430 (e.g., the control device 130a of FIG. 1H, a smartphone, a tablet, a dedicated control device, an IoT device, and/or another suitable device) showing corresponding user interface displays in various states of operation. A first user interface display 431a (FIG. 4A) includes a display name 433a (i.e., “Rooms”). A selected group region 433b displays audio content information (e.g., artist name, track name, album art) of audio content played back in the selected group and/or zone. Group regions 433c and 433d display corresponding group and/or zone name, and audio content information audio content played back or next in a playback queue of the respective group or zone. An audio content region 433e includes information related to audio content in the selected group and/or zone (i.e., the group and/or zone indicated in the selected group region 433b). A lower display region 433f is configured to receive touch input to display one or more other user interface displays. For example, if a user selects “Browse” in the lower display region 433f, the control device 430 can be configured to output a second user interface display 431b (FIG. 4B) comprising a plurality of music services 433g (e.g., Spotify, Radio by Tunein, Apple Music, Pandora, Amazon, TV, local music, line-in) through which the user can browse and from which the user can select media content for play back via one or more playback devices (e.g., one of the playback devices 110 of FIG. 1A). Alternatively, if the user selects “My Sonos” in the lower display region 433f, the control device 430 can be configured to output a third user interface display 431c (FIG. 4C). A first media content region 433h can include graphical representations (e.g., album art) corresponding to individual albums, stations, or playlists. A second media content region 433i can include graphical representations (e.g., album art) corresponding to individual songs, tracks, or other media content. If the user selections a graphical representation 433j (FIG. 4C), the control device 430 can be configured to begin play back of audio content corresponding to the graphical representation 433j and output a fourth user interface display 431d fourth user interface display 431d includes an enlarged version of the graphical representation 433j, media content information 433k (e.g., track name, artist, album), transport controls 433m (e.g., play, previous, next, pause, volume), and indication 433n of the currently selected group and/or zone name.

FIG. 5 is a schematic diagram of a control device 530 (e.g., a laptop computer, a desktop computer). The control device 530 includes transducers 534, a microphone 535, and a camera 536. A user interface 531 includes a transport control region 533a, a playback status region 533b, a playback zone region 533c, a playback queue region 533d, and a media content source region 533e. The transport control region comprises one or more controls for controlling media playback including, for example, volume, previous, play/pause, next, repeat, shuffle, track position, crossfade, equalization, etc. The audio content source region 533e includes a listing of one or more media content sources from which a user can select media items for play back and/or adding to a playback queue.

The playback zone region 533b can include representations of playback zones within the media playback system 100 (FIGS. 1A and 1B). In some example configurations, the graphical representations of playback zones may be selectable to bring up additional selectable icons to manage or configure the playback zones in the media playback system, such as a creation of bonded zones, creation of zone groups, separation of zone groups, renaming of zone groups, etc. In the illustrated embodiment, a “group” icon is provided within each of the graphical representations of playback zones. The “group” icon provided within a graphical representation of a particular zone may be selectable to bring up options to select one or more other zones in the media playback system to be grouped with the particular zone. Once grouped, playback devices in the zones that have been grouped with the particular zone can be configured to play audio content in synchrony with the playback device(s) in the particular zone. Analogously, a “group” icon may be provided within a graphical representation of a zone group. In the illustrated embodiment, the “group” icon may be selectable to bring up options to deselect one or more zones in the zone group to be removed from the zone group. In some example configurations, the control device 530 includes other interactions and implementations for grouping and ungrouping zones via the user interface 531. In certain example configurations, the representations of playback zones in the playback zone region 533b can be dynamically updated as playback zone or zone group configurations are modified.

The playback status region 533c includes graphical representations of audio content that is presently being played, previously played, or scheduled to play next in the selected playback zone or zone group. The selected playback zone or zone group may be visually distinguished on the user interface, such as within the playback zone region 533b and/or the playback queue region 533d. The graphical representations may include track title, artist name, album name, album year, track length, and other relevant information that may be useful for the user to know when controlling the media playback system 100 via the user interface 531.

The playback queue region 533d includes graphical representations of audio content in a playback queue associated with the selected playback zone or zone group. In some example configurations, each playback zone or zone group may be associated with a playback queue containing information corresponding to zero or more audio items for playback by the playback zone or zone group. For instance, each audio item in the playback queue may comprise a uniform resource identifier (URI), a uniform resource locator (URL) or some other identifier that may be used by a playback device in the playback zone or zone group to find and/or retrieve the audio item from a local audio content source or a networked audio content source, possibly for playback by the playback device. In some example configurations, for example, a playlist can be added to a playback queue, in which information corresponding to each audio item in the playlist may be added to the playback queue. In some example configurations, audio items in a playback queue may be saved as a playlist. In certain example configurations, a playback queue may be empty, or populated but “not in use” when the playback zone or zone group is playing continuously streaming audio content, such as Internet radio that may continue to play until otherwise stopped, rather than discrete audio items that have playback durations. In some example configurations, a playback queue can include Internet radio and/or other streaming audio content items and be “in use” when the playback zone or zone group is playing those items.

When playback zones or zone groups are “grouped” or “ungrouped,” playback queues associated with the affected playback zones or zone groups may be cleared or re-associated. For example, if a first playback zone including a first playback queue is grouped with a second playback zone including a second playback queue, the established zone group may have an associated playback queue that is initially empty, that contains audio items from the first playback queue (such as if the second playback zone was added to the first playback zone), that contains audio items from the second playback queue (such as if the first playback zone was added to the second playback zone), or a combination of audio items from both the first and second playback queues. Subsequently, if the established zone group is ungrouped, the resulting first playback zone may be re-associated with the previous first playback queue, or be associated with a new playback queue that is empty or contains audio items from the playback queue associated with the established zone group before the established zone group was ungrouped. Similarly, the resulting second playback zone may be re-associated with the previous second playback queue, or be associated with a new playback queue that is empty, or contains audio items from the playback queue associated with the established zone group before the established zone group was ungrouped.

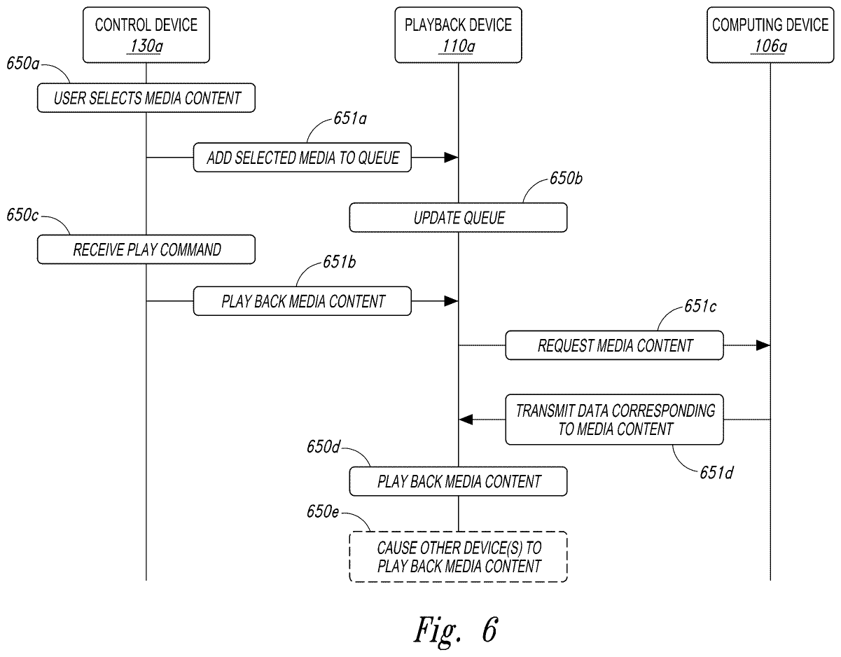

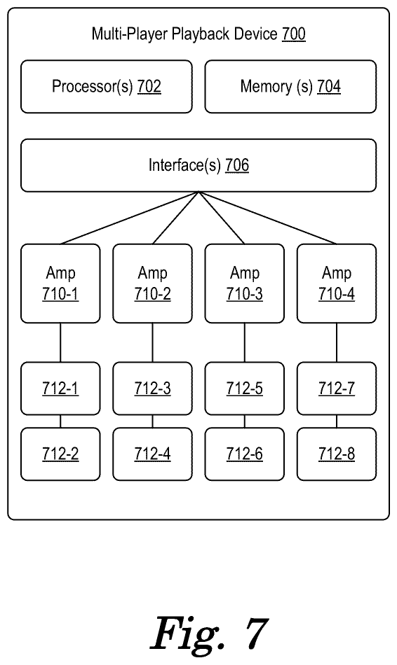

FIG. 6 is a message flow diagram illustrating data exchanges between devices of the media playback system 100 (FIGS. 1A-1M).

At step 650a, the media playback system 100 receives an indication of selected media content (e.g., one or more songs, albums, playlists, podcasts, videos, stations) via the control device 130a. The selected media content can comprise, for example, media items stored locally on or more devices (e.g., the audio source 105 of FIG. 1C) connected to the media playback system and/or media items stored on one or more media service servers (one or more of the remote computing devices 106 of FIG. 1B). In response to receiving the indication of the selected media content, the control device 130a transmits a message 651a to the playback device 110a (FIGS. 1A-1C) to add the selected media content to a playback queue on the playback device 110a.

At step 650b, the playback device 110a receives the message 651a and adds the selected media content to the playback queue for play back.

At step 650c, the control device 130a receives input corresponding to a command to play back the selected media content. In response to receiving the input corresponding to the command to play back the selected media content, the control device 130a transmits a message 651b to the playback device 110a causing the playback device 110a to play back the selected media content. In response to receiving the message 651b, the playback device 110a transmits a message 651c to the first computing device 106a requesting the selected media content. The first computing device 106a, in response to receiving the message 651c, transmits a message 651d comprising data (e.g., audio data, video data, a URL, a URI) corresponding to the requested media content.

At step 650d, the playback device 110a receives the message 651d with the data corresponding to the requested media content and plays back the associated media content.

At step 650e, the playback device 110a optionally causes one or more other devices to play back the selected media content. In one example, the playback device 110a is one of a bonded zone of two or more players (FIG. 1M). The playback device 110a can receive the selected media content and transmit all or a portion of the media content to other devices in the bonded zone. In another example, the playback device 110a is a coordinator of a group and is configured to transmit and receive timing information from one or more other devices in the group. The other one or more devices in the group can receive the selected media content from the first computing device 106a, and begin playback of the selected media content in response to a message from the playback device 110a such that all of the devices in the group play back the selected media content in synchrony.

IV. Example Multi-Player Playback Device

FIG. 7 shows an example block diagram of a Multi-Player Playback Device 700 configurable to implement from one to eight logical players according to some example embodiments.

As mentioned earlier, a Multi-Player Playback Device is a playback device comprising multiple configurable audio outputs, one or more processors, and tangible, non-transitory computer readable media storing program instructions that are executed by the one or more processors to cause the Multi-Player Playback Device to perform the Multi-Player Playback Device features and functions described herein. The Multi-Player Playback Device 700 can be configured to operate in any of the grouped configurations described herein, including but not limited to, the Area Zone configurations disclosed above. Further, when configured in an Area Zone configuration, the Multi-Player Playback Device 700 can be configured to perform any of the Area Zone features disclosed above, including but not limited to performing the functions of an Area Zone Primary and/or Area Zone Secondary.

The example Multi-Player Playback Device 700 illustrated in FIG. 7 includes one or more processors 702 and one or more tangible, non-transitory computer-readable memory 704. The tangible, non-transitory computer-readable memory 704 is configured to store program instructions that are executable by the one or more processors 702. When executed by the one or more processors 702, the program instructions cause the Multi-Player Playback Device 700 to perform the Multi-Player Playback Device functions disclosed and described herein.

Multi-Player Playback Device 700 also includes one or more network interfaces 706. The network interfaces may include any one or more (i) wired network interfaces, e.g., Ethernet, Universal Serial Bus, Firewire, Power-over-Ethernet, or any other type of wired network interface now known or later developed that is suitable for transmitting and receiving the types of data described herein and/or (ii) wireless network interfaces, e.g., WiFi, Bluetooth, 4G/5G, or any other type of wireless interface now known or later developed that is suitable for transmitting and receive the types of data described herein. The Multi-Player Playback Device 700 can also include a router component (e.g., hardware, firmware, software, or any combination thereof) configured to route data (including audio data and control data) to and from individual logical players and/or corresponding audio outputs. For example, the router component can be configured to route packets and/or frames received at the one or more network interfaces 706 to individual logical players and/or corresponding outputs based at least in part on logical player/output identifier data. Similarly, in some instances, the router component can be configured to route data (including audio and/or control data) between different logical players implemented by the Multi-Player Playback Device 700. The router component can also be configured to route data from a logical player implemented by the Multi-Player Playback Device 700 to the one or more network interfaces 706.

Multi-Player Playback Device 700 includes amplifiers 710-1, 710-2, 710-3, and 710-4, where each amplifier is connected to two audio outputs. In particular, (i) amplifier 710-1 is connected to audio outputs 712-1 and 712-2, (ii) amplifier 710-2 is connected to audio outputs 712-3 and 712-4, (iii) amplifier 710-3 is connected to audio outputs 712-5 and 712-6; and (iv) amplifier 710-4 is connected to audio outputs 712-7 and 712-8. Multi-Player Playback Device 700 includes four amplifiers 710-1 through 710-4 and eight audio outputs 712-1 through 712-8 as an illustrative example. Other embodiments may have a different number of amplifiers, a different number of audio outputs, and/or a different ratio of amplifiers to audio outputs.

In operation, the Multi-Player Playback Device 700 is configurable to implement from one to eight “logical” players. Each logical player (sometimes referred to herein as simply a player) can be addressed and managed within a playback system as a distinct playback entity.

In some embodiments, the Multi-Player Playback Device 700 is configured to operate within any of several different operating modes. In some embodiments, the Multi-Player Playback Device 700 is reconfigurable to switch between operating in one mode to operating in a different mode.

For example, in some embodiments, the Multi-Player Playback Device 700 is configurable to operate in a first mode where the Multi-Player Playback Device 700 is configured to implement eight single-channel logical players, where each logical player is configured to output single-channel audio from one of the eight audio outputs.

In this first mode of operation, each of the audio outputs 712-1 through 712-8 plays the same channel of audio. In some embodiments, the single-channel audio comprises a mono audio stream. In some embodiments, the single-channel audio comprises one channel from a multi-channel audio stream. In some scenarios, each of the eight logical players can be connected to a different speaker (e.g., free-standing speakers, speakers mounted in walls or ceilings, and so on) so that each connected speaker plays the same channel of audio. In some embodiments, all eight of the logical players are configured to output the same audio stream. In other embodiments, one or more of the logical players may be configured to output different audio than one or more other logical players.

In some embodiments, the Multi-Player Playback Device 700 is configurable to operate in a second mode where the Multi-Player Playback Device 700 is configured to implement four two-channel logical players, wherein each logical player is configured to output two-channel audio from two of the eight audio outputs.

In this second mode of operation, (i) a first logical player uses amp 710-1 to drive audio outputs 712-1 and 712-2 to output two channels of audio, (ii) a second logical player uses amp 710-2 to drive audio outputs 712-3 and 712-4 to output two channels of audio, (ii) a third logical player uses amp 710-3 to drive audio outputs 712-5 and 712-6 to output two channels of audio, and (iv) a fourth logical player uses amp 710-4 to drive audio outputs 712-7 and 712-8 to output two channels of audio. The two channels of audio could be left and right channels of a stereo audio stream. Alternatively, the two channels of audio could be any two different channels of a multichannel audio stream. In some embodiments, all four of the logical players are configured to output the same audio stream. In other embodiments, one or more of the logical players may be configured to output different audio than one or more other logical players.

In some embodiments, the Multi-Player Playback Device 700 is configurable to operate in a third mode where the Multi-Player Playback Device 700 is configured to implement two four-channel logical players, wherein each logical player is configured to output four-channel audio from four of the eight audio outputs.

In this third mode of operation, (i) a first logical player uses amps 710-1 and 710-2 to drive audio outputs 712-1, 712-2, 712-3, and 712-4 to output four channels of audio, and (ii) a second logical player uses amps 710-3 and 710-4 to drive audio outputs 712-5, 712-6, 712-7, and 712-8 to output four channels of audio. The four channels of audio could be front left, front right, rear left, and rear right channels of a surround sound audio stream. Alternatively, the four channels of audio could be any four different channels of a multichannel audio stream. In some embodiments, both of the logical players are configured to output the same audio stream. In other embodiments, one of the logical players may be configured to output different audio than the other logical player.

In some embodiments, the Multi-Player Playback Device 700 is configurable to operate in a fourth mode where the Multi-Player Playback Device 700 is configured to implement one eight-channel logical player, where the logical player is configured to output eight-channel audio from the eight audio outputs.

In this fourth mode of operation, a single logical player uses amps 710-1 through 710-4 to drive audio outputs 712-1 through 712-8 to output eight channels of audio. The eight channels of audio could be front left, front center, front right, rear left, rear center, rear right, left subwoofer, and right subwoofer channels of a surround sound audio stream. Alternatively, the eight channels of audio could be any eight different channels of a multichannel audio stream. In some embodiments, the logical player is configured to output the same channel of audio via each of the eight audio outputs.

Although four operating modes are described here for illustrative purposes, the Multi-Player Playback Device 700 in some embodiments is configurable to operate in other operating modes that include combinations of differently configured players. For example, in some embodiments, the Multi-Player Playback Device 700 is configurable to operate in a mode that includes (i) a first logical player that uses amps 710-1, 710-2, and 710-3 to drive audio outputs 712-1, 712-2, and 712-3 to output six channels of audio, and (ii) a second logical player uses amp 710-4 to drive audio output 712-8 to output one channel of audio. The Multi-Player Playback Device 700 can implement other combinations and configurations of amps and audio outputs to output different channels of audio content.

In some embodiments, several Multi-Player Playback Devices (e.g., several Multi-Player Playback Devices like Multi-Player Playback Device 700) can be bonded together to implement more sophisticated configurations of one or more logical players.

For example, in some embodiments, the Multi-Player Playback Device 700 is configured to selectively operate in any of a plurality of bonded modes comprising a first bonded mode and a second bonded mode.

In the first bonded mode, the Multi-Player Playback Device 700 is configured to operate in a bonded configuration with a second Multi-Player Playback Device that has eight audio outputs similar to Multi-Player Playback Device 700. In the first bonded mode, the Multi-Player Playback Device 700 and the second Multi-Player Playback Device are configured to implement a single logical player configured to output any of (i) one set of sixteen channels of audio, (ii) two sets of eight channels of audio, (iii) four sets of four channels of audio, (iv) eight sets of two channels of audio, or (v) sixteen single channels of audio.

In the second bonded mode, the Multi-Player Playback Device 700 operate in a bonded configuration with a second Multi-Player Playback Device and a third Multi-Player Playback Device, where the second Multi-Player Playback Device and the third Multi-Player Playback Device each have eight audio outputs similar to Multi-Player Playback Device 700. In the second bonded mode, the Multi-Player Playback Device 700, the second Multi-Player Playback Device, and the third Multi-Player Playback Device are configured to implement a single logical player configured to output any of (i) one set of twenty four channels of audio, (ii) two sets of twelve channels of audio, (iii) three sets of eight channels of audio, (iv) four sets of six channels of audio, (v) six sets of four channels of audio, (v) eight sets of three channels of audio, (vi) twelve sets of two channels of audio, or (vii) twenty four singles channels of audio.

### V. Graphical User Interface Examples

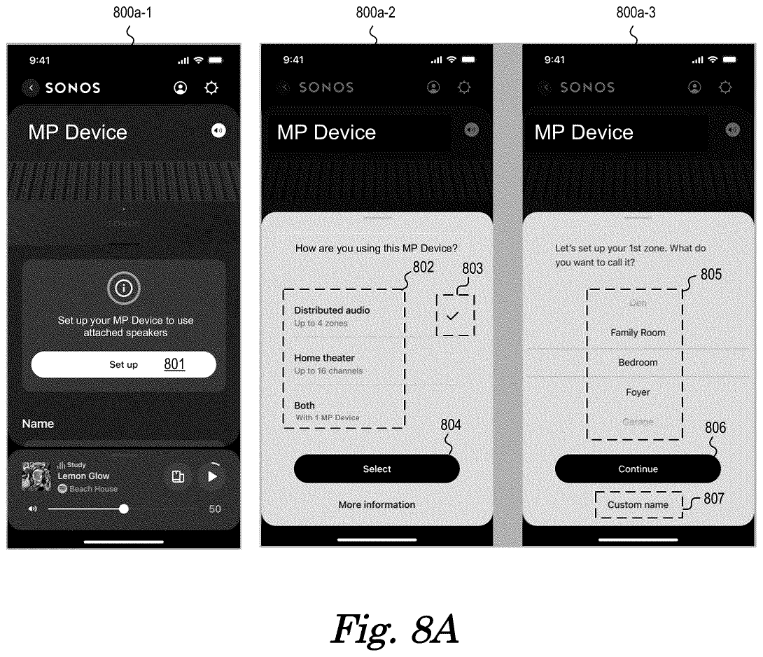

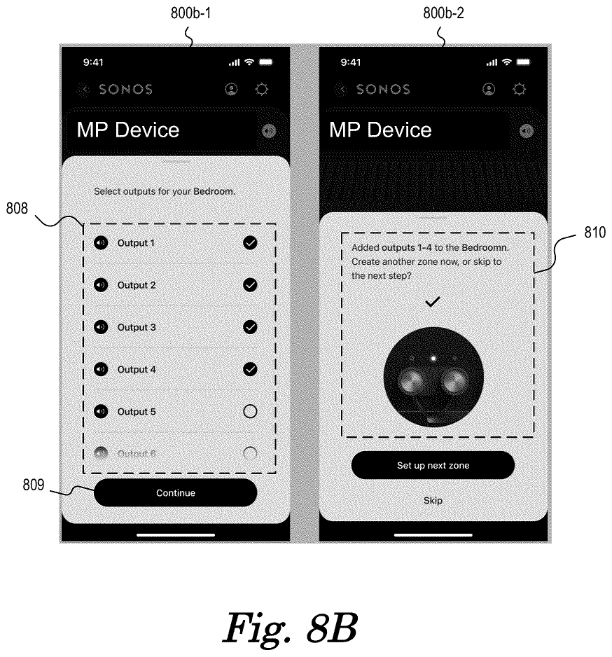

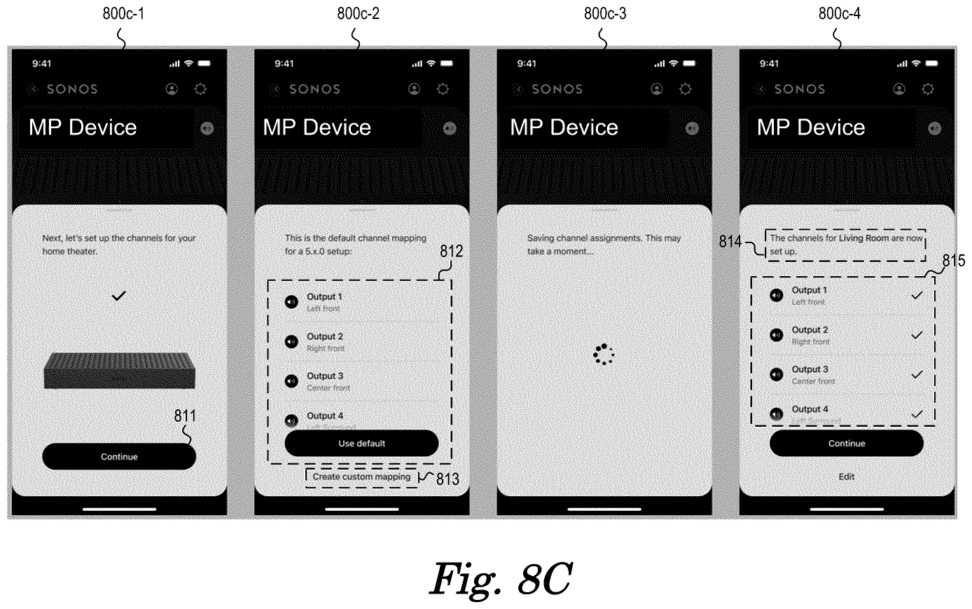

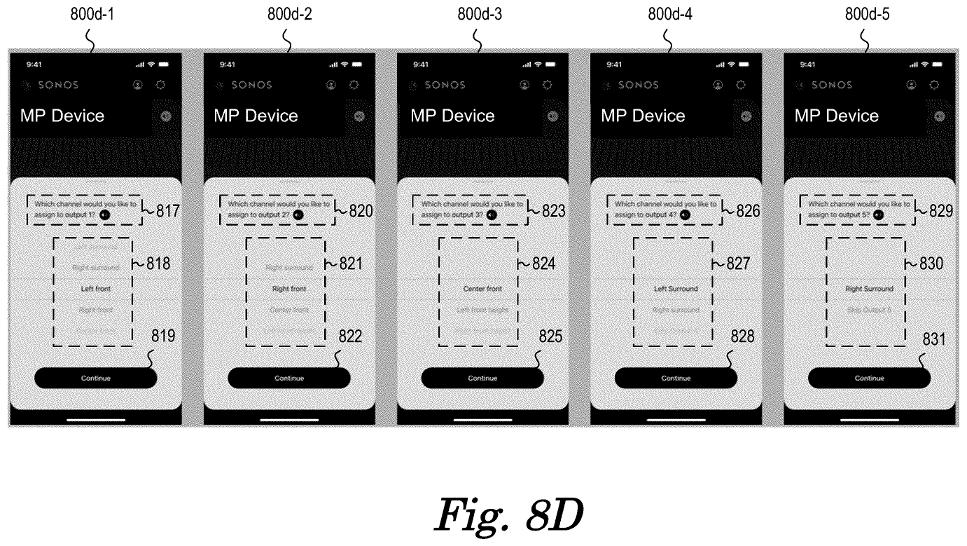

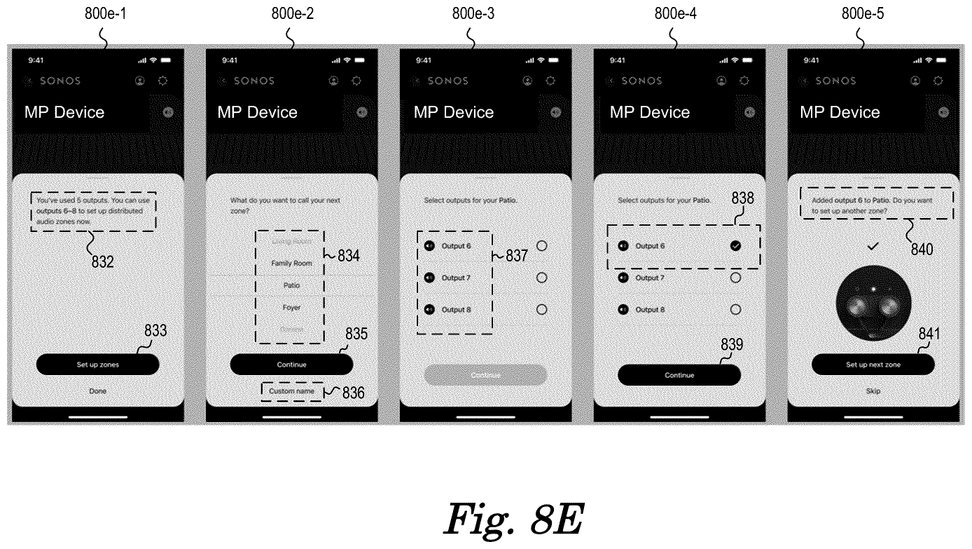

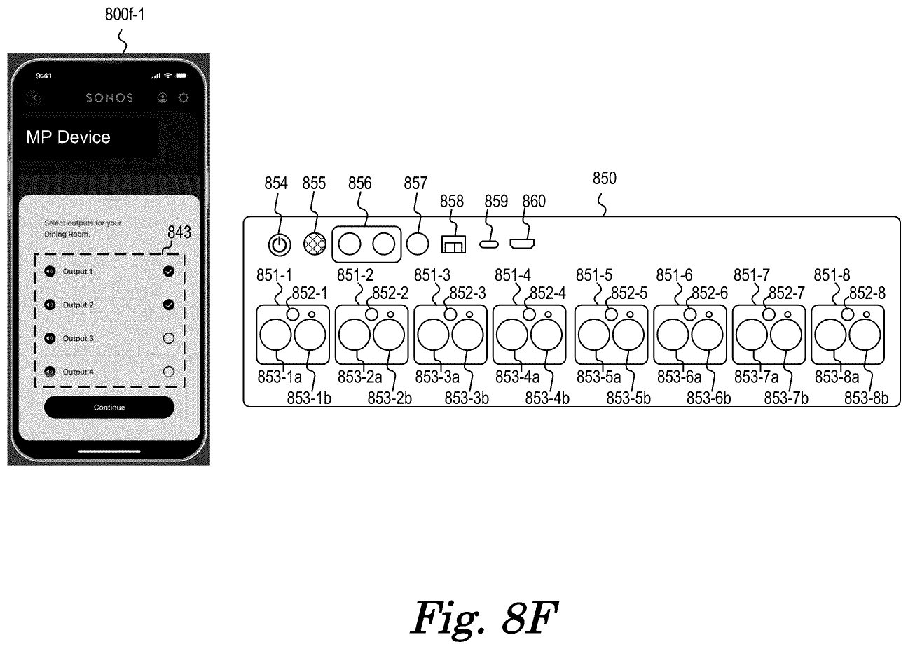

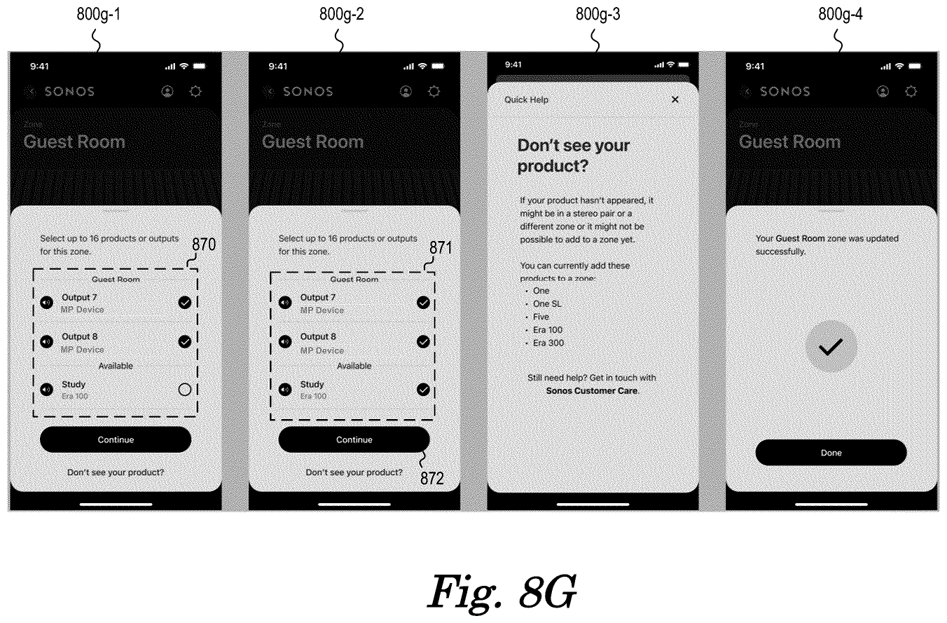

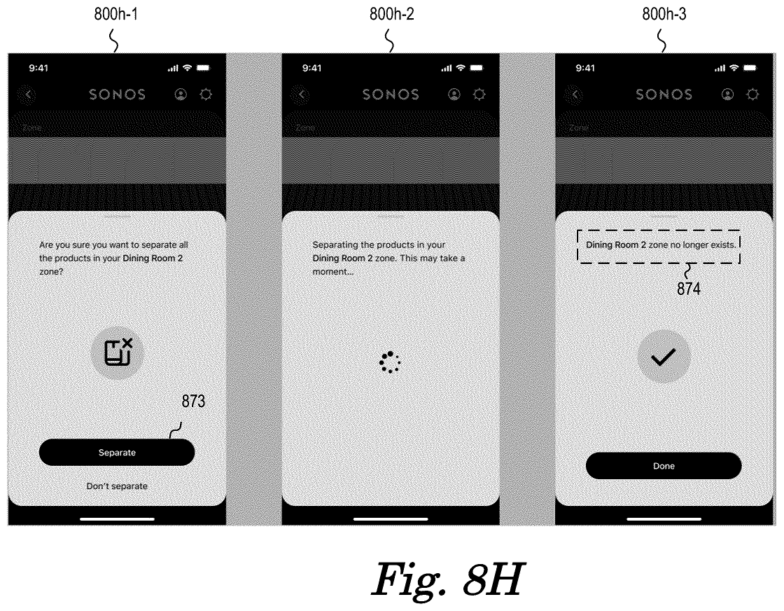

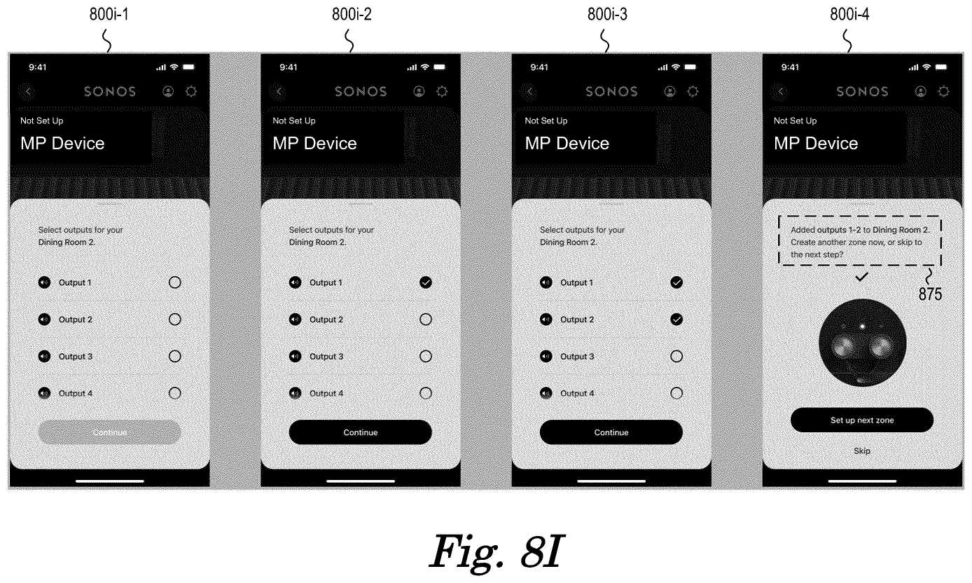

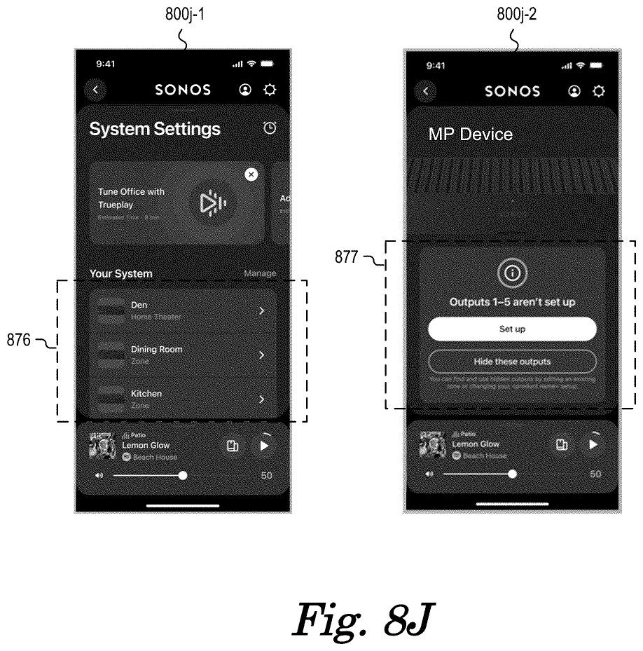

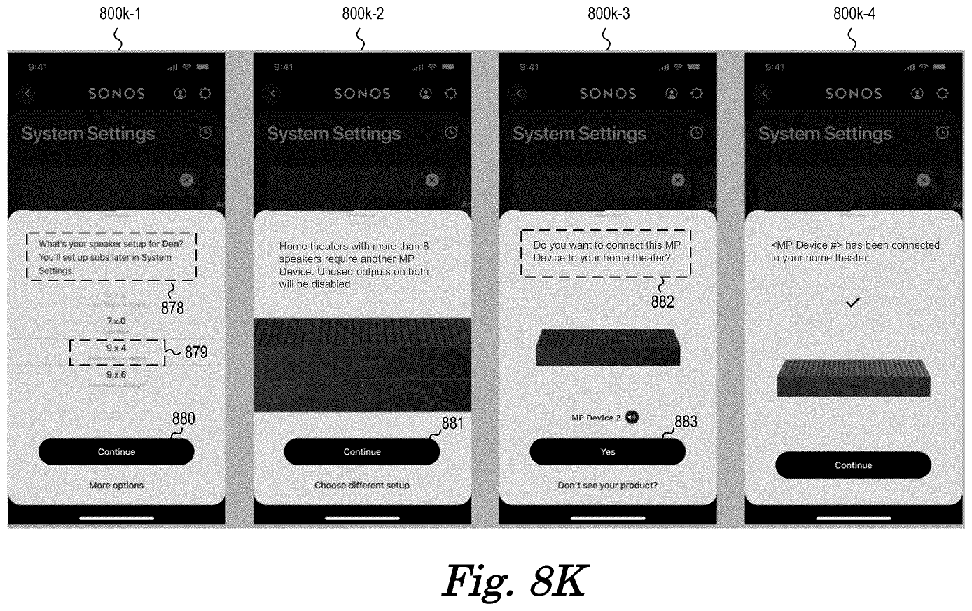

FIGS. 8A-8K show example Graphical User Interface screens for configuring a Multi-Player Playback Device, including screens for selecting configuration types, assigning outputs to zones, configuring default and custom channel mappings for home theater setups, setting up distributed audio zones, setting up distributed audio zones with home theater setups, managing zone assignments, adding and removing playback devices (including Multi-Player Playback Devices) to and from zones, configuring zones, managing system settings, hiding unused outputs, and configuring bonded home theater setups using two or more Multi-Player Playback Devices.

In some embodiments, the example GUI screens are displayed on the screen of a controller device, e.g., a smartphone, tablet computer, laptop computer, desktop computer, smartwatch, television, or similar computing device (or device with computing capabilities) that is configured to run controller application software for configuring and controller a playback system that includes one or more Multi-Player Playback Devices. For example, the GUI screens shown in and described with reference to FIGS. 8A-8K may be implemented via tangible, non-transitory computer-readable media comprising program instructions, wherein the program instructions, when executed by one or more processors, cause a computing device to perform the functions and features relating to generating and displaying the example GUI screens, receiving inputs via the example GUI screens, receiving data from and sending data to a Multi-Player Playback Device, and performing other functions in connection with configuring and controller the operation of Multi-Player Playback Devices to perform the functions described herein. In some examples, the program instructions (individually or in combination with the tangible, non-transitory computer-readable media on which they are stored) for performing the features and functions described with reference to FIGS. 8A-8K are sometimes referred to as a “controller application.”

The Multi-Player Playback Devices referred to the in the context of FIGS. 8A-8K may be the same as or similar to any of the example Multi-Player Playback Device embodiments disclosed and described herein, including but not limited to Multi-Player Playback Device 700 shown and described with reference to FIG. 7. Recall that the Multi-Player Playback Device embodiments disclosed herein each include a plurality of independently configurable audio outputs (e.g., two or more independently configurable outputs).

FIGS. 8A-8K show certain aspects of example Graphical User Interface screens for configuring a Multi-Player Playback Device for ease of illustration. Persons of skill in the art will understand that configuring one or more Multi-Player Playback Devices to play audio in distributed audio, home theater, and other groupwise playback configurations may include other steps implemented with other GUI screens not shown in FIGS. 8A-8K. Furthermore, even though most examples in this disclosure describe controlling the Multi-Player Playback Device via a controller application on a controller device via a GUI, other control mechanisms are possible. For example, the Multi-Player Playback Device can be controlled to perform any of the functions described herein via a Voice User Interface (VUI) on the Multi-Player Playback Device or on another device in the system, or via an Artificial Intelligence (AI) agent associated with the system, etc.

Further, in FIGS. 8A-8K, the example GUI screens refer to a Multi-Player Playback Device as a “MP Device” device. Persons of skill in the art will understand that a Multi-Player Playback Device could be called other names different than “MP Device.”

FIG. 8A shows example Graphical User Interface screens for selecting a configuration type and naming a first zone during setup of a Multi-Player Playback Device according to some embodiments.

The Multi-Player Playback Device includes a plurality of independently configurable audio outputs. In some embodiments, the Multi-Player Playback Device also maintains one or more configuration files that collectively store a plurality of settings of the Multi-Player Playback Device. In some embodiments, the plurality of settings includes (among other settings) one or more of, for each audio output of the Multi-Player Playback Device, (i) whether the audio output is assigned to a logical player, and (ii) for each assigned audio output, (a) a logical player to which the audio output is assigned, (b) an audio channel assigned to the audio output, and (c) a playback zone to which the logical player is assigned. In operation, the configuration files can be accessible by and editable via a set of application programming interfaces (APIs) implemented at the Multi-Player Playback Device. Commands, selections, and other inputs received via the GUI screens implemented by the controller application running on a controller device are incorporated into data messages transmitted to the Multi-Player Playback Device. After receiving such data messages from the controller device, the Multi-Player Playback Device in some instances uses the set of APIs to access configuration information and/or update configuration information for the Multi-Player Playback Device. Some embodiments include the Multi-Player Playback Device using the set of APIs to access the configuration files, and then transmit configuration information obtained from the configuration files to the controller device, which in turn displays the configuration information (or aspects thereof) to a user via one or more of the GUI screens.

Screen 800a-1 prompts a user to “Set up your MP Device to use attached speakers.” Upon detecting an activation of the “Setup” button 801, the controller application launches screen 800a-2, which presents the user with a prompt “How are you using this MP Device?”

In connection with the “How are you using this MP Device?” prompt, screen 800a-2 displays a plurality of selectable configuration processes shown within box 802.

In the example screen 800a-2, the configuration processes in box 802 include “Distributed audio” with a description indicating “Up to 4 zones,” “Home theater” with a description indicating “Up to 16 channels,” and “Both” with a description indicating “With 1 MP Device.” However, other example embodiments may include fewer configuration processes, additional configuration processes, different configuration processes and/or different descriptions. In some instances, the descriptions indicate current device and/or system capabilities. In operation, each selectable configuration process shown in box 802, when selected by a user, launches a different corresponding process for assigning one or more of the plurality of independently configurable audio outputs of the Multi-Player Playback Device to one or more playback zones of the media playback system and/or to one or more corresponding audio channels for playing audio content within one or more playback zones of the media playback system.

For example, selecting the “Distributed audio” process launches a first process for assigning one or more of the plurality of independently configurable audio outputs of the Multi-Player Playback Device to play audio in a “Distributed audio” configuration, selecting the “Home theater” process launches a second process for assigning one or more of the plurality of independently configurable audio outputs of the Multi-Player Playback Device to play audio in a “Home theater” configuration, and selecting the “Both” process launches a third process that includes aspects of the first process (for “Distributed audio”) and the second process (“Home theater”).

In some embodiments, the “Distributed audio” process can be used for configuring the Multi-Player Playback Device to implement one or more logical players (e.g., up to four logical players in the example depicted in box 802) that can each be configured to play different audio streams in different zones, where each logical player can be configured to output single-channel or multi-channel audio via one or more of the Multi-Player Playback Device's configurable audio outputs. The “Home theater” process can be used for configuring the Multi-Player Playback Device to implement a single logical player configured to play one or more channels of home theater audio content (e.g., up to 16 channels of home theater audio content in the example depicted in box 802 or more when grouped with additional Multi-Player Playback Devices, where different audio outputs of the Multi-Player Playback Device can be assigned to play different channels of the home theater audio content (e.g., left front, right front, center, surround channels, etc.). And the “Both” process can be used for configuring the Multi-Player Playback Device to implement both distributed audio zones and home theater zones simultaneously, where some of the Multi-Player Playback Device's audio outputs can be assigned to one or more distributed audio logical players while other audio outputs can be assigned to a home theater logical player.

In the example shown in FIG. 8A, a user has selected the “Distributed audio” process, as indicated by the check mark shown in box 803.

Upon detecting selection of one the “Distributed audio” process and activation of the “Select” button 804, the controller application launches screen 800a-3 for the “Distributed audio” process, thereby enabling the user to configure the Multi-Player Playback Device to play audio in a “Distributed audio” configuration.

Screen 800a-3 prompts the user to name their first zone by displaying “Let's set up your 1st zone. What do you want to call it?” Screen 800 a-3 provides several predefined zone name options in box 805, including “Den,” “Family Room,” “Bedroom,” “Foyer,” and “Garage,” as well as a “Custom name” option 807. After the user selects or enters a zone name and the controller application detects activation of the “Continue” button 806, the controller application may proceed with the “Distributed audio” zone configuration.

FIG. 8B shows example Graphical User Interface screens for selecting and assigning outputs to a zone during setup of a Multi-Player Playback Device according to some embodiments. The screens in FIG. 8B continue the “Distributed audio” configuration process that was initiated in FIG. 8A when the user selected “Bedroom” as the zone name in screen 800a-3.

Screen 800b-1 prompts the user to “Select outputs for your Bedroom” and displays a set of available audio outputs of the Multi-Player Playback Device that are available for assignment to the Bedroom zone. In the example shown, the controller application displays six independently configurable audio outputs labeled “Output 1” through “Output 6” in box 808.However, in embodiments where the Multi-Player Playback Device has fewer than 6 outputs, screen 800b-1 would include the corresponding number of available outputs (e.g., 2 outputs, 4 outputs, etc.). Similarly, in embodiments where the Multi-Player Playback Device has 8 outputs, screen 800b-1 additionally enables a user to scroll down (or “roll up”) the list of outputs in box 808 to see Output 7 and Output 8. For Multi-Player Playback Device embodiments that may include 8, 10, 12 or more outputs, box 808 would similarly be scrollable to reveal all of the audio outputs that are available for assignment to the Bedroom zone.

In operation, the controller application enables a user to select one or more of the available audio outputs for assignment to the Bedroom zone. In the example shown in screen 800b-1, the user has selected Outputs 1-4 as indicated by the check marks in box 808.

After the user has selected one or more available audio outputs and activates the “Continue” button 809, the controller application causes the Multi-Player Playback Device to (i) implement a first logical player associated with the Bedroom zone, (ii) assign the selected outputs (Outputs 1-4) to the first logical player for the Bedroom zone, and (iii) configure the first logical player to play audio content via the selected outputs. In some embodiments, causing the Multi-Player Playback Device to perform the above-listed functions includes sending a command, message, API call, or similar data transmission to the Multi-Player Playback Device with instructions sufficient to enable the Multi-Player Playback Device to perform the above-recited functions. After receiving the command, message, API call, or similar transmission with the instructions, the Multi-Player Playback Device uses the instructions to perform the steps of (i) implementing the first logical player associated with the Bedroom zone, (ii) assigning the selected outputs (Outputs 1-4) to the first logical player for the Bedroom zone, and (iii) configuring the first logical player to play audio content via the selected outputs.

Next, the controller application launches screen 800b-2, which confirms “Added outputs 1-4 to the Bedroom” and prompts the user to either “Set up next zone” or “Skip.” The confirmation message in box 810 confirms that the controller application has successfully caused the Multi-Player Playback Device to implement the first logical player and assign the selected outputs. In some examples, confirming that the Multi-Player Playback Device has implemented the first logical player and assigned the selected audio outputs to the first logical player includes sending a configuration request to the Multi-Player Playback Device and receiving configuration information from the Multi-Player Playback Device in response thereto, where the configuration information received from the Multi-Player Playback Device includes configuration information that enables the controller application to confirm that the Multi-Player Playback Device has indeed implemented the first logical player for the Bedroom zone and assigned Outputs 1-4 to the first logical player, thus configuring the Multi-Player Playback Device to play audio content via Outputs 1-4 in the Bedroom zone.

In some embodiments, after configuring the first logical player for the Bedroom zone, the controller application may additionally send a request to the Multi-Player Playback Device for an updated set of available/unused audio outputs. The set of available outputs that the Multi-Player Playback Device sends back to the controller application in response to the request for available outputs set would not include Outputs 1-4 since those outputs have been assigned to the Bedroom zone's logical player. In the example shown, Outputs 5 and 6 were not assigned to the Bedroom zone in screen 800b-1, so Outputs 5 and 6 would remain available for assignment to other zones.

FIG. 8C shows example Graphical User Interface screens for configuring default channel assignments for a home theater setup during configuration of a Multi-Player Playback Device according to some embodiments. In some scenarios, the configuration process selected from the plurality of selectable configuration processes (e.g., in box 802 of screen 800a-2 of Figure A) is a home theater configuration process. For example, the screens in FIG. 8C illustrate a configuration flow that begins when a user selects “Home theater” (rather than “Distributed audio”) from the configuration processes shown in box 802 of screen 800a-2 in FIG. 8A.

Screen 800c-1 prompts the user with “Next, let's set up the channels for your home theater.” At or before this time, the user may be given the option to select a zone name for their home theater zone (e.g., Living Room) in a manner similar as described above with reference to screen 800a-3. Additionally, the user may be given the option to select among a plurality of available home theater configurations (e.g., a 3.x.0 setup, a 5.x.0 setup, a 7.x.0, etc.). In some instances, the home theater configuration can be selected or suggested based on the current configuration of the device (e.g., how many outputs are available). The user may also be given the option to add and/or test a TV connection to the home theater setup (e.g., a TV connection to/via the Multi Player Playback Device). After detecting selection of the “Continue” box 811, the controller application presents a default channel mapping in screen 800c-2 for assigning specific audio outputs to standard home theater audio channels. Assuming that the user is configuring a 5.x.0 setup, the controller can display text indicating “This is the default channel mapping for a 5.x.0 setup.” The available home theater configurations depend on the Multi-Player Playback device capabilities and configuration such as the number of available outputs of the Multi-Player Playback Device, the number of subwoofer outputs available, whether there are other devices that can be included in the home theater setup (e.g., other playback devices including Multi-Player Playback Devices in the system), etc.

In some scenarios, implementation of the home theater configuration process includes displaying one or more audio channels available for assignment, including but not limited to one or more of (i) a left front channel, (ii) a right front channel, (iii) a center front channel, (iv) a left surround channel, (v) a right surround channel, and (vi) a subwoofer channel. For example, in screen 800c-2, the controller application displays the following default channel mapping in box 812: (i) Output 1 is mapped to “Left front”, (ii) Output 2 is mapped to “Right front”, (iii) Output 3 is mapped to “Center front”, and (iv) Output 4 is mapped to “Left Surround.” Additional mappings may be viewed by scrolling down the list shown in box 812. The “. x” in “5.x.0” indicates that one or more additional outputs may be mapped to one or more subwoofer channels.

Screen 800c-2 displays two options: (i) “Use default” button to accept the default channel mapping (shown in box 812), or (ii) “Create custom mapping” option 813 to configure a custom channel assignment. These options enable the user to either proceed with the pre-configured default mapping or create their own custom mapping of audio outputs to home theater channels. Screens 800c-3 and 800c-4 (in FIG. 8C) show example screens displayed after detecting activation/selection of the “Use default” button in screen 800c-2, whereas screens 800d-1 through 800d-5 (in FIG. 8D) show screens displayed after detecting activation/selection of the “Create custom mapping” option 813.

After detecting activation of the “Use default” button in screen 800c-2, the controller application sends commands to the Multi-Player Playback Device to (i) implement a logical player for the home theater configuration, and (ii) configure the logical player to output home theater audio content via the assigned outputs according to the default channel mapping. The Multi-Player Playback Device processes these commands using its configuration APIs to create and configure the logical player with the specified channel assignments. While the Multi-Player Playback Device is processing the configuration information, the controller application can display screen 800c-3, which shows “Saving channel assignments. This may take a moment...”

In some embodiments, after the controller application sends the configuration information based on the user selections in screen 800c-2, the controller application sends a configuration request to the Multi-Player Playback Device.

In response to the configuration request, the Multi-Player Playback Device accesses its configuration file and returns updated configuration information to the controller application. After receiving the updated configuration information from the Multi-Player Playback Device, the controller application confirms that the Multi-Player Playback Device has implemented the home theater channels according to the selections received in screen 800c-2.

In some embodiments, rather than the controller application sending a configuration request to the Multi-Player Playback Device after sending the configuration instructions (based on the user selections in screen 800c-2), the Multi-Player Playback Device is configured to send a configuration update to the controller application (or the controller device running the controller application) after implementing the configuration instructions.

But regardless of whether the controller device (via the controller application) expressly requests a configuration update or the Multi-Player Playback Device sends a configuration update as part of implementing the configuration instructions, screen 800c-4 displays a confirmation message (i.e., “The channels for Living Room are now set up”) in box 814, and indicates the home theater channel assigned to each audio output in box 815.

FIG. 8D shows example Graphical User Interface screens for assigning specific audio channels to individual outputs in a custom home theater configuration according to some embodiments. Whereas FIG. 8C shows example screens (e.g., 800c-3 and 800c-4) displayed in scenarios where the controller application has detected a selection/activation of the “User Default” button in screen 800c-2, FIG. 8D show example screens that would be displayed in scenarios where the controller application detects a selection/activation of the “Create custom mapping” option 813 in screen 800c-2 of FIG. 8C.

Screen 800d-1 prompts the user with “Which channel would you like to assign to output 1?” in box 817, along with a set of available home theater audio channels in box 818, including “Left surround,” “Left front,” “Right front,” “Center front,” “Left front height,” and “Right front height.” Screen 800d-1 shows that the Output 1 of the Multi-Player Playback Device has been assigned to the “Left front” channel because the “Left front” channel is highlighted in box 818.

After detecting activation or selection of the “Continue” box 819 in screen 800d-1, the controller application records the assignment of the “Left front” channel to Output 1. In some embodiments, the controller device sends the assignment (i.e., the assignment of the “Left front” channel to Output 1) to the Multi-Player Playback Device after detecting activation or selection of the “Continue” box 819 in screen 800d-1. However, in other embodiments, the controller device may instead collect audio channel assignments for each of the outputs before sending the channel assignment selections for all of the outputs to the Multi-Player Playback Device for implementation.

Screen 800d-2 prompts the user with “Which channel would you like to assign to output 2?” in box 820. Similar to screen 800 d-1, the controller application displays available home theater audio channels in box 821. Screen 800d-2 shows that the “Right front” has been assigned to Output 2 of the Multi-Player Playback Device because “Right Front” is highlighted in box 821. After detecting activation or selection of the “Continue” box 822 in screen 800d-2, the controller application records the assignment of the “Right front” channel to Output 2.

This channel assignment process for Output 1 and Output 2 in screens 800d-1 and 800d-2, respectively, continues through screens 800d-3, 800d-4, and 800d-5 for the “Center front”, “Left surround,” and “Right surround” channels, respectively. In operation, screens 800d-3, 800d-4, and 800d-5, display prompts in boxes 823, 826, and 829 along with available channels in boxes 824, 827, and 830 that can be selected and added to the channel assignments the continue buttons 825, 828, and 831. The controller application maintains and updates the list of available channels shown in boxes 824, 827, and 830, removing channels that have already been assigned to prevent duplicate assignments.

As mentioned earlier, in some configurations, after the audio channels have been assigned to the outputs of the Multi-Player Playback Device, the controller application sends one or more data messages to the Multi-Player Playback Device to implement the set of audio channel assignments. The one or more data messages cause the Multi-Player Playback Device to (i) implement a logical player for the home theater configuration (to the extent that a logical player for the home theater configuration may not have already been created), and (ii) configure the logical player (implemented by the Multi-Player Playback Device) to output channels of home theater audio according to channel assignments.

In some embodiments, after the Multi-Player Playback Device receives the one or more data messages (comprising the channel assignments) from the controller device, the Multi-Player Playback Device uses one or more APIs to one or both (i) create a logical player for the home theater configuration (to the extent that a logical player for the home theater configuration may not have already been created), and (ii) configure the logical player to output channels of home theater audio according to channel assignments.

Similar to the process described for the default channel mapping configuration with reference to FIG. 8C, the Multi-Player Playback Device returns updated configuration information to the controller application, either in response to a configuration request or automatically after implementing the configuration instructions. This enables the controller application to confirm that the Multi-Player Playback Device has properly implemented the custom home theater channel assignments according to channel assignments.

FIG. 8E shows example Graphical User Interface screens for configuring distributed audio zones using available audio outputs according to some embodiments.

Recall from earlier that selecting the “Both” process in box 802 of screen 800a-2 in FIG. 8A launches a third process that includes aspects of the “Distributed audio” and the “Home theater” process. The scenario illustrated FIG. 8E is consistent with a scenario where (i) the “Both” process in box 802 of screen 800a-2 has been selected, (ii) audio outputs 1-5 of the Multi-Player Playback Device have been assigned to home theater channels for a home theater configuration according to the “Home theater” process (e.g., as shown in FIG. 8C (default channel assignments) and FIG. 8D (custom channel assignments)), and (iii) the remaining outputs (e.g., outputs 6-8) remain available for assignment according to the “Distributed audio” process.

Screen 800e-1 informs the user that “You've used 5 outputs. You can use outputs 6-8 to set up distributed audio zones now” in box 832. After detecting selection or activation of the “Set up zones” button 833, the controller application displays screen 800e-2, which prompts the user for a name to call the new playback zone.

Screen 800e-2 displays several predefined zone name options in box 834, including “Family Room,” “Patio,” “Foyer,” and “Garage,” as well as a “Custom name” option 836. After detecting selection of “Patio” and activation of the “Continue” button 835, the controller application launches screen 800e-3.

Screen 800e-3 displays a set of available audio outputs for assignment to the Patio zone in box 837. The controller application shows Output 6, Output 7, and Output 8 as available for assignment, since Outputs 1-5 were previously assigned to the home theater configuration in one of FIG. 8C or 8D. After detecting selection of Output 6 in box 838 and activation of the “Continue” button 839 in screen 800e-4, the controller application launches screen 800e-5.

Screen 800e-5 displays a confirmation message “Added output 6 to Patio” in box 840 and prompts “Do you want to set up another zone?” The controller application provides an option to “Set up next zone” via button 841.

In some embodiments, after detecting the output selection for the Patio zone, the controller application sends one or more commands to the Multi-Player Playback Device to (i) implement a logical player for the Patio zone, and (ii) configure the logical player to output audio content via Output 6. As described previously, and as explained further herein, the Multi-Player Playback Device processes these commands received from the controller application, and uses one or more APIs create and configure the logical player with the audio output assignment based on the one or more commands.

Similar to previously described configuration processes, the Multi-Player Playback Device may return updated configuration information to the controller application, either (i) in response to a configuration information request or (ii) automatically after implementing the configuration instructions. This enables the controller application to confirm that the Multi-Player Playback Device has properly implemented the distributed audio zone configuration with the correct output assignment.

FIG. 8F shows an example Graphical User Interface screen and a Multi-Player Playback Device in connection with identifying and confirming audio output connections according to some embodiments.

The Multi-Player Playback Device 850 includes a plurality of independently configurable audio outputs 851-1 through 851-8. Each audio output includes (i) a positive speaker interface (e.g., 853-1a for output 851-1), (ii) a negative or return speaker interface (e.g., 853-1b for output 851-1), and (iii) an associated user interface element such as an indicator light (e.g., 852-1 for output 851-1). The Multi-Player Playback Device 850 can also include a power button 854, one or more local speakers 855, one or more line-in interfaces 856, one or more subwoofer outputs 857, one or more data communication interfaces such as an ethernet interface 858, a USB interface 859, and an HDMI interface 860.

Screen 800f-1 displays a set of available audio outputs in box 843 that can be selected for identification. After detecting selection of an individual audio output (e.g., Output 1), the controller application sends an audio output identification command to the Multi-Player Playback Device 850.

After receiving the audio output identification command, the Multi-Player Playback Device 850 one or both (i) plays an audio indication via a speaker connected to the selected individual audio output (e.g., Output 1 implemented as 851-1 at Multi-Player Playback Device 850), and (ii) activates an indicator light associated with a physical interface on the Multi-Player Playback Device 850 corresponding to the selected individual audio output (e.g., indicator light 852-1 for Output 1 implemented as 851-1 at Multi-Player Playback Device 850).

For example, after detecting selection of Output 1 in screen 800f-1, the controller application sends one or more commands that cause the Multi-Player Playback Device 850 to (i) play an audio indication via speakers connected to output 851-1 and (ii) activate indicator light 852-1. The audio indication plays for a duration of time sufficient for a user to confirm which speaker is (or which speakers are) connected to output 851-1, and the indicator light 852-1 flashes on and off for a duration of time sufficient for a user to confirm which physical interface corresponds to Output 1, thus enabling the user to confirm that Output 1 shown in screen 800f-1 does indeed correspond to physical interface 851-1 on Multi-Player Playback Device 850. These indications to identify the selected outputs can be provided, for example, when the user is selecting outputs for a particular zone (e.g., as described with reference to screen 800b-1 in FIG. 8B). In this way, the user can ensure that the output selected via the user interface corresponds to the particular connection on the Multi-Player Playback Device. In some examples, the indications can be provided at any time when the user wishes to identify outputs of the Multi-Player playback device.

In some embodiments, the Multi-Player Playback Device 850 processes these identification commands using a specific API (e.g., startOutputAudioClip) that enables playing identification tones through specific outputs while simultaneously (or alternatively) controlling corresponding indicator light behavior. The API may include parameters for specifying the output index, number of audio clip repeats, LED behavior, and whether to cancel any currently running identification signals. The audio and/or light indications provided by the Multi-Player Playback Device can be provided at any suitable time and have any suitable behavior. For example, when a zone is created and outputs are assigned to the zone, the corresponding light and/or sound indications for the outputs assigned to the zone could be provided as confirmation that the zone has been created and/or as a means to identify outputs associated with a particular zone. In this way, if the user creates a “Bedroom” zone and assigns Output 1 and Output 2 to the Bedroom zone, both light indicators corresponding to Outputs 1 and 2 could be provided so as to indicate that both outputs are assigned to the zone (e.g., the LEDs can turn the same color and/or flash/breathe at the same pattern so as to indicate that they belong to a same zone). Similarly, all speakers in a zone connected to corresponding outputs assigned to the zone could play a chime so that the user can identify the speakers in the zone.

FIG. 8G shows example Graphical User Interface screens for adding audio outputs of a Multi-Player Playback Device and a separate zone player to an existing playback zone according to some embodiments. The screens illustrate a process for updating the previously-configured “Guest Room” zone by adding both (i) additional outputs from a Multi-Player Playback Device and (ii) a zone player to the Guest Room zone.

Screen 800g-1 prompts the user to “Select up to 16 products or outputs for this zone” in box 870 (as explained, other number of products different than 16 are possible). The controller application displays a list of available outputs and playback devices in box 870 that can be selected and added to the Guest Room zone, including Output 7 and Output 8 from the Multi-Player Playback Device, and an Era 100 zone player that is currently part of the Study zone.

After detecting selection of Output 7, Output 8, and the Era 100 zone player from the Study zone in box 871, and activation of the “Continue” button 872, the controller application sends one or more commands to the Multi-Player Playback Device to update the Guest Room zone configuration. In particular, the controller application causes the Multi-Player Playback Device to (i) assign Output 7 and Output 8 to a logical player for the Guest Room zone (which may be a previously-configured logical player for the Guest Room zone or could perhaps be a newly-created logical player that will be added to the Guest Room zone), and (ii) add the Era 100 zone player from the Study zone to the Guest Room zone.

In some embodiments, after receiving the zone update request from the controller application, the Multi-Player Playback Device uses one or more APIs to (i) assign Output 7 and Output 8 to the logical player for the Guest Room zone and/or configure the logical player to play audio content via Output 7 and Output 8, and (ii) add the Era 100 zone player to the Guest Room zone configuration stored in the Multi-Player Playback Device's configuration file.

Screen 800g-3 provides helpful information for a user in a scenario where a desired product to be added to the playback zone does not appear in the list of available products to be added to the zone (e.g., when the desired product to be added to the zone does not appear in the list shown in box 870 of screen 800g-1 or box 871 of screen 800g-2).

Screen 800g-4 displays a confirmation message that “Your Guest Room zone was updated successfully,” thus confirming that Output 7, Output 8, and the Era 100 zone player have been successfully added to the Guest Room zone.

In some embodiments, after updating the Guest Room zone configuration, the Multi-Player Playback Device returns updated configuration information to the controller application, either (i) in response to a configuration request or (ii) automatically after implementing the configuration instructions. This updated configuration information enables the controller application to confirm that the Multi-Player Playback Device has properly implemented the updated zone configuration that includes both (i) the updated logical player implemented by the Multi-Player Playback Device (or perhaps newly-created logical player) that plays audio via Output 7 and Output 8, and (ii) the Era 100 zone player that was previously part of the Study zone.

FIG. 8H shows example Graphical User Interface screens for separating or removing components from an existing zone according to some embodiments. The screens illustrate an example that includes removing outputs and/or playback devices from a previously configured “Dining Room 2” zone.

Screen 800h-1 prompts the user with “Are you sure you want to separate all the products in your Dining Room 2 zone?” and displays two options selection: “Separate” or “Don't separate” to confirm or cancel the zone separation request.

After detecting selection of the “Separate” option 873 in screen 800h-1, the controller application sends a playback zone deletion request (e.g., one or more commands and/or instructions to delete the playback zone) to the Multi-Player Playback Device. The deletion request includes an indication of the Dining Room 2 zone to be deleted from the Multi-Player Playback Device.

In some embodiments, while the Multi-Player Playback Device processes the deletion request, the controller application displays screen 800h-2 with the message “Separating the products in your Dining Room 2 zone. This may take a moment . . . ”

In some embodiments, after receiving the request to delete the Dining Room 2 zone, the Multi-Player Playback Device uses one or more of its APIs to delete the logical player for the Dining Room 2 zone from its configuration file. Recall that the Multi-Player Playback Device maintains a configuration file with a plurality of settings, including for each audio output of the Multi-Player Playback Device, (i) whether the audio output is assigned to a logical player, and (ii) for each assigned audio output, (a) a logical player to which the audio output is assigned, (b) an audio channel assigned to the audio output, and (c) a playback zone to which the logical player is assigned.

In some embodiments, deleting the logical player includes using the one or more of the APIs implemented at the Multi-Player Playback Device to (i) remove all assignments between the logical player and its assigned audio outputs, (ii) update the configuration file to indicate that the previously-assigned audio outputs are no longer assigned to any logical player, and (iii) update the configuration file to remove the association between the logical player and the Dining Room 2 zone, thereby making the previously-assigned audio outputs available for reassignment to other logical players and zones. After the logical player has been deleted, the Multi-Player Playback Device may transmit updated configuration information to the controller application indicating that the previously-assigned outputs are now available for assignment to other zones.

Screen 800h-3 displays a confirmation message that “Dining Room 2 zone no longer exists” in box 874, confirming that the zone has been successfully deleted and its components are now available for reassignment to other zones.

In some embodiments, after the zone deletion is complete, the controller application may send a request to the Multi-Player Playback Device for an updated set of available audio outputs. The set of available outputs returned by the Multi-Player Playback Device would now include any outputs that were previously assigned to the deleted Dining Room 2 zone.

FIG. 8I shows example Graphical User Interface screens for selecting and configuring audio outputs of a Multi-Player Playback Device for a zone according to some embodiments. The screens illustrate a process for updating an existing zone configuration by selecting and configuring additional outputs for the “Dining Room 2” zone.

Screen 800i-1 prompts the user to “Select outputs for your Dining Room 2” and displays a set of available audio outputs, including “Output 1,” “Output 2,” “Output 3,” and “Output 4.” Since Outputs 5-8 are not displayed as available for selection, Outputs 5-8 might have already been configured for/assigned to a different zone.

Screen 800i-2 shows that Output 1 has been selected for addition to the “Dining Room 2” zone. Screen 800i-3 shows that Output 2 has also been selected for addition to the “Dining Room 2” zone such that the set of outputs to be added to the “Dining Room 2” zone includes Output 1 and Output 2.

After the selection of Output 1 and Output 2 and detecting activation of the “Continue” button in screen 800i-1, the controller application sends a request (e.g., via one or more data messages) to the Multi-Player Playback Device to add the selected outputs to the Dining Room 2 zone. The request includes audio output assignments for Output 1 and Output 2.

In some embodiments, after receiving the request to add the additional audio outputs to the Dining Room 2 zone, the Multi-Player Playback Device uses one or more of its APIs to add the audio outputs corresponding to the audio output assignments (i.e., Output 1 and Output 2) to the logical player for the Dining Room 2 zone.

Screen 800i-4 displays a confirmation message that states, “Added outputs 1-2 to Dining Room 2” in box 875 and asks whether the user wants to “Create another zone now, or skip to the next step?”

In some embodiments, after adding the additional outputs to the logical player for the Dining Room 2 zone, the Multi-Player Playback Device updates its configuration file to reflect the new assignments. Specifically, the configuration file is updated to indicate that (i) Output 1 and Output 2 are now assigned to a logical player, (ii) the logical player to which Output 1 and Output 2 are assigned is the logical player associated with the Dining Room 2 zone, and (iii) the audio channel assignments (if any) for Output 1 and Output 2.

After updating the configuration file, the Multi-Player Playback Device may return updated configuration information to the controller application, either in response to a configuration request or automatically after implementing the configuration instructions. This enables the controller application to confirm that the Multi-Player Playback Device has properly implemented the updated zone configuration with the newly added outputs.

FIG. 8J shows example Graphical User Interface screens for managing system settings and hiding unused audio outputs of a Multi-Player Playback Device according to some embodiments.

Screen 800j-1 displays a system settings interface showing the current system configuration in box 876, which includes configured zones for the Den, Dining Room, and Kitchen. Screen 800j-2 indicates that “Outputs 1-5 aren't set up” in box 877.

After detecting selection of the “Set up” option associated with the unconfigured outputs notification, the controller application may display a screen such as screen 800a-2 (FIG. 8A), which presents the user with a plurality of selectable configuration processes, where each selectable configuration process, when selected, launches a different corresponding process for assigning one or more of the plurality of independently configurable audio outputs of the Multi-Player Playback Device to one or more corresponding audio channels for playing audio content within one or more playback zones of the media playback system.

In the example screen 800a-2, the configuration processes in box 802 include “Distributed audio” with a description indicating “Up to 4 zones,” “Home theater” with a description indicating “Up to 16 channels,” and “Both” with a description indicating “With 1 MP Device.” However, other example embodiments may include fewer configuration processes, additional configuration processes, and/or different configuration processes. In operation, each selectable configuration process shown in box 802, when selected by a user, launches a different corresponding process for assigning one or more of the plurality of independently configurable audio outputs of the Multi-Player Playback Device to one or more corresponding audio channels for playing audio content within one or more playback zones of the media playback system.

In operation, after selecting the “Set up” option in screen 800j-2 and launching a setup screen (e.g., screen 800a-2), the controller device can then display corresponding screens from any of FIGS. 8A through 8I to configure the un-configured Outputs 1-5.

In some embodiments, after detecting selection of the “Hide these outputs” option in screen 800j-2, the controller application hides the unconfigured audio outputs within the graphical user interface. The controller application in some examples may additionally display a message indicating “You can find and use hidden outputs by editing an existing zone or changing your setup.”

In some embodiments, after detecting selection of the “Hide these outputs” option in screen 800j-2, the unconfigured outputs can be hidden in one of at least two ways.

First, the controller application itself can be configured to hide the unconfigured outputs within its graphical user interface. In this approach, even when the Multi-Player Playback Device returns information about unconfigured Outputs 1-5 in response to configuration requests, the controller application refrains from displaying those outputs until the controller application has been reconfigured to show the “hidden” outputs again.

Second, the Multi-Player Playback Device can be configured to hide the unconfigured outputs at the device level. In this approach, after receiving instructions from the controller application to hide Outputs 1-5, the Multi-Player Playback Device updates its configuration file to indicate that these unconfigured outputs should not be included in responses to configuration requests. The outputs remain “hidden” until the Multi-Player Playback Device is reconfigured to include them in its responses again.

In either approach, the hidden outputs remain accessible and can be revealed later by editing zones or changing the Multi-Player Playback Device configuration through the appropriate GUI screens.

FIG. 8K shows example Graphical User Interface screens for configuring a bonded home theater setup using multiple Multi-Player Playback Devices according to some embodiments. The screens illustrate the process of implementing a single logical player that supports more than the number of audio channels of the example Multi-Player Playback Devices by combining the outputs of multiple Multi-Player Playback Devices for the logical player such that the audio outputs of multiple Multi-Player Playback Devices are assigned to a single logical player.

Screen 800k-1 asks a user, “What's your speaker setup for Den?” in box 878, and presents several home theater configuration options for selection, including “5.x.2” (5 ear-level +2 height channels), “7.x.0” (7 ear-level channels), “9.x.4” (9 ear-level+4 height channels), and “9.x.6” (9 ear-level+6 height channels). In the example shown in FIG. 8K, the “9.x.4” (9 ear-level+4 height channels) configuration has been selected in box 879 and will be added to the configuration after activation of the “Continue” button 880. Since the selected “9.x.4” configuration requires at least 13 audio channels (not including potential subwoofer channels), and each Multi-Player Playback Device used in this example scenario has eight independently configurable audio outputs, implementing this configuration requires at least two Multi-Player Playback Devices working together in a bonded configuration.

In the bonded configuration, two or more Multi-Player Playback Devices can be configured to operate in concert with each other to flexibly route different audio content to different speakers or groups of speakers connected to the Multi-Player Playback Devices. The group of Multi-Player Playback Devices plays the audio content routed to their connected speakers in a groupwise fashion, with each Multi-Player Playback Device playing its assigned channels in synchrony with the other Multi-Player Playback Device(s). For example, once the two Multi-Player Playback Devices in this scenario have been bonded together, and once the bonded configuration of Multi-Player Playback Devices has been configured to implement a logical player for the “9.x.4” home theater configuration, the Multi-Player Playback Devices in the bonded configuration will play audio content from each output that is assigned to the logical player for the “9.x.4” home theater configuration.

After detecting selection of the “9.x.4” home theater configuration in screen 800k-1, the controller application displays screen 800k-2, which informs the user that “Home theaters with more than 8 speakers require another MP Device” (i.e., Multi-Player Playback Device). The screen further explains that “Unused outputs on both will be disabled.” In some embodiments, implementing a single logical player across multiple Multi-Player Playback Devices requires dedicating the outputs of the Multi-Player Playback Device to the home theater configuration. However, in other example embodiments, unused output ports on one or both of the bonded Multi-Player Playback Devices may be assigned to other zone or different home theater configuration. After detecting selection of the “Continue” option 881 in screen 800k-2, the controller application displays screen 800k-3.

Screen 800k-3 prompts “Do you want to connect this MP Device to your home theater?” at box 882. After detecting selection of the “Yes” option 883, the controller application sends one or more home theater playback zone creation commands to the first Multi-Player Playback Device. In some embodiments, these one or more home theater playback zone creation commands includes both a home theater playback zone identifier and an identification of at least a second Multi-Player Playback Device with which to create the home theater playback zone.

Recall that when operating in a bonded configuration, multiple Multi-Player Playback Devices are configured to implement a single logical player capable of outputting multiple channels of audio. For example, two 8-output Multi-Player Playback Devices can be configured to implement a single logical player capable of outputting: (i) one set of sixteen channels of audio, (ii) two sets of eight channels of audio, (iii) four sets of four channels of audio, (iv) eight sets of two channels of audio, or (v) sixteen single channels of audio. This flexibility enables sophisticated home theater configurations like the selected 9.x.4 home theater configuration selected in screen 800k-1.

In operation, the Multi-Player Playback Device processes the one or more home theater playback zone creation command(s) received from the controller device using one or more specific APIs. After receiving the home theater playback zone creation command(s), the Multi-Player Playback Device uses one or more APIs to create a logical player with the second Multi-Player Playback Device. Then, Multi-Player Playback Device uses one or more APIs to associate audio outputs from both of the Multi-Player Playback Devices to the single logical player for the 9.x.4 home theater configuration. Some embodiments additionally include configuring each output assigned to the logical player to play a corresponding assigned home theater audio channel (i.e., each output is configured to play one of the thirteen audio channels).

In some examples where the configuration includes one subwoofer channel, then the logical player would include 14 (rather than 13) assigned outputs, and each of the 14 outputs would be assigned to play one of the 14 audio channels, i.e., the 9 ear level channels, the 4 height channels, and the 1 subwoofer channel. In some embodiments, the subwoofer outputs are independent from the other audio outputs of the Multi-Player Playback Device (e.g., subwoofer output 857 in FIG. 8F is independent from audio outputs 851) and can be dynamically assigned to any of the zones or logical players implemented by the Multi-Player Playback Device.

The configuration process also includes updating the configuration files maintained by each Multi-Player Playback Device. Recall that the configuration file maintained by each Multi-Player Playback Device stores settings for each audio output including: (i) whether the output is assigned to a logical player, (ii) the logical player assignment, (iii) the audio channel assigned to the output, and (iv) the playback zone to which the logical player is assigned.

Screen 800k-4 displays a confirmation message that “<MP Device #> has been connected to your home theater.” This confirmation appears after the Multi-Player Playback Devices have successfully: (i) created the logical player for the home theater configuration, (ii) configured the logical player to output home theater audio content via the assigned outputs across both devices according to the 9.x.4 channel mapping, and (iii) returned updated configuration information to the controller device confirming the implementation.

### VI. Example Methods

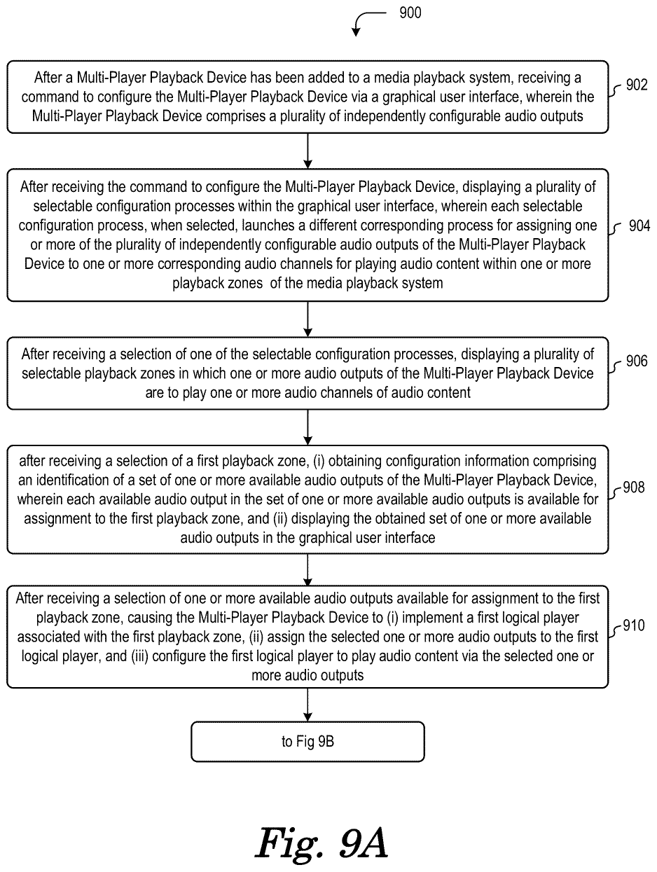

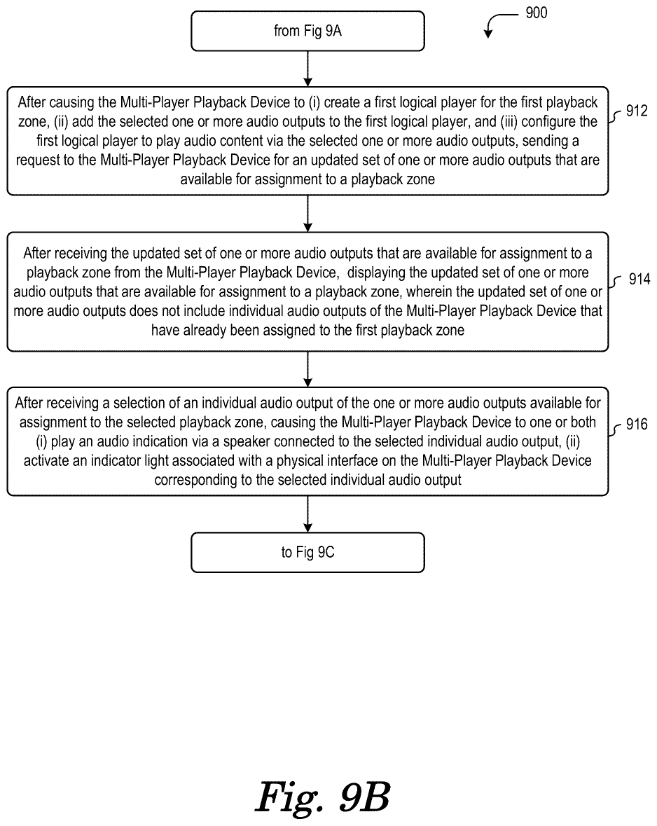

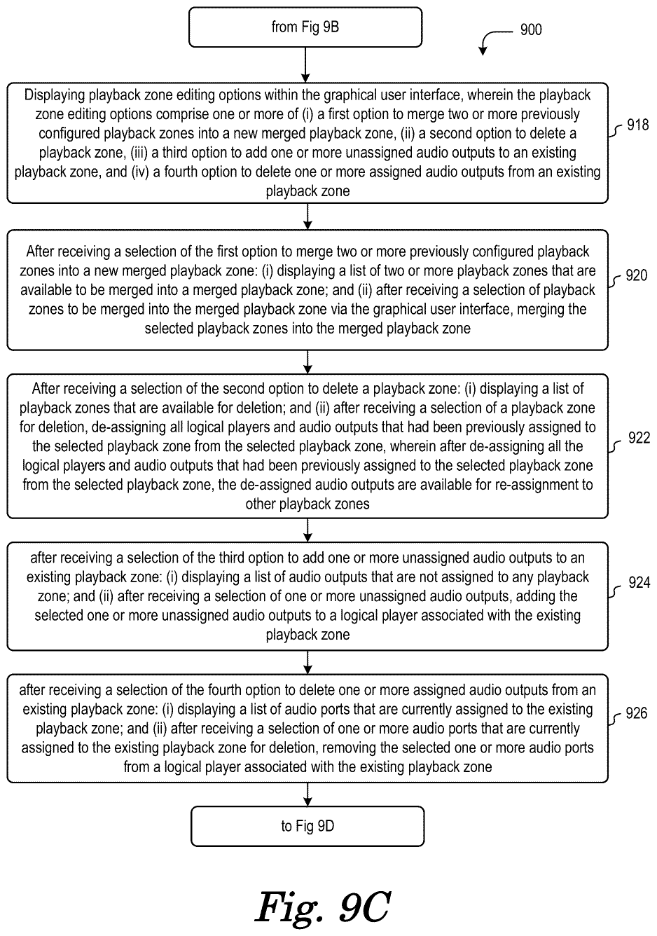

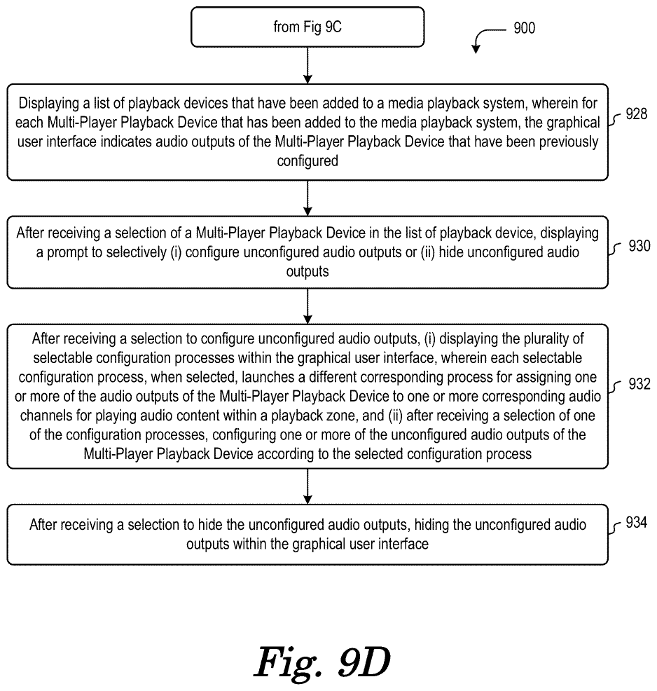

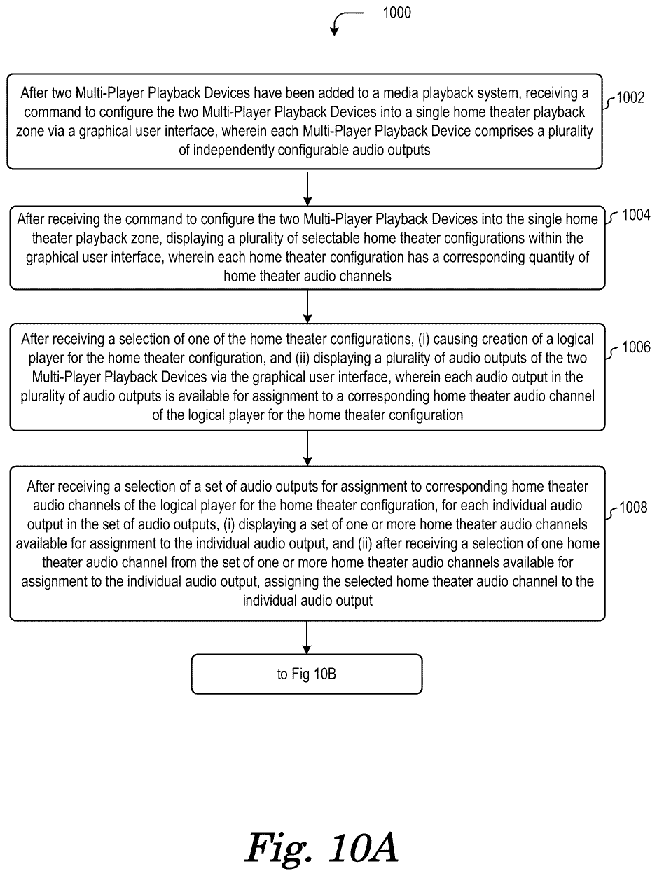

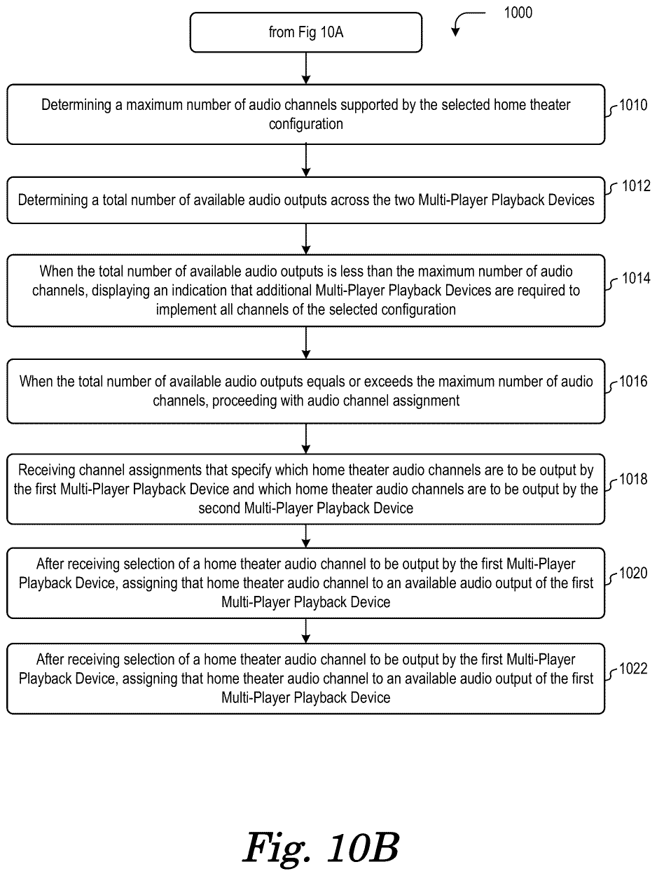

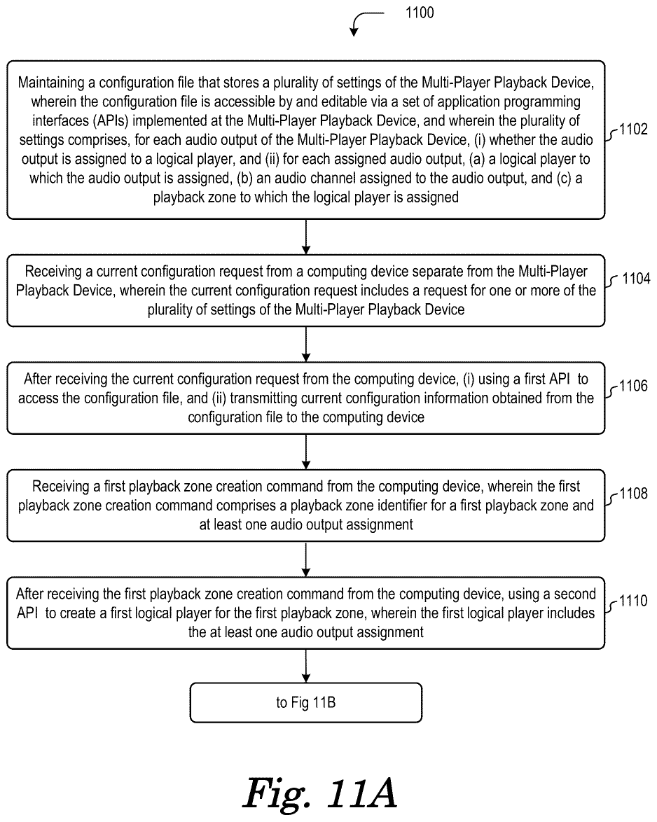

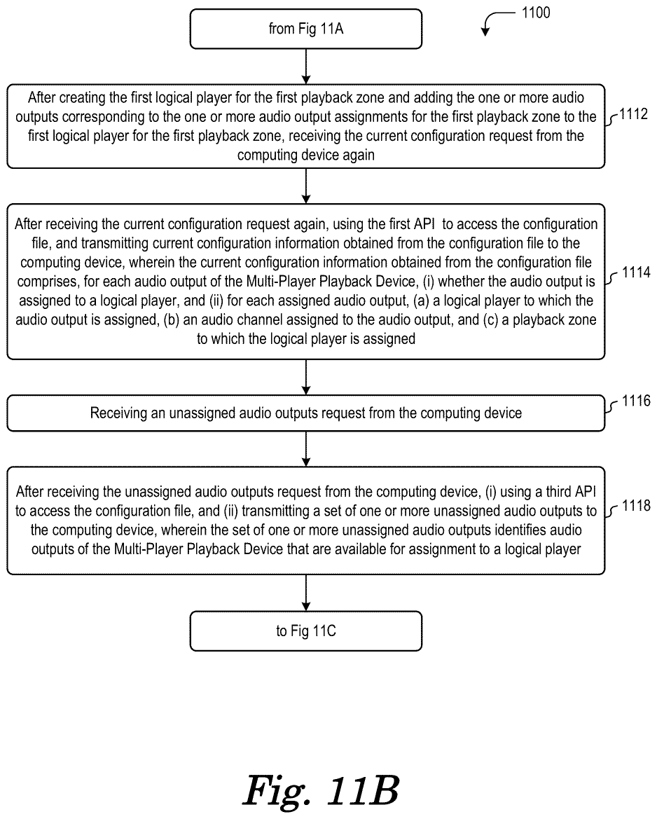

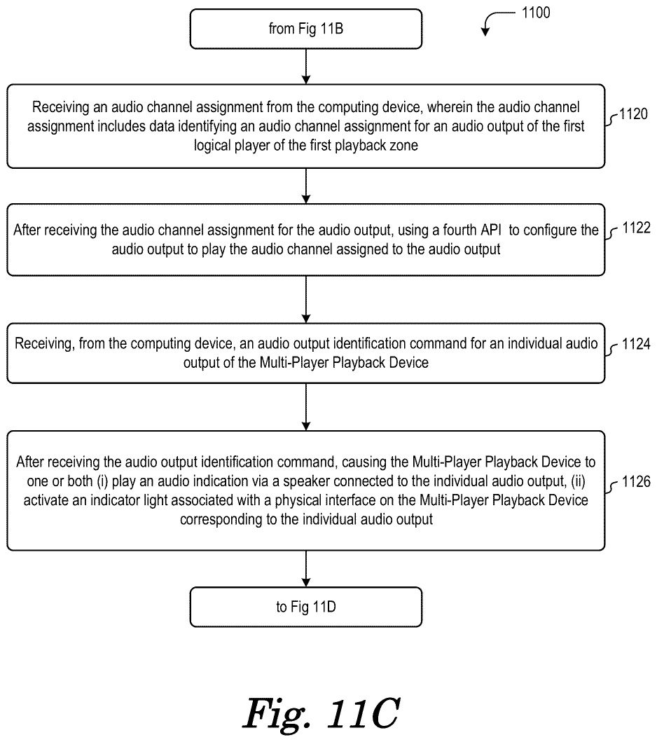

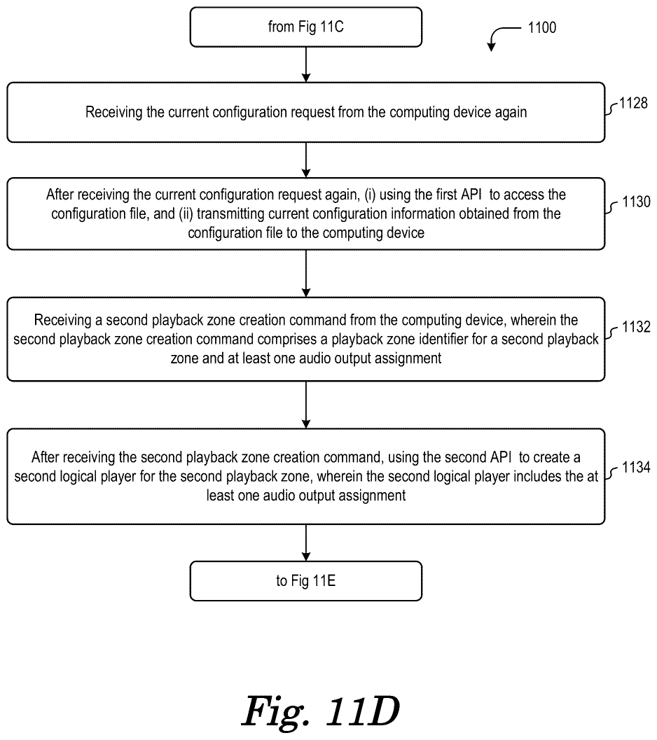

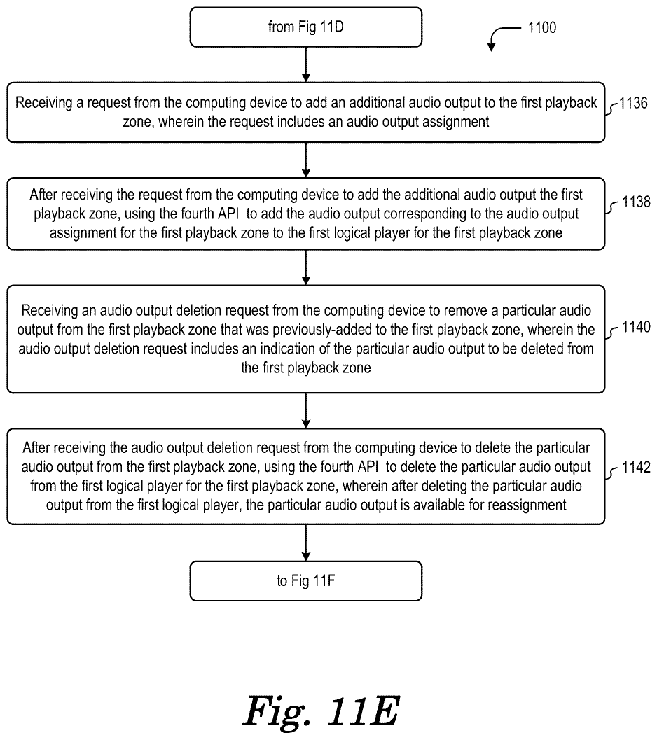

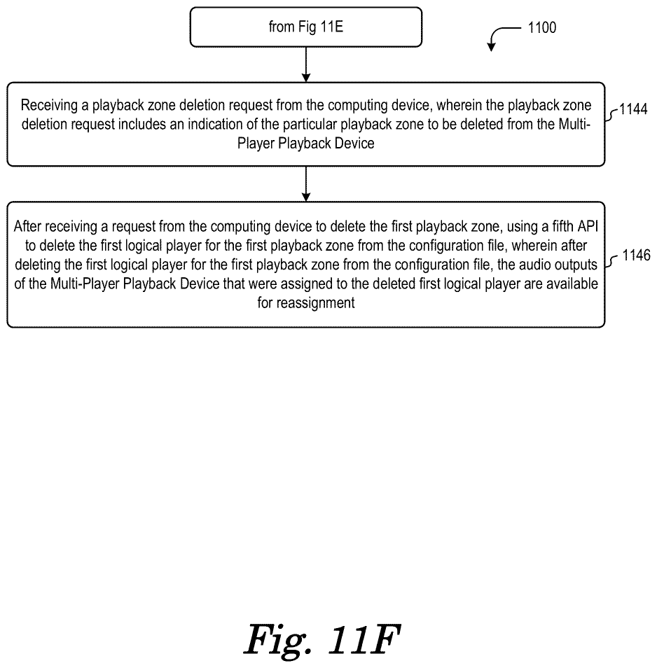

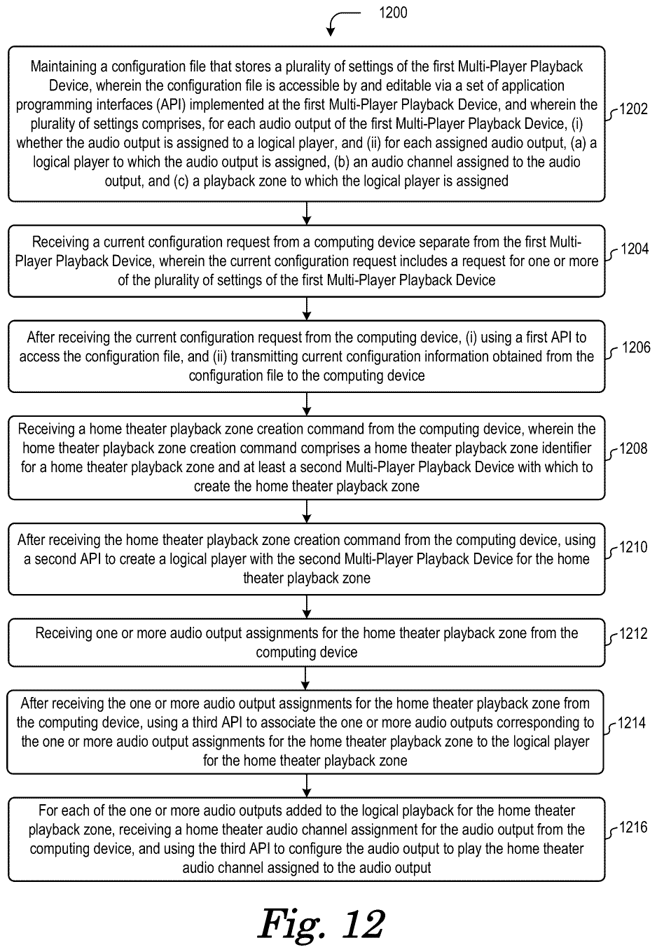

FIGS. 9A-9D and 10A-10B show flowcharts illustrating aspects of example methods 900 and 1000 for using Graphical User Interfaces (GUIs) to configure Multi-Player Playback Devices according to some embodiments, and FIGS. 11A-11F and 12 show flowcharts illustrating aspects of methods 1100 and 1200 for using application programming interfaces to configure Multi-Player Playback Devices according to some embodiments. Methods 900 and 1000 are implemented by a computing device executing controller software (e.g., and thus configured as a controller device), while methods 1100 and 1200 are implemented by a Multi-Player Playback Device. The methods work together to enable configuration of Multi-Player Playback Devices, where the controller device implements methods 900 and 1000 to provide the user interface and send configuration commands, while the Multi-Player Playback Device implements methods 1100 and 1200 to process those commands using its APIs to maintain the device configuration and communicate configuration state information and confirm configuration changes to the controller device.

In operation, any of the controller device embodiments disclosed herein may be configured to implement one or more (or all) of the features and functions of methods 900 and 1000, while any of the Multi-Player Playback Device embodiments disclosed herein may be configured to implement one or more (or all) of the features and functions of methods 1100 and 1200. The methods depicted in the figures are illustrated in different functional blocks for ease of explanation. In operation, the functions described in each block can be performed in any order and/or concurrently with each other, without limitation. Additionally, one or more (or all) of the additional/alternative embodiments can be performed in any combination, any order, and/or concurrently with each other, without limitation.

### A. Configuration Methods Performed by Controller Devices

FIGS. 9A-9D and 10A-10B show flowcharts illustrating aspects of example methods 900 and 1000 for using Graphical User Interfaces (GUIs) to configure Multi-Player Playback Devices according to some embodiments.

In operation, the methods 900 and 1000 shown in FIGS. 9A-9D and 10A-10B are implemented by a computing device configured as a controller device. The methods 900 and 1000 shown in FIGS. 9A-9D and 10A-10B may be implemented by any of the controller device embodiments disclosed herein, including but not limited to smartphones running media playback system controller application software (e.g., iPhone, Android phone), tablet computers (e.g., iPad), laptop/desktop computers like control device 530 shown in FIG. 5, dedicated controller devices specifically designed for the media playback system, integrated controllers within playback devices like control device 130c shown in FIG. 1G, network microphone devices with integrated control capabilities, IoT devices configured as controllers, or any other computing device that has a screen for displaying an GUI (or can control a screen for displaying a GUI), sufficient computing power to run the controller application, and one or more communication interfaces sufficient to exchange configuration and control information with a Multi-Player Playback Device. In operation, any of the controller device embodiments disclosed herein may be configured to implement one or more (or all) of the features and functions of the methods 900 and 1000 shown and described with reference to FIGS. 9A-9D and 10A-10B. Further, the methods 900 and 1000 depicted in FIGS. 9A-9D and 10A-10B are illustrated in different functional blocks for ease of explanation. In operation, the functions described in each block can be performed in any order and/or concurrently with each other, without limitation. Additionally, one or more (or all) of the additional/alternative embodiments can be performed in any combination, any order, and/or concurrently with each other, without limitation.

Method 900 begins at block 902 in FIG. 9A, which includes, after a Multi-Player Playback Device has been added to a media playback system, receiving a command to configure the Multi-Player Playback Device via a graphical user interface, where the Multi-Player Playback Device comprises a plurality of independently configurable audio outputs. For example, in some embodiments, the controller device may receive this configuration command similar to the process shown and described with reference to screen 800a-1 in FIG. 8A, where a user activates the “Setup” button to initiate configuration.

The configuration procedure could be initiated through other mechanisms as well. For instance, the setup process could be started automatically after receipt of a setup request from a Multi-Player Playback Device that has been added to the system. For example, after being added to a playback system, a Multi-Player Playback Device in some embodiments may send a message to a controller device requesting configuration, which may in turn cause the controller device to prompt a user to configure the Multi-Player Playback Device via the GUI screens.

Before launching the configuration interface, the controller device in some embodiments performs several validation steps, including: (i) verifying that the Multi-Player Playback Device is properly connected to the playback system network; (ii) confirming the controller device has proper authorization to configure the Multi-Player Playback Device; and (iii) checking that no other controller devices are currently configuring the same Multi-Player Playback Device, which helps prevent configuration conflicts that could arise from concurrent configuration attempts.

After receiving the command to configure the Multi-Player Playback Device at block 902, method 900 proceeds to block 904 in FIG. 9A, which includes displaying a plurality of selectable configuration processes within the graphical user interface, wherein each selectable configuration process, when selected, launches a different corresponding process for assigning one or more of the plurality of independently configurable audio outputs of the Multi-Player Playback Device to one or more corresponding audio channels for playing audio content within one or more playback zones of the media playback system.

For example, in some embodiments, displaying a plurality of selectable configuration processes within the graphical user interface at block 904 includes displaying configuration processes similar to the interface shown in screen 800a-2 of FIG. 8A, including displaying (i) a “Distributed audio” option which enables configuring the Multi-Player Playback Device to implement one or more logical players that can each play different audio streams in different zones, (ii) a “Home theater” option which enables configuration of the Multi-Player Playback Device to implement a single logical player configured to play a plurality of channels of home theater audio content, and (iii) a “Both” option which enables configuring some of the Multi-Player Playback Device's audio outputs for distributed audio while configuring other outputs for home theater.

In some embodiments, block 904 additionally includes displaying a “More information” button that, when selected, causes the controller device to display detailed explanations about each configuration option. The detailed explanations include information about: (i) maximum number of zones supported for distributed audio configurations, (ii) supported channel configurations for home theater setups, (iii) recommendations and/or limitations regarding combining distributed audio and home theater configurations on a single Multi-Player Playback Device, and (iv) recommendations for optimal speaker placement based on the selected configuration type.

In some embodiments, prior to allowing selection of a particular configuration process, the controller device in some embodiments may additionally validate that each of the potential configuration types is supported by: (i) confirming the Multi-Player Playback Device has sufficient available outputs to support the configuration type, (ii) verifying the Multi-Player Playback Device's processing capabilities can handle the expected audio processing load for the configuration type, and (iii) checking that any required inputs (e.g., HDMI inputs for home theater configurations) are available and properly configured for that configuration type. If the controller determines that the Multi-Player Playback Device should not implement (or perhaps cannot implement) a particular configuration for some reason, some embodiments may include disabling activation of the configuration process according that type of configuration.

After receiving a selection of one of the selectable configuration processes at block 904, method 900 advances to block 906 in FIG. 9A, which includes displaying a plurality of selectable playback zones in which one or more audio outputs of the Multi-Player Playback Device are to play one or more audio channels of audio content. For example, displaying the plurality of selectable playback zones at block 906 in some embodiments includes displaying a zone configuration interface that enables users to either select from predefined zone options or create a custom zone name. In some instances, when a custom zone name is entered, block 906 includes the controller device validating that the entered name does not conflict with existing zone names in the media playback system. For example, block 906 in some embodiments may include displaying playback zones similar to the zone selection interface shown in screen 800a-3 of FIG. 8A.

After receiving a selection of a first playback zone at block 906, method 900 proceeds to block 908 in FIG. 9A, which includes (i) obtaining configuration information comprising an identification of a set of one or more available audio outputs of the Multi-Player Playback Device, wherein each available audio output in the set of one or more available audio outputs is available for assignment to the first playback zone, and (ii) displaying the obtained set of one or more available audio outputs in the graphical user interface. In some embodiments, displaying the obtained set of available audio outputs at block 908 includes displaying a scrollable output selection interface that shows which independently configurable audio outputs are available for assignment to the selected zone, similar to the interface shown in screen 800b-1 of FIG. 8B

In some embodiments, before displaying the set of available audio outputs at block 908, the controller device may perform several validation steps to ensure that each audio output in the set of available outputs is actually available to be assigned, including: (i) sending a configuration request to the Multi-Player Playback Device to verify current audio output assignments, (ii) confirming that displayed audio outputs are not already assigned to other zones or logical players, and/or (iii) checking that the audio outputs are properly responding and available for configuration. In some examples, the controller application works with the Multi-Player Playback Device to help maintain and update this list of available audio outputs in real-time (or substantially real-time), removing audio outputs that become assigned to other zones or logical players during the configuration process to prevent duplicate assignments.

After receiving a selection of one or more available audio outputs available for assignment to the first playback zone at block 908, method 900 advances to block 910 in FIG. 9A, which includes causing the Multi-Player Playback Device to (i) implement a first logical player associated with the first playback zone, (ii) assign the selected one or more audio outputs to the first logical player, and (iii) configure the first logical player to play audio content via the selected one or more audio outputs. For example, the controller device in some embodiments implements this configuration (or causes the Multi-Player Playback Device to implement this configuration) similar to the manner shown and described with reference to screens 800b-1 and 800b-2 of FIG. 8B.

In some embodiments, the controller device works with the Multi-Player Playback Device to implement configuration steps atomically, meaning that all steps must complete successfully or none of the changes are applied. This helps maintain system stability by preventing partial configurations that could leave the system in an inconsistent state. If any errors occur during the configuration process at block 910, some embodiments include the controller device working with the Multi-Player Playback Device to implement rollback procedures to restore the previous valid configuration state. The rollback procedures may include: (i) removing any partial logical player implementations, (ii) clearing temporary output assignments, and (iii) refreshing the displayed available outputs list to reflect the restored configuration state.

In some embodiments, the atomic implementation of the configuration as well as the rollback procedures are primarily executed by the Multi-Player Playback Device. Nevertheless, the controller device in some such embodiments works with the Multi-Player Playback Device to implement the atomic implementation and rollback features at least in part by obtaining operational and configuration data obtained from the Multi-Player Playback Device in connection with the status of the atomic configuration implementation and/or the rollback procedure (when necessary) so that the status can be displayed via a GUI screen to a user. In some instances, in addition to displaying the status, the controller device may also present prompts that invite the user to cancel the configuration or perhaps try again (e.g., to see if the problem preventing the configuration completion may have resolved).

In some embodiments, causing the Multi-Player Playback Device to (i) implement a first logical player associated with the first playback zone, (ii) assign the selected one or more audio outputs to the first logical player, and (iii) configure the first logical player to play audio content via the selected one or more audio outputs at block 910 includes: (A) displaying a set of one or more audio channels available for assignment to each of the selected one or more audio outputs, and (B) for an individual audio output of the selected one or more audio outputs, after receiving a selection of one audio channel from the set of one or more audio channels available for assignment to one of the selected one or more audio outputs, sending one or more audio channel assignment commands to the Multi-Player Playback Device that cause the Multi-Player Playback Device to configure the individual audio output of the selected one or more audio outputs to play the selected audio channel.

In some embodiments where the configuration process selected from the plurality of selectable configuration processes at block 906 is a home theater configuration process, displaying the set of one or more audio channels available for assignment to each of the selected one or more audio outputs at block 910 includes displaying one or more of (i) a left front channel, (ii) a right front channel, (iii) a center front channel, (iv) a left surround channel, (v) a right surround channel, and (vi) a subwoofer channel. In some embodiments where the configuration process selected from the plurality of selectable configuration processes at block 906 is a distributed audio configuration process, displaying the set of one or more audio channels available for assignment to each of the selected one or more audio outputs at block 910 includes displaying one or more of a left channel and a right channel. However, this list of channels is not exhaustive and other channels may be included such as a left wide channel, a right wide channel, a left rear surround channel, a right rear surround channel, a left top front channel, right top front channel, right top middle channel, left top middle channel, among others. In some embodiments where the configuration process selected from the plurality of selectable configuration processes at block 906 is a distributed audio configuration process, each of the selected one or more audio outputs may be automatically or manually configured to play single channel (i.e., mono) audio so that all the selected outputs play the same “full” audio channel. In some embodiments, one or more of the audio channels can be a mono downmix channel where all the available channels are mixed into a single channel. In some embodiments where the configuration process selected from the plurality of selectable configuration processes at block 906 is a distributed audio configuration process, pairs of audio outputs can be automatically or manually configured to playback stereo content (e.g., if assigned to a zone that comprises only these two outputs). Other examples are possible.

Displaying the set of available audio channels in some embodiments of block 910 includes displaying a channel assignment interface that enables users to assign specific audio channels to individual outputs of the Multi-Player Playback Device. In some examples, the available channels displayed in some such embodiments of 910 are determined based on the configuration process selected at block 904. For instance, when implementing a home theater configuration, the GUI displays home theater channel options similar to those shown in screen 800c-2 of FIG. 8C.

Next, method 900 advances to block 912 in FIG. 9B, which includes after causing the Multi-Player Playback Device to (i) create a first logical player for the first playback zone, (ii) add the selected one or more audio outputs to the first logical player, and (iii) configure the first logical player to play audio content via the selected one or more audio outputs at block 910, sending a request to the Multi-Player Playback Device for an updated set of one or more audio outputs that are available for assignment to a playback zone.

Next, method 900 advances to block 914 in FIG. 9B, which includes after receiving the updated set of one or more audio outputs that are available for assignment to a playback zone from the Multi-Player Playback Device at block 912, displaying the updated set of one or more audio outputs that are available for assignment to a playback zone, wherein the updated set of one or more audio outputs does not include individual audio outputs of the Multi-Player Playback Device that have already been assigned to the first playback zone.

Next, method 900 advances to block 916 in FIG. 9B, which includes after receiving a selection of an individual audio output of the one or more audio outputs available for assignment to the selected playback zone (i.e., a selection from the updated set of one or more audio outputs that are available for assignment to a playback zone displayed at block 914), causing the Multi-Player Playback Device to one or both (i) play an audio indication via a speaker connected to the selected individual audio output, (ii) activate an indicator light associated with a physical interface on the Multi-Player Playback Device corresponding to the selected individual audio output. In some instances, some or all of the functions described with reference to block 916 can also or alternatively be performed after or concurrently with the functions in block 910 in FIG. 9A. For example, the Multi-Player Playback Device can play an audio indication and/or activate an indicator light after/when receiving a selection of one or more available outputs in block 910.

In some embodiments, the controller device implements coordinated output identification by configuring specific parameters that control how the Multi-Player Playback Device identifies selected outputs. These parameters can include: (i) timing parameters that specify the duration of identification signals, (ii) audio parameters that define the type and volume of identification sounds, and (iii) visual parameters that coordinate LED indicator patterns with audio playback to provide clear confirmation of which output is being identified.

To prevent (or at least avoid) confusion when identifying multiple outputs connected to speakers that may be physically close to each other, some embodiments include the controller device implementing sequential output testing. For example, when multiple outputs are selected for identification, the controller device may cause the Multi-Player Playback Device to play identification signals one at a time with appropriate spacing between signals. This sequential approach helps users clearly differentiate between outputs being identified, particularly in scenarios where speakers connected to different outputs are mounted near each other.

In some embodiments, causing the Multi-Player Playback Device to play the audio indication via the speaker connected to the selected individual audio output includes causing the Multi-Player Playback Device to play the audio indication for a duration of time sufficient for a user to confirm which speaker is connected to the selected individual audio output. Similarly, causing the Multi-Player Playback Device to activate the indicator light associated with the physical interface includes causing the indicator light to flash on and off for a duration of time sufficient for a user to confirm which physical interface corresponds to the selected individual audio output, as shown and described with reference to FIG. 8F.

Before initiating output identification, the controller device in some embodiments validates the identification request by: (i) confirming the specified output is properly connected and responding, (ii) verifying the output is not currently being used for active audio playback that would be interrupted by the identification signal, and (iii) checking that no other identification processes are currently running that could create confusion. Additionally, some embodiments include the controller device providing options to stop the identification process for a particular output and properly restore that output to its previous state.

Accordingly, in some embodiments, causing the Multi-Player Playback Device play the audio indication via the speaker connected to the selected individual audio output at block 916 includes causing the Multi-Player Playback Device to play the audio indication for a duration of time sufficient for a user to confirm which speaker is connected to the selected individual audio output. And in some embodiments, causing the Multi-Player Playback Device to activate the indicator light associated with the physical interface on the Multi-Player Playback Device corresponding to the selected individual audio output at block 916 includes causing the indicator light to flash on and off for a duration of time sufficient for a user to confirm which physical interface corresponds to the selected individual audio output.

Some embodiments of method 900 additionally include blocks 918 through 926 in FIG. 9C, which include playback zone editing procedures.

For embodiments of method 900 that include the zone editing procedures of blocks 918 through 926 in FIG. 9C, block 918 includes displaying playback zone editing options within the graphical user interface, wherein the playback zone editing options comprise one or more of (i) a first option to merge two or more previously configured playback zones into a new merged playback zone, (ii) a second option to delete a playback zone, (iii) a third option to add one or more unassigned audio outputs to an existing playback zone, and (iv) a fourth option to delete/remove one or more assigned audio outputs from an existing playback zone. The playback zone editing options can include any other suitable option such as an option to break down a playback zone into two or more zones, an option to reassign outputs from one zone to another, etc.

After detecting a user selection of one of the options, method 900 proceeds according to the selected option.

For example, at block 920 in FIG. 9C, after receiving a selection of the first option to merge two or more previously configured playback zones into a new merged playback zone at block 918, method 900 includes: (i) displaying a list of two or more playback zones that are available to be merged into a merged playback zone; and (ii) after receiving a selection of playback zones to be merged into the merged playback zone via the graphical user interface, merging the selected playback zones into the merged playback zone. In some instances, in order to merge two or more zones, the zones are first separated or removed so that the outputs become available and can then be assigned to the merged zone. Merging the zones can include implementing a new logical player corresponding to the merged zone. Merging the zones can include assigning all outputs previously assigned to each of the individual zones to a new merged zone and/or to the new logical player corresponding to the merged zone.

Similarly, at block 922 in FIG. 9C, after receiving a selection of the second option to delete a playback zone at block 918, method 900 includes: (i) displaying a list of playback zones that are available for deletion; and (ii) after receiving a selection of a playback zone for deletion, de-assigning all logical players and audio outputs that had been previously assigned to the selected playback zone from the selected playback zone, wherein after de-assigning all the logical players and audio outputs that had been previously assigned to the selected playback zone from the selected playback zone, the de-assigned audio outputs are available for re-assignment to other playback zones.

Likewise, at block 924 in FIG. 9C, after receiving a selection of the third option to add one or more unassigned audio outputs to an existing playback zone at block 918, method 900 includes: (i) displaying a list of audio outputs that are not assigned to any playback zone; and (ii) after receiving a selection of one or more unassigned audio outputs, adding the selected one or more unassigned audio outputs to a logical player associated with the existing playback zone.

Finally, at block 926 in FIG. 9C, after receiving a selection of the fourth option to remove one or more assigned audio outputs from an existing playback zone at block 918, method 900 includes: (i) displaying a list of audio ports that are currently assigned to the existing playback zone; and (ii) after receiving a selection of one or more audio ports that are currently assigned to the existing playback zone for deletion, removing the selected one or more audio ports from a logical player associated with the existing playback zone.

Some embodiments of method 900 additionally include blocks 928 through 934 in FIG. 9D, which include procedures for handling unconfigured audio outputs of a Multi-Player Playback Device, including configuring the unconfigured audio outputs or hiding the unconfigured audio outputs.

For embodiments of method 900 that include the unconfigured port handling procedures of blocks 928 through 934 in FIG. 9D, block 928 includes displaying a list of playback devices that have been added to a media playback system, wherein for each Multi-Player Playback Device that has been added to the media playback system, the graphical user interface indicates audio outputs of the Multi-Player Playback Device that have been previously configured.

After receiving a selection of a Multi-Player Playback Device in the list of playback devices displayed at block 928, method 900 advances to block 930, which includes displaying a prompt to selectively (i) configure unconfigured audio outputs or (ii) hide unconfigured audio outputs.

After detecting a user selection of one of the options presented at block 930, method 900 proceeds according to the selected option.

For example, at block 932 in FIG. 9D, after receiving a selection to configure unconfigured audio outputs at block 930, method 900 includes: (i) displaying the plurality of selectable configuration processes within the graphical user interface (e.g., similar to or the same as block 904 of FIG. 9A), wherein each selectable configuration process, when selected, launches a different corresponding process for assigning one or more of the audio outputs of the Multi-Player Playback Device to one or more corresponding audio channels for playing audio content within a playback zone, and (ii) after receiving a selection of one of the configuration processes (e.g., similar to or the same as block 906 in FIG. 9A), configuring one or more of the unconfigured audio outputs of the Multi-Player Playback Device according to the selected configuration process (e.g., similar to the processes described with reference to blocks 906-926).

Similarly, at block 934 in FIG. 9D, after receiving a selection to hide the unconfigured audio outputs at block 930, method 900 includes hiding the unconfigured audio outputs within the graphical user interface.

Method 1000 begins at block 1002 in FIG. 10A, which includes, after two or more Multi-Player Playback Devices have been added to a media playback system, receiving a command to configure the two or more Multi-Player Playback Devices into a single playback zone (e.g., a single home theater playback zone) via a graphical user interface, wherein each Multi-Player Playback Device comprises a plurality of independently configurable audio outputs. Configuring the two or more Multi-Player Playback Devices into a single playback zone can include configuring one or more (but not necessarily all) outputs from each of the Multi-Player Playback Devices into a same playback zone so that the same playback zone comprises at least one output from each of the Multi-Player Playback Devices.

Next, method 1000 advances to block 1004 in FIG. 10A, which includes after receiving the command to configure the two Multi-Player Playback Devices into the single home theater playback zone, displaying a plurality of selectable home theater configurations within the graphical user interface, wherein each home theater configuration has a corresponding quantity of home theater audio channels.

In some embodiments, displaying the plurality of selectable home theater configurations at block 1004 includes displaying configuration options similar to those shown in screen 800k-1 of FIG. 8K, including options for different surround sound configurations such as 5.x.2 (5 ear-level+2 height speakers), 7.x.0 (7 ear-level speakers), 9.x.4 (9 ear-level+4 height speakers), 9.x.6 (9 ear-level+6 height speakers), and possibly other configurations.

Next, method 1000 advances to block 1006 in FIG. 10A, which includes after receiving a selection of one of the home theater configurations that was displayed in block 1004, (i) causing creation of a logical player for the home theater configuration, and (ii) displaying a plurality of audio outputs of the two Multi-Player Playback Devices via the graphical user interface, wherein each audio output in the plurality of audio outputs is available for assignment to a corresponding home theater audio channel of the logical player for the home theater configuration.

In some embodiments, displaying a plurality of audio outputs of the two Multi-Player Playback Devices via the graphical user interface at block 1004 includes determining whether each audio output of the two Multi-Player Playback Devices is available for assignment to the home theater configuration, and displaying only audio outputs that are determined to be available for assignment.

Before displaying available audio outputs at block 1006, the controller device in some embodiments may perform several validation steps to verify the availability of an audio output, including: (i) sending configuration requests to both Multi-Player Playback Devices to verify current audio output assignments, (ii) confirming that displayed audio outputs are not already assigned to other zones or logical players, and (iii) checking that the audio outputs are properly responding and available for configuration.

In operation, the computing device is configured to receive one or more selections of one or more audio outputs from the plurality of audio outputs of the two Multi-Player Playback Devices displayed at block 1006.

Next, method 1000 advances to block 1008 in FIG. 10A, which includes after receiving a selection of a set of audio outputs for assignment to corresponding home theater audio channels of the logical player for the home theater configuration, for each individual audio output in the set of audio outputs, (i) displaying a set of one or more home theater audio channels available for assignment to the individual audio output, and (ii) after receiving a selection of one home theater audio channel from the set of one or more home theater audio channels available for assignment to the individual audio output, assigning the selected home theater audio channel to the individual audio output.

In some embodiments, when implementing the configuration at blocks 1006 and 1008, and similar to the procedures described with reference to method 900, the controller device works with both Multi-Player Playback Devices to implement the configuration changes atomically across both devices. This helps maintain system stability by ensuring that either all aspects of the home theater configuration are properly implemented across both devices or none of the changes are applied. If errors occur during configuration, some embodiments include implementing rollback procedures that restore both Multi-Player Playback Devices to their previous stable configurations.

In some embodiments of method 1000, after causing creation of the logical player for the home theater configuration at block 1006, method includes blocks 1010 through 1022 in FIG. 10B.

Block 1010 in FIG. 10B includes determining a maximum number of audio channels supported by the selected home theater configuration.

Block 1012 in FIG. 10B includes determining a total number of available audio outputs across the two Multi-Player Playback Devices;

At block 1014 in FIG. 10B, when the total number of available audio outputs determined at block 1012 is less than the maximum number of audio channels determined at block 1010, block 1014 includes displaying an indication that additional Multi-Player Playback Devices are required to implement all channels of the selected configuration.

At block 1016 in FIG. 10B, when the total number of available audio outputs determined at block 1012 equals or exceeds the maximum number of audio channels determined at block 1010, block 1016 includes proceeding with audio channel assignment.

When audio channel assignment proceeds at block 1016, method 1000 advances to block 1018 which includes receiving channel assignments that specify which home theater audio channels are to be output by the first Multi-Player Playback Device and which home theater audio channels are to be output by the second Multi-Player Playback Device.

Next, at block 1020, after receiving selection of a home theater audio channel to be output by the first Multi-Player Playback Device at block 1018, block 1020 includes assigning that home theater audio channel to an available audio output of the first Multi-Player Playback Device.

Finally, at block 1022, after receiving selection of a home theater audio channel to be output by the second Multi-Player Playback Device at block 1018, block 1022 includes assigning that home theater audio channel to an available audio output of the second Multi-Player Playback Device.

In some embodiments, after completing the channel assignments at blocks 1020 and 1022, the controller device validates the complete configuration by: (i) confirming all required channels for the selected home theater configuration have been properly assigned, and (ii) checking that both Multi-Player Playback Devices can properly synchronize audio playback with each other to maintain proper timing between all assigned channels between the Multi-Player Playback Devices.

For example, the controller device may: (i) cause the Multi-Player Playback Devices to send test signals to each other and measure the response times to verify synchronization capabilities, (ii) confirm that device-to-device communication latency between the Multi-Player Playback Devices meets synchronization requirements for proper home theater playback, and (iii) validate that both Multi-Player Playback Devices can maintain proper synchronization when processing HDMI-CEC signals. This validation can be important for synchronized playback because even small timing differences between speakers can create echo effects or audio artifacts that degrade the listening experience. Even though the examples provided with reference to the methods in FIGS. 10A and 10B describe a home theater zone configuration, the methods can be more broadly applicable to any type of zone configuration (e.g., a distributed audio zone).

### B. Configuration Methods Performed by Multi-player Playback Device

FIGS. 11A-11F show a flowchart illustrating aspects of an example method 1100 for using application programming interfaces to configure a Multi-Player Playback Device according to some embodiments, and FIG. 12 shows a flowchart illustrating aspects of a method 1200 for configuring home theater playback zones using application programming interfaces according to some embodiments. In operation, the methods 1100 and 1200 shown in FIGS. 11A-11F and 12 are implemented by a Multi-Player Playback Device. The methods 1100 and 1200 shown in FIGS. 11A-11F and 12 (or at least part of them) can additionally or alternatively be implemented by any computing system/device associated with the Multi-Player Playback Device, such as a cloud computing system. The methods 1100 and 1200 shown in FIGS. 11A-11F and 12 may be implemented by any of the Multi-Player Playback Device embodiments disclosed herein, including but not limited to Multi-Player Playback Device 700 shown and described with reference to FIG. 7, the Multi-Player Playback Device 850 described in FIG. 8F. In operation, any of the Multi-Player Playback Device embodiments disclosed herein may be configured to implement one or more (or all) of the features and functions of the methods 1100 and 1200 shown and described with reference to FIGS. 11A-11F and 12. Further, the methods 1100 and 1200 depicted in FIGS. 11A-11F and 12 are illustrated in different functional blocks for ease of explanation. In operation, the functions described in each block can be performed in any order and/or concurrently with each other, without limitation. Additionally, one or more (or all) of the additional/alternative embodiments can be performed in any combination, any order, and/or concurrently with each other, without limitation. Examples of program code suitable for implementation in connection with implementing the application programming interface (API) functions described herein are shown in the Appendix to the specification.

Method 1100 begins at block 1102 in FIG. 11A, which includes maintaining one or more configuration files that store a plurality of settings of the Multi-Player Playback Device. In some embodiments, the configuration files are accessible by and editable via a set of one or more application programming interfaces (APIs) implemented at the Multi-Player Playback Device. The configuration files may store settings that comprise, for each audio output of the Multi-Player Playback Device, one or more of: (i) whether the audio output is assigned to a logical player, and (ii) for each assigned audio output, (ii-a) a logical player to which the audio output is assigned, (ii-b) an audio channel assigned to the audio output, and (ii-c) a playback zone to which the logical player is assigned. In some embodiments, the configuration information in the configuration files includes more or less settings than the settings described herein. In some embodiments, the configuration information in the configuration files may not explicitly include audio channel assignment information. For example, for a distributed audio zone, all the outputs in the zone may be set to play mono. In this case, storing information about the audio channels assigned to the audio outputs for that zone may not be necessary.

In some embodiments, the configuration file implements a structured data format that includes one or more of: (i) unique identifiers for each logical player; (ii) channel mapping information for audio outputs; (iii) zone assignments and relationships; (iv) status indicators for each configured output; (v) hardware capability parameters; and (vi) resource allocation tracking. In some embodiments, the configuration file is additionally arranged to maintain a detailed version history through: (i) timestamped configuration snapshots that record: (i-a) the complete device state at each configuration change, (i-b) identifiers for both the source device and user that initiated the change, and (i-c) mapping of configuration dependencies between linked zones; and (ii) rollback mechanisms that: (ii-a) store previous valid configurations as recovery points, (ii-b) track the relationships between sequential configuration changes to enable precise state restoration, and (ii-c) maintain configuration consistency during recovery operations.

In embodiments that implement version history tracking in the configuration file, the version history tracking enables a user (e.g., via the controller application running on the computer device) to access the configuration file at the Multi-Player Playback Device and: (i) audit configuration changes to identify when and how specific settings were modified; (ii) detect and resolve conflicts that may arise from concurrent configuration attempts; and (iii) restore previous working configurations if errors occur during configuration changes. In operation, version history tracking can help prevent configuration errors while enabling recovery from interrupted configuration operations.

Next, method 1100 advances to block 1104 in FIG. 11A, which includes receiving a current configuration request from a computing device separate from the Multi-Player Playback Device. Before processing the configuration request, the Multi-Player Playback Device in some examples validates access permissions through: (i) administrative-level access verification to confirm the computing device has proper authorization to access configuration settings; and (ii) system configuration administration scope verification to ensure the computing device has appropriate permissions for the specific system's configuration. These permission validations help maintain system security by preventing unauthorized access to or modification of device configurations.

After validating permissions, the Multi-Player Playback Device proceeds to process the configuration request to obtain the requested configuration settings. In some embodiments, the current configuration request includes a request for one or more specific settings of the Multi-Player Playback Device, such as zone assignments, output configurations, or channel mappings. The Multi-Player Playback Device validates the request parameters and format to ensure the request can be properly processed.

For example, after receiving the current configuration request at block 1104, method 1100 advances to block 1106 in FIG. 11A, which includes using one of the APIs (e.g., a first API) to access the configuration file and transmit current configuration information to the computing device. The first API may return a structured response payload from the configuration file (maintained at block 1102) that includes one or more of: (i) unique identifiers for each logical player; (ii) channel mapping information; (iii) zone assignments; and (iv) status indicators for each configured output. The structured response may include additional configuration details, too. An example of program code suitable for use in connection with the first API is shown in the Appendix to the specification as “Get AudioPlayers.”

In some embodiments, use of the first API provides access to the configuration file and implements standardized response formats comprising one or more of: (i) success/failure indicators with detailed status codes; (ii) error codes with comprehensive descriptions; (iii) warning messages for partial success conditions; and (iv) configuration version tracking for change management. In operation, using this first API enables consistent error handling and state management across the system.

In some embodiments, when implementing block 1106, the first API may additionally or alternatively implement partial success handling through: (i) response formatting that includes: (i-a) completed operations, (i-b) pending operations, and (i-c) required user actions; and (ii) state management procedures for partial configurations.

After transmitting the current configuration information to the computing device at block 1106, method 1100 proceeds to block 1108 in FIG. 11A, which includes receiving a first playback zone creation command from the computing device. The first playback zone creation command comprises a playback zone identifier for a first playback zone and at least one audio output assignment.

After receiving the first playback zone creation command at block 1108, method 1100 advances to block 1110 in FIG. 11A, which includes using one of the APIs (e.g., a second API) to create a first logical player for the first playback zone. The Multi-Player Playback Device implements zone creation through several steps: (i) configuration procedures comprising: (i-a) validating that requested outputs are available and compatible with the zone configuration, (i-b) initializing a new logical player with appropriate settings for audio processing and playback synchronization; and (ii) state management including updating the configuration file to reflect the new zone's logical player, output assignments, and channel mappings. This structured approach helps ensure zones are created in a way that maintains system stability while enabling proper audio playback functionality. An example of program code suitable for use in connection with the second API is shown in the Appendix to the specification as “Create AudioPlayer.”

In some examples, when implementing block 1108, the Multi-Player Playback Device validates zone creation commands via several verification steps. First, the Multi-Player Playback Device performs configuration validation by: (i) examining product policies to verify the requested configuration complies with system limitations; (ii) detecting potential conflicts by checking for overlapping resource assignments; and (iii) verifying hardware capabilities by testing output ports and system resources. Second, for home theater zones, the Multi-Player Playback Device confirms that the zone creation information satisfies additional requirements needed for proper home theater operation, such as: (i) confirming that a single logical player at the Multi-Player Playback Device is assigned to implement the home theater zone; (ii) validating that one or more HDMI inputs are available and can be properly assigned the home theater zone; (iii) verifying which surround sound format that the logical player at the Multi-Player Playback Device and any zone players assigned to the home theater zone will support; and (iv) confirming device-to-device communication latency meets synchronization requirements.

In some embodiments, when examining product policies to verify the requested configuration complies with system limitations, the Multi-Player Playback Device performs one or more of: (i) verifying that the total number of configured zones does not exceed system limits, (ii) confirming that the expected computing load for processing the audio streams (and the channels contained in those streams) in the requested configuration remains within supported operational thresholds, and (iii) validating zone type combinations by confirming that: (iii-a) the requested zone types (e.g., stereo, home theater, distributed audio) are supported by the device's hardware capabilities; (iii-b) the combination of different zone types does not exceed the device's processing resources; and (iii-c) any dependencies between different zone types are properly coordinated, such as confirming that home theater inputs (e.g., HDMI inputs where applicable) are configured correctly and processing resources are allocated for surround sound appropriately for satisfactory audio performance. Additionally, when verifying hardware capabilities by testing output ports and system resources, the Multi-Player Playback Device verifies that the audio format in connection with zone creation request can be supported in the requested zone configuration. This validation can be important in scenarios where users may be creating complex multi-room configurations because it can help prevent system instability that can result from exceeding the Multi-Player Playback Device's processing and memory capabilities. Further, because each audio output is independently configurable, configuration changes to outputs assigned to one zone do not affect outputs assigned to other zones, enabling continuous playback through unaffected outputs during zone configuration changes.

During configuration conflict detection, the Multi-Player Playback Device performs detailed validation steps including: (i) examining each output assignment by checking whether outputs are currently allocated, verifying no single output is assigned to multiple zones, and confirming zone relationships remain properly defined; and (ii) implementing system consistency checks that track how resources are allocated across all configured zones to prevent resource conflicts.

The hardware capability verification includes real-time monitoring of: (i) output connection states to confirm speakers remain properly connected; (ii) signal integrity to ensure audio quality; and (iii) thermal conditions to prevent overheating. This verification is especially beneficial during initial zone setup because it helps users identify and correct connection issues before they affect playback quality. Additionally, the thermal monitoring could help protect system components by preventing configurations that could lead to excessive heat generation.

For home theater zones specifically, the hardware capability verification includes HDMI input validation that is crucial for maintaining proper audio/video synchronization. The validation process verifies HDMI-CEC control capabilities, which enables coordinated operation between the Multi-Player Playback Device and video components like TVs and media players. This coordination is particularly important for home theater applications because it prevents audio/video sync issues that could degrade the viewing experience.

The surround sound bonding validation helps ensure optimal home theater performance by: (i) verifying the device supports advanced surround configurations like Dolby Atmos; (ii) confirming sufficient outputs are available for all surround channels; and (iii) validating proper channel mapping options exist. This validation is essential for immersive audio experiences because it ensures each speaker properly reproduces its intended audio content while maintaining proper spatial positioning of sound effects.

The latency validation for multi-device home theater setups measures transmission delays between devices and verifies they remain within acceptable thresholds. This validation is critical for synchronized playback because even small timing differences between speakers can create echo effects or audio artifacts that degrade the listening experience. The specialized audio processing helps optimize movie and TV sound quality by enabling theater-specific DSP modes while coordinating HDMI-CEC signals to maintain proper audio/video sync.

The partial success handling provides detailed feedback about validation results and specific guidance for resolving any issues. This handling is valuable during complex zone configurations because it helps users quickly identify and correct problems without having to troubleshoot the entire system configuration.

After creating the first logical player at block 1110, method 1100 proceeds to block 1112 in FIG. 11B, which includes receiving the current configuration request from the computing device again.

After receiving the current configuration request again at block 1112, method 1100 advances to block 1114 in FIG. 11B, which includes using one of the APIs (e.g., the first API) to access the configuration file and transmit current configuration information to the computing device. The configuration information comprises, for each audio output of the Multi-Player Playback Device: (i) whether the audio output is assigned to a logical player; and (ii) for each assigned audio output: (ii-a) a logical player to which the audio output is assigned, (ii-b) an audio channel assigned to the audio output, and (ii-c) a playback zone to which the logical player is assigned.

In some embodiments, using the first API to access the configuration file and provide current configuration info to the computing device includes verifying the configuration information through: (i) state checking procedures, including configuration completeness verification and consistency validation; and (ii) response generation including generating updated configuration information.

In certain example configurations, performing the configuration completeness verification in connection with the first API includes: (i) checking that all required configuration parameters are present, including that the configuration includes proper zone identifiers, output assignments, and channel mappings; (ii) validating that all referenced components exist, including confirming that the physical outputs, logical players, and assigned zones are configured; and (iii) confirming that all required relationships are properly defined between the hardware device(s), logical player(s), audio output(s), and channel assignment(s).

In certain example configurations, performing consistency validation in connection with the first API includes: (i) cross-reference checking, including verifying that the output assignments match logical player configurations, confirming that the channel mappings align with zone types, and validating that the zone relationships are consistent across the playback system; and (ii) resource allocation verification, including confirming amplifiers driving the output ports assigned to audio channels are appropriately configured and that the Multi-Player Playback Device has computing resources sufficient to process the audio channels assigned to its output ports.

In some embodiments, using the first API at block 1112 may additionally include implementing error handling for configuration requests through: (i) validation procedures, including configuration state verification; and (ii) error response generation including detailed error descriptions and recovery suggestions. In some examples, the configuration state verification includes checking that all configured outputs are responding properly, verifying logical player operational states, and confirming that zone configurations are valid. For error response generation, some embodiments include generating detailed error descriptions that specify the exact nature of configuration issues, the affected components or relationships, and/or the validation rules that were violated. Some embodiments may additionally include providing recovery suggestions in the responses provided to the computing device, such as specific corrective actions and/or configuration alternatives that would satisfy system requirements.

In some embodiments, method 1100 additionally includes block 1116 in FIG. 11B, which includes receiving an unassigned audio outputs request from the computing device.

After receiving the unassigned audio outputs request at block 1116, method 1100 advances to block 1118 in FIG. 11B, which includes using one of the APIs (e.g., a third API) to access the configuration file and transmit a set of one or more unassigned audio outputs to the computing device. An example of program code suitable for use in connection with the third API is shown in the Appendix to the specification as “Get Available (unused) Outputs.”

In some embodiments, using the third API includes accessing the configuration file to obtain detailed output configurations including: (i) physical port mappings; (ii) amplifier channel assignments; (iii) audio processing capabilities; and (iv) current operational status of physical output ports, amplifiers, and audio processors of the Multi-Player Playback Device.

In certain example configurations, when implementing block 1118, using the third API to obtain current configuration settings may additionally include validating details of the configuration settings before returning those settings to the computing device, including verifying the current operational state of each audio output, such as checking active playback sessions and determining whether there are any pending configuration changes; and (ii) error handling procedures for concurrent operations.

In some embodiments, method 1100 additionally includes block 1120 in FIG. 11C. Block 1120 includes the Multi-Player Playback Device receiving an audio channel assignment from the computing device. The audio channel assignment includes data identifying an audio channel assignment for an audio output of the first logical player of the first playback zone.

In some embodiments, when receiving the audio channel assignment at block 1120, the Multi-Player Playback Device first validates that the received channel assignment complies with its structured channel enumeration system. The enumeration system defines supported channel types including: (i) standard stereo channels comprising left and right channel assignments for basic two-channel audio configurations; (ii) home theater channels comprising center channel, low frequency effects (LFE), and surround sound channels; and (iii) extended surround channels for advanced home theater configurations including rear surround, wide, and height channels.

After validating the channel type associated with the received channel assignment, the Multi-Player Playback Device performs hardware validation by: (i) verifying the output port supports the assigned channel type's processing requirements (e.g., that a subwoofer channel is assigned to an output port capable of outputting a subwoofer signal); (ii) confirming the port's amplifier can properly drive the assigned channel type; and (iii) checking that the port's digital signal processing capabilities support the channel format.

The Multi-Player Playback Device then validates configuration compatibility by: (i) verifying the channel assignment maintains proper channel relationship(s) within the zone; (ii) confirming no conflicts exist with other channel assignments (e.g., avoiding attempts to assign multiple audio channels to the same output port); and (iii) validating that the zone type supports the requested channel configuration.

After receiving the audio channel assignment from the computing device at block 1120, method 1100 advances to block 1122 in FIG. 11C, which includes using one of the APIs (e.g., a fourth API) to configure the audio output to play the audio channel assigned to the audio output. In some embodiments, the fourth API implements configuration changes through a two-phase process: (i) validation procedures that verify the output hardware can properly support the assigned channel type and coordinate the timing of configuration updates to prevent audio interruption during channel assignment changes; and (ii) state management procedures that maintain continuous audio playback by preserving the current playback state while applying the new channel configuration, coordinating any needed amplifier or DSP resource changes, and ensuring proper synchronization between affected outputs. An example of program code suitable for use in connection with the fourth API is shown in the Appendix to the specification as “Update AudioPlayer.”

In some examples, the fourth API's implementation of configuration changes on a per-output basis enables granular control over individual audio outputs of the Multi-Player Playback Device. This granular control allows the Multi-Player Playback Device to maintain stable playback in some zones while reconfiguring outputs assigned to other zones. For example, when changing channel assignments for outputs assigned to a home theater zone, outputs assigned to distributed audio zones can continue playing their assigned audio streams without interruption. The API validates each configuration change independently to ensure the change can be implemented without affecting playback through other configured audio outputs of the Multi-Player Playback Device, thereby enabling and maintaining independent operation of each audio output of the Multi-Player Playback Device.

In some embodiments, method 1100 additionally includes block 1124 in FIG. 11C, which includes receiving an audio output identification command from the computing device for an individual audio output.

After receiving the audio output identification command at block 1124, method 1100 advances to block 1126 in FIG. 11C, which includes causing the Multi-Player Playback Device to one or both (i) play an audio indication via a speaker connected to the individual audio output or (ii) activate an indicator light associated with a physical interface corresponding to the individual audio output.

In some embodiments, the Multi-Player Playback Device implements output identification through configurable parameters that enable precise control over the identification process. These parameters include: (i) output specification parameters that define: (i-a) which physical output to identify through a numeric index, (i-b) what type of identification sound to play through that output, and (i-c) how many times to repeat the identification sound; and (ii) visual feedback parameters that coordinate the timing between audio playback and LED indicator patterns to provide clear visual confirmation of the identified output.

In some examples, the Multi-Player Playback Device implements coordinated output testing by playing identification signals one at a time with appropriate spacing between signals. This sequential approach prevents confusion when multiple outputs are being configured in close physical proximity by ensuring clear differentiation between outputs being identified.

In certain example configurations, when implementing block 1126, the Multi-Player Playback Device validates output identification requests through: (i) verification procedures that include: (i-a) confirming the specified output index is valid for the device, (i-b) verifying the output is not currently being used for active audio playback, and (i-c) checking that the output's hardware is responding correctly before attempting identification playback; and (ii) cancellation procedures that enable stopping identification playback on a per-output basis and properly resetting the output to its previous state

Some embodiments of method 1100 additionally include block 1128 in FIG. 11D, which includes receiving the current configuration request from the computing device again.

After receiving the current configuration request again at block 1128, method 1100 advances to block 1130 in FIG. 11D, which includes using one of the APIs (e.g., the first API) to access the configuration file and transmit current configuration information to the computing device.

In some embodiments, when accessing and transmitting the configuration information at block 1128, the Multi-Player Playback Device implements a structured data retrieval process that includes: (i) gathering current configuration state information comprising: (i-a) logical player assignments, (i-b) output configurations, and (i-c) zone relationships; and (ii) formatting the configuration data into a standardized response payload that enables efficient parsing and processing by the computing device.

In some examples, the Multi-Player Playback Device keeps track of system resources during configuration retrieval through: (i) monitoring amplifier channel allocation status and utilization; (ii) tracking DSP processing resource availability; (iii) measuring memory allocation for audio buffers; and (iv) maintaining power management states for outputs and processing units. This resource tracking helps ensure the configuration remains within system capabilities.

Additionally, to maintain configuration consistency, the Multi-Player Playback Device in some embodiments also implements version tracking and caching mechanisms that: (i) maintain configuration version numbers to detect concurrent modification attempts; (ii) store local copies of valid configurations with backoff retry logic for handling network interruptions; and (iii) queue and validate configuration changes received during connectivity losses before applying them when connectivity is restored. Implementing these version tracking and caching mechanisms can be useful in scenarios where multiple configuration changes are being made simultaneously or network connectivity becomes unstable during configuration updates because it prevents configuration conflicts while enabling the system to recover gracefully from interruptions without losing configuration changes.

Before transmitting a response with the retrieved configuration information back to the computing device, the Multi-Player Playback Device in some embodiments additionally validates the response by: (i) verifying the completeness of the configuration data; (ii) validating that the response payload format matches API specifications; and (iii) including any relevant warning messages for partial or incomplete configuration states. Validating the response in this manner can be beneficial where the Multi-Player Playback Device is in a partial configuration state during system startup or recovery because it enables the computing device to identify which settings are valid and which require reconfiguration while maintaining system stability.

Some embodiments of method 1100 additionally include block 1132 in FIG. 11D, which includes receiving a second playback zone creation command from the computing device. In some instances, the second playback zone creation command comprises a playback zone identifier for a second playback zone and at least one audio output assignment.

After receiving the second playback zone creation command at block 1132, method 1100 advances to block 1134 in FIG. 11D, which includes using one of the APIs (e.g., the second API) to create a second logical player for the second playback zone.

In some embodiments, when creating the second logical player at block 1132, the Multi-Player Playback Device (e.g., via the second API) first validates the requested configuration through a series of checks including: (i) product policy verification to confirm the requested zone configuration complies with device limitations, such as maximum number of zones and supported zone type combinations; (ii) conflict detection to determine whether any requested outputs are already assigned to other zones; and (iii) hardware capability verification to confirm the device's outputs and processing resources can support the requested configuration.

After validation passes, the Multi-Player Playback Device (e.g., via the second API) implements zone creation request by: (i) initializing the logical player with appropriate settings for audio processing and playback synchronization based on the zone type; (ii) assigning the requested outputs to the logical player; and (iii) updating the configuration file to reflect the new zone with the logical player, audio output, and audio channel assignments.

Some embodiments of method 1100 additionally include block 1136 in FIG. 11E, which includes receiving a request from the computing device to add an additional audio output to the first playback zone.

After receiving the request to add an additional output at block 1136, method 1100 advances to block 1138 in FIG. 11E, which includes using one of the APIs (e.g., the fourth API) to add the audio output corresponding to the audio output assignment for the first playback zone to the first logical player.

In some embodiments, when adding the additional audio output at block 1138, the Multi-Player Playback Device (e.g., via the fourth API) first validates the addition request by: (i) verifying the requested output is not currently assigned to another zone or being used for active playback; (ii) checking that adding the output to the zone is compatible with the zone's existing configuration, such as confirming the zone type supports additional outputs and validating channel mapping options; and (iii) confirming sufficient system resources are available, including amplifier channels and processing capacity.

After validation passes, the Multi-Player Playback Device implements the output addition by: (i) updating the configuration to include the new output, including assigning the output to the logical player and mapping the appropriate audio channel based on the zone type; and (ii) coordinating the timing of configuration changes to maintain continuous audio playback through any existing outputs while the new output is being configured.

Some embodiments of method 1100 additionally include block 1140 in FIG. 11E, which includes receiving an audio output deletion request to remove a particular audio output that was previously added to the first playback zone.

After receiving the deletion request at block 1140, method 1100 advances to block 1142 in FIG. 11E, which includes using one of the APIs (e.g., the fourth API) to delete the particular audio output from the first logical player, wherein after deleting the particular audio output, it becomes available for reassignment.

In some embodiments, when deleting the particular audio output at block 1142, the Multi-Player Playback Device (e.g., via the fourth API) first validates the deletion request by: (i) verifying whether the output is currently being used for active audio playback; (ii) confirming the output is properly assigned to the first logical player; and (iii) checking that removing the output will not disrupt required zone configurations, such as minimum channel requirements for home theater zones.

After validation passes, the Multi-Player Playback Device implements the output deletion by: (i) updating the configuration file to remove the output assignment from the logical player; (ii) releasing any amplifier channels and processing resources associated with the output; and (iii) marking the output as available in the configuration file to enable reassignment to other zones.

Some embodiments of method 1100 additionally include block 1144 in FIG. 11F, which includes receiving a playback zone deletion request from the computing device.

After receiving the zone deletion request at block 1144, method 1100 advances to block 1146 in FIG. 11F, which includes using one of the APIs (e.g., a fifth API) to delete the first logical player from the configuration file. After deleting the first logical player at block 1146, the audio outputs that were assigned to the deleted first logical player become available for reassignment. An example of program code suitable for use in connection with the fifth API is shown in the Appendix to the specification as “Delete AudioPlayer.”

In some embodiments, when deleting the first logical player at block 1146, the Multi-Player Playback Device (e.g., via the fifth API) first validates the zone deletion request through several checks. First, the Multi-Player Playback Device verifies there are no active playback sessions using the logical player by checking for any ongoing media transport sessions, thereby preventing disruption of active audio playback. Second, the Multi-Player Playback Device confirms all associated thread server contexts are properly closed, which ensures any background processing tasks for that logical player are safely terminated. Third, the Multi-Player Playback Device checks that any assigned HDMI inputs or shared resources can be safely released by verifying no other logical players or zones depend on those resources. Fourth, the device validates that the device properties can be properly updated by confirming the new configuration state will not adversely impact other system configurations.

After validation passes, the Multi-Player Playback Device implements the zone deletion process. In some embodiments, the Multi-Player Playback Device implements the zone deletion process via an atomic deletion operation, meaning that all configuration changes must either complete successfully together or none of the changes will be applied. This atomic deletion approach ensures consistency by preventing partial deletions that could leave the Multi-Player Playback Device in an invalid state. In some examples, the atomic deletion operation includes: (i) removing the logical player settings from the configuration file; (ii) releasing all outputs assigned to the logical player; and (iii) updating the availability status of the released outputs to enable their reassignment to other zones and/or logical players.

In practice, the atomic deletion operation can be particularly important for zone deletion because it prevents scenarios where some resources are freed while others remain allocated, which could create configuration conflicts. For example, if the operation were not atomic, an interruption during deletion could result in some outputs being marked as available while still being assigned in the configuration file, leading to potential double-assignment of outputs which could result in operational faults. Operational faults stemming from software conflicts like double-assignment of outputs can be particularly difficult to troubleshoot. Sometimes, software conflicts may require a hard reboot of the Multi-Player Playback Device which is generally undesirable from a user standpoint because the Multi-Player Playback Device cannot play audio via any of its audio outputs during the hard reboot process even when the hard reboot may be required to reset only one of the audio outputs.

In some embodiments, the Multi-Player Playback Device additionally implements a transaction logging process during deletion operations that includes one or more of several components described in the following paragraphs. In some instances, the transaction logging process includes all of the components described in the following paragraphs.

First, the transaction logging process in some embodiments includes maintaining detailed state information in non-volatile storage, including: (i) the complete configuration state before starting the deletion operation; (ii) timestamps and identifiers for each deletion step; and (iii) the status of hardware resources being released. Maintaining the detailed state information in non-volatile storage in this manner can provide advantages in scenarios where network connectivity is lost or power interruptions occur during deletion operations because it enables the Multi-Player Playback Device to recover its configuration state and resume the deletion process when power or connectivity is restored.

Second, the transaction logging process in some examples additionally or alternatively includes implementing a rollback functionality by: (i) analyzing critical operation boundaries where configuration consistency must be maintained; (ii) identifying resource dependencies between components being modified; and (iii) marking stable system states that can serve as recovery targets. For example, analyzing critical operation boundaries is beneficial when deleting zones that share HDMI inputs or other resources because it ensures all dependent components are properly handled during deletion. Similarly, identifying resource dependencies between components being modified is advantageous where multiple zones use shared amplifier channels or processing resources because it prevents orphaned resource allocations that could prevent proper system operation. By marking stable system states in the configuration file as recovery targets, the Multi-Player Playback Device can execute a rollback procedure that restores the system to the last known good configuration if errors occur during the deletion process, including re-enabling any disabled outputs and/or re-establishing any broken HDMI connections.

Third, the transaction logging process in some examples additionally or alternatively includes tracking error conditions and execution status to enable precise state restoration if issues occur.

Method 1200 begins at block 1202, which includes maintaining a configuration file that stores a plurality of settings of the first Multi-Player Playback Device, wherein the configuration file is accessible by and editable via a set of application programming interfaces (API) implemented at the first Multi-Player Playback Device, and wherein the plurality of settings comprises, for each audio output of the first Multi-Player Playback Device, (i) whether the audio output is assigned to a logical player, and (ii) for each assigned audio output, (a) a logical player to which the audio output is assigned, (b) an audio channel assigned to the audio output, and (c) a playback zone to which the logical player is assigned.

In some embodiments, the configuration file implements a structured data format that includes: (i) unique identifiers for each logical player; (ii) channel mapping information for audio outputs; (iii) zone assignments and relationships; (iv) status indicators for each configured output; (v) hardware capability parameters; and (vi) resource allocation tracking. The configuration file may additionally be arranged to maintain a detailed version history through timestamped configuration snapshots to facilitate rollback mechanisms.

Next, method 1200 advances to block 1204, which includes receiving a current configuration request from a computing device separate from the first Multi-Player Playback Device, wherein the current configuration request includes a request for one or more of the plurality of settings of the first Multi-Player Playback Device.

Next, method 1200 proceeds to block 1206, which includes after receiving the current configuration request from the computing device at block 1204, (i) using a first API to access the configuration file, and (ii) transmitting current configuration information obtained from the configuration file to the computing device.

In some embodiments, using the first API to access the configuration file and provide current configuration information includes verifying the configuration information through: (i) state checking procedures, including configuration completeness verification and consistency validation; and (ii) response generation including generating updated configuration information.

Method 1200 next advances to block 1208, which includes receiving a home theater playback zone creation command from the computing device, wherein the home theater playback zone creation command comprises a home theater playback zone identifier for a home theater playback zone and at least a second Multi-Player Playback Device with which to create the home theater playback zone.

Next, method 1200 advances to block 1210, which includes after receiving the home theater playback zone creation command from the computing device at block 1208, using a second API to create a logical player with the second Multi-Player Playback Device for the home theater playback zone.

In some embodiments, when creating the logical player at block 1210, the Multi-Player Playback Device (e.g., via the second API) first validates the requested configuration through a series of checks including: (i) product policy verification to confirm the requested zone configuration complies with device limitations, such as maximum number of zones and supported zone type combinations; (ii) conflict detection to determine whether any requested outputs are already assigned to other zones; and (iii) hardware capability verification to confirm the device's outputs and processing resources can support the requested configuration.

Next, method 1200 advances to block 1212, which includes receiving one or more audio output assignments for the home theater playback zone from the computing device.

Method 1200 next advances to block 1214, which includes after receiving the one or more audio output assignments for the home theater playback zone from the computing device at block 1216, using a third API to associate the one or more audio outputs corresponding to the one or more audio output assignments for the home theater playback zone to the logical player for the home theater playback zone.

When implementing block 1214, the Multi-Player Playback Device additionally validates output assignments through: (i) verifying that requested outputs are available and compatible with the zone configuration, (ii) confirming sufficient system resources are available, including amplifier channels and processing capacity, and (iii) coordinating the timing of configuration changes to maintain continuous audio playback through any existing outputs while new outputs are being configured.

The Multi-Player Playback Device's ability to independently configure each audio output enables configuration changes to be implemented on a per-output basis rather than requiring reconfiguration/resetting of the entire Multi-Player Playback Device. When reconfiguring outputs assigned to one playback zone or logical player, the Multi-Player Playback Device can maintain continuous audio playback through other audio outputs assigned to other playback zones/logical players, thereby enabling audio output reconfiguration and reassignment without affecting playback of audio via other audio outputs of the Multi-Player Playback Device. This independent audio output configuration capability is particularly beneficial when the Multi-Player Playback Device has outputs assigned to multiple zones, as it enables reconfiguration of outputs assigned to one zone while maintaining uninterrupted audio playback through audio outputs assigned to other zones.

At block 1216, method 1200 includes for each of the one or more audio outputs added to the logical playback for the home theater playback zone, receiving a home theater audio channel assignment for the audio output from the computing device, and using the third API to configure the audio output to play the home theater audio channel assigned to the audio output.

In some embodiments, after configuring the audio outputs at block 1216, the Multi-Player Playback Device implements validation procedures to verify proper configuration, including: (i) confirming all required channels for the home theater configuration have been properly assigned, (ii) verifying channel assignments maintain proper spatial relationships for optimal surround sound performance, and (iii) checking that both Multi-Player Playback Devices can properly synchronize audio playback. For example, the Multi-Player Playback Device may: (i) send test signals through both devices and measure response times to verify synchronization capabilities, (ii) confirm that device-to-device communication latency meets synchronization requirements for proper home theater playback, and (iii) validate that both devices can maintain proper audio/video synchronization when processing HDMI-CEC signals.

Additionally, to maintain configuration consistency during the home theater setup process, the Multi-Player Playback Device in some embodiments implements version tracking and caching mechanisms that: (i) maintain configuration version numbers to detect concurrent modification attempts; (ii) store local copies of valid configurations with backoff retry logic for handling network interruptions; and (iii) queue and validate configuration changes received during connectivity losses before applying them when connectivity is restored.

### VII. Example Embodiments

The following section summarizes several examples. The examples (and features thereof) summarized in this section are for illustration purposes. The invention(s) disclosed and described herein are not limited to the examples summarized in this section or to any other example disclosed elsewhere herein. Any of the examples disclosed in this section, and any features of any of the examples, may be used together with each other in any combination, so long as the example (or feature(s) thereof) are not mutually exclusive. Further, any example (or feature(s) thereof) disclosed in any other section of this disclosure may be combined with any other example (or feature(s) thereof) disclosed in this section and/or any other section, in any combination, so long as the example (or feature(s) thereof) are not mutually exclusive.

### A. Graphical User Interface Examples

Example 1: A tangible, non-transitory computer-readable media comprising program instructions, wherein the program instructions, when executed by one or more processors, cause a computing device to perform functions comprising: (A) after a Multi-Player Playback Device has been added to a media playback system, receiving a command to configure the Multi-Player Playback Device via a graphical user interface, wherein the Multi-Player Playback Device comprises a plurality of independently configurable audio outputs; (B) after receiving the command to configure the Multi-Player Playback Device, displaying a plurality of selectable configuration processes within the graphical user interface, wherein each selectable configuration process, when selected, launches a different corresponding process for assigning one or more of the plurality of independently configurable audio outputs of the Multi-Player Playback Device to one or more corresponding audio channels for playing audio content within one or more playback zones of the media playback system; (C) after receiving a selection of one of the selectable configuration processes, displaying a plurality of selectable playback zones in which one or more audio outputs of the Multi-Player Playback Device are to play one or more audio channels of audio content; (D) after receiving a selection of a first playback zone, (i) obtaining configuration information comprising an identification of a set of one or more available audio outputs of the Multi-Player Playback Device, wherein each available audio output in the set of one or more available audio outputs is available for assignment to the first playback zone, and (ii) displaying the obtained set of one or more available audio outputs in the graphical user interface; and (E) after receiving a selection of one or more available audio outputs available for assignment to the first playback zone, causing the Multi-Player Playback Device to (i) implement a first logical player associated with the first playback zone, (ii) assign the selected one or more audio outputs to the first logical player, and (iii) configure the first logical player to play audio content via the selected one or more audio outputs.

Example 2: The tangible, non-transitory computer-readable media of Example 1, wherein causing the Multi-Player Playback Device to (i) create a first logical player for the first playback zone, (ii) add the selected one or more audio outputs to the first logical player, and (iii) configure the first logical player to play audio content via the selected one or more audio outputs comprises: (A) displaying a set of one or more audio channels available for assignment to each of the selected one or more audio outputs; and (B) for an individual audio output of the selected one or more audio outputs, after receiving a selection of one audio channel from the set of one or more audio channels available for assignment to one of the selected one or more audio outputs, sending one or more audio channel assignment commands to the Multi-Player Playback Device that cause the Multi-Player Playback Device to configure the individual audio output of the selected one or more audio outputs to play the selected audio channel.

Example 3: The tangible, non-transitory computer-readable media of Example 2 (individually or in combination with any other suitable preceding Example), wherein when the configuration process selected from the plurality of selectable configuration processes is a home theater configuration process, displaying the set of one or more audio channels available for assignment to each of the selected one or more audio outputs comprises displaying one or more of (i) a left front channel, (ii) a right front channel, (iii) a center front channel, (iv) a left surround channel, (v) a right surround channel, and (vi) a subwoofer channel.

Example 4: The tangible, non-transitory computer-readable media of Example 2 (individually or in combination with any other suitable preceding Example), wherein when the configuration process selected from the plurality of selectable configuration processes is a distributed audio configuration process, displaying the set of one or more audio channels available for assignment to each of the selected one or more audio outputs comprises displaying one or more of a left channel and a right channel.

Example 5: The tangible, non-transitory computer-readable media of Example 1 (individually or in combination with any other suitable preceding Example), wherein the functions further comprise: (A) after causing the Multi-Player Playback Device to (i) create a first logical player for the first playback zone, (ii) add the selected one or more audio outputs to the first logical player, and (iii) configure the first logical player to play audio content via the selected one or more audio outputs, sending a request to the Multi-Player Playback Device for an updated set of one or more audio outputs that are available for assignment to a playback zone; and (B) after receiving the updated set of one or more audio outputs that are available for assignment to a playback zone from the Multi-Player Playback Device, displaying the updated set of one or more audio outputs that are available for assignment to a playback zone, wherein the updated set of one or more audio outputs does not include individual audio outputs of the Multi-Player Playback Device that have already been assigned to the first playback zone.

Example 6: The tangible, non-transitory computer-readable media of Example 1 (individually or in combination with any other suitable preceding Example), wherein the functions further comprise after receiving a selection of an individual audio output of the one or more audio outputs available for assignment to the selected playback zone, causing the Multi-Player Playback Device to one or both (i) play an audio indication via a speaker connected to the selected individual audio output, (ii) activate an indicator light associated with a physical interface on the Multi-Player Playback Device corresponding to the selected individual audio output.

Example 7: The tangible, non-transitory computer-readable media of Example 6, wherein causing the Multi-Player Playback Device play the audio indication via the speaker connected to the selected individual audio output comprises causing the Multi-Player Playback Device to play the audio indication for a duration of time sufficient for a user to confirm which speaker is connected to the selected individual audio output.

Example 8: The tangible, non-transitory computer-readable media of Example 6 (individually or in combination with any other suitable preceding Example), wherein causing the Multi-Player Playback Device to activate the indicator light associated with the physical interface on the Multi-Player Playback Device corresponding to the selected individual audio output comprises causing the indicator light to flash on and off for a duration of time sufficient for a user to confirm which physical interface corresponds to the selected individual audio output.

Example 9: The tangible, non-transitory computer-readable media of Example 1 (individually or in combination with any other suitable preceding Example), wherein the functions comprise displaying playback zone editing options within the graphical user interface, wherein the playback zone editing options comprise one or more of (i) a first option to merge two or more previously configured playback zones into a new merged playback zone, (ii) a second option to delete a playback zone, (iii) a third option to add one or more unassigned audio outputs to an existing playback zone, and (iv) a fourth option to delete one or more assigned audio outputs from an existing playback zone.

Example 10: The tangible, non-transitory computer-readable media of Example 9 (individually or in combination with any other suitable preceding Example), wherein the functions comprise, after receiving a selection of the first option to merge two or more previously configured playback zones into a new merged playback zone: (A) displaying a list of two or more playback zones that are available to be merged into a merged playback zone; and (B) after receiving a selection of playback zones to be merged into the merged playback zone via the graphical user interface, merging the selected playback zones into the merged playback zone.

Example 11: The tangible, non-transitory computer-readable media of Example 9 (individually or in combination with any other suitable preceding Example), wherein the functions comprise, after receiving a selection of the second option to delete a playback zone: (A) displaying a list of playback zones that are available for deletion; and (B) after receiving a selection of a playback zone for deletion, de-assigning all logical players and audio outputs that had been previously assigned to the selected playback zone from the selected playback zone, wherein after de-assigning all the logical players and audio outputs that had been previously assigned to the selected playback zone from the selected playback zone, the de-assigned audio outputs are available for re-assignment to other playback zones.

Example 12: The tangible, non-transitory computer-readable media of Example 9 (individually or in combination with any other suitable preceding Example), wherein the functions comprise, after receiving a selection of the third option to add one or more unassigned audio outputs to an existing playback zone: (A) displaying a list of audio outputs that are not assigned to any playback zone; and (B) after receiving a selection of one or more unassigned audio outputs, adding the selected one or more unassigned audio outputs to a logical player associated with the existing playback zone.

Example 13: The tangible, non-transitory computer-readable media of Example 9 (individually or in combination with any other suitable preceding Example), wherein the functions comprise, after receiving a selection of the fourth option to delete one or more assigned audio outputs from an existing playback zone: (A) displaying a list of audio ports that are currently assigned to the existing playback zone; and (B) after receiving a selection of one or more audio ports that are currently assigned to the existing playback zone for deletion, removing the selected one or more audio ports from a logical player associated with the existing playback zone.

Example 14: The tangible, non-transitory computer-readable media of Example 1 (individually or in combination with any other suitable preceding Example), wherein the functions comprise: (A) displaying a list of playback devices that have been added to a media playback system, wherein for each Multi-Player Playback Device that has been added to the media playback system, the graphical user interface indicates audio outputs of the Multi-Player Playback Device that have been previously configured; (B) after receiving a selection of a Multi-Player Playback Device in the list of playback devices, displaying a prompt to selectively (i) configure unconfigured audio outputs or (ii) hide unconfigured audio outputs; (C) after receiving a selection to configure unconfigured audio outputs, (i) displaying the plurality of selectable configuration processes within the graphical user interface, wherein each selectable configuration process, when selected, launches a different corresponding process for assigning one or more of the audio outputs of the Multi-Player Playback Device to one or more corresponding audio channels for playing audio content within a playback zone, and (ii) after receiving a selection of one of the configuration processes, configuring one or more of the unconfigured audio outputs of the Multi-Player Playback Device according to the selected configuration process; and (D) after receiving a selection to hide the unconfigured audio outputs, hiding the unconfigured audio outputs within the graphical user interface.

Example 15: A tangible, non-transitory computer-readable media comprising program instructions, wherein the program instructions, when executed by one or more processors, cause a computing device to perform functions comprising: (A) after two Multi-Player Playback Devices have been added to a media playback system, receiving a command to configure the two Multi-Player Playback Devices into a single home theater playback zone via a graphical user interface, wherein each of the two Multi-Player Playback Devices comprises a plurality of independently configurable audio outputs; (B) after receiving the command to configure the two Multi-Player Playback Devices into the single home theater playback zone, displaying a plurality of selectable home theater configurations within the graphical user interface, wherein each home theater configuration has a corresponding quantity of home theater audio channels; (C) after receiving a selection of one of the home theater configurations, (i) causing creation of a logical player for the home theater configuration, and (ii) displaying a plurality of audio outputs of the two Multi-Player Playback Devices via the graphical user interface, wherein each audio output in the plurality of audio outputs is available for assignment to a corresponding home theater audio channel of the logical player for the home theater configuration; and (D) after receiving a selection of a set of audio outputs for assignment to corresponding home theater audio channels of the logical player for the home theater configuration, for each individual audio output in the set of audio outputs, (i) displaying a set of one or more home theater audio channels available for assignment to the individual audio output, and (ii) after receiving a selection of one home theater audio channel from the set of one or more home theater audio channels available for assignment to the individual audio output, assigning the selected home theater audio channel to the individual audio output.

Example 16: The tangible, non-transitory computer-readable media of Example 15, wherein after causing creation of the logical player for the home theater configuration, the functions further comprise: (A) determining a maximum number of audio channels supported by the selected home theater configuration; (B) determining a total number of available audio outputs across the two Multi-Player Playback Devices; (C) when the total number of available audio outputs is less than the maximum number of audio channels, displaying an indication that additional Multi-Player Playback Devices are required to implement all channels of the selected configuration; and (D) when the total number of available audio outputs equals or exceeds the maximum number of audio channels, proceeding with audio channel assignment.

Example 17: The tangible, non-transitory computer-readable media of Example 15 (individually or in combination with any other suitable preceding Example), wherein displaying a plurality of audio outputs of the two Multi-Player Playback Devices via the graphical user interface comprises determining whether each audio output of the two Multi-Player Playback Devices is available for assignment to the home theater configuration, and displaying only audio outputs that are determined to be available for assignment.

Example 18: The tangible, non-transitory computer-readable media of Example 15 (individually or in combination with any other suitable preceding Example), wherein after creating the logical player for the home theater configuration, the functions further comprise, after displaying a user interface screen that enables selection of specific audio channel assignments across both of the two Multi-Player Playback Devices: (A) receiving channel assignments that specify which home theater audio channels are to be output by the a Multi-Player Playback Device of the two Multi-Player Playback Devices and which home theater audio channels are to be output by a second Multi-Player Playback Device of the two Multi-Player Playback Devices; (B) after receiving selection of a home theater audio channel to be output by the first Multi-Player Playback Device, assigning that home theater audio channel to an available audio output of the first Multi-Player Playback Device; and (C) after receiving selection of a home theater audio channel to be output by the second Multi-Player Playback Device, assigning that home theater audio channel to an available audio output of the second Multi-Player Playback Device.

Example 19: A system comprising: (i) a set of one or more Multi-Player Playback Devices; and (ii) tangible, non-transitory computer-readable media comprising program instructions. IN some examples, the program instructions, when executed by one or more processors, cause a computing device to perform functions comprising: (A) after a first Multi-Player Playback Device of the set of one or more Multi-Player Playback Devices has been added to a media playback system, receiving a command to configure the first Multi-Player Playback Device via a graphical user interface, wherein the first Multi-Player Playback Device comprises a plurality of independently configurable audio outputs; (B) after receiving the command to configure the first Multi-Player Playback Device, displaying a plurality of selectable configuration processes within the graphical user interface, wherein each selectable configuration process, when selected, launches a different corresponding process for assigning one or more of the plurality of independently configurable audio outputs of the first Multi-Player Playback Device to one or more corresponding audio channels for playing audio content within one or more playback zones of the media playback system; (C) after receiving a selection of one of the selectable configuration processes, displaying a plurality of selectable playback zones in which one or more audio outputs of the first Multi-Player Playback Device are to play one or more audio channels of audio content; (D) after receiving a selection of a first playback zone, (i) obtaining configuration information comprising an identification of a set of one or more available audio outputs of the first Multi-Player Playback Device, wherein each available audio output in the set of one or more available audio outputs is available for assignment to the first playback zone, and (ii) displaying the obtained set of one or more available audio outputs in the graphical user interface; and (E) after receiving a selection of one or more available audio outputs available for assignment to the first playback zone, causing the first Multi-Player Playback Device to (i) implement a first logical player associated with the first playback zone, (ii) assign the selected one or more audio outputs to the first logical player, and (iii) configure the first logical player to play audio content via the selected one or more audio outputs.

Example 20: The system of Example 19, wherein the program instructions, when executed by the one or more processors, cause the computing device to perform functions comprising, for each additional Multi-Player Playback Device in the set of one or more Multi-Player Playback Devices: (A) after the additional Multi-Player Playback Device has been added to a media playback system, receiving a command to configure the additional Multi-Player Playback Device via a graphical user interface, wherein additional first Multi-Player Playback Device comprises a plurality of independently configurable audio outputs; (B) after receiving the command to configure the additional Multi-Player Playback Device, displaying a plurality of selectable configuration processes within the graphical user interface, wherein each selectable configuration process, when selected, launches a different corresponding process for assigning one or more of the plurality of independently configurable audio outputs of the additional Multi-Player Playback Device to one or more corresponding audio channels for playing audio content within one or more playback zones of the media playback system; (C) after receiving a selection of one of the selectable configuration processes, displaying a plurality of selectable playback zones in which one or more audio outputs of the additional Multi-Player Playback Device are to play one or more audio channels of audio content; (D) after receiving a selection of a first playback zone, (i) obtaining configuration information comprising an identification of a set of one or more available audio outputs of the additional Multi-Player Playback Device, wherein each available audio output in the set of one or more available audio outputs is available for assignment to the first playback zone, and (ii) displaying the obtained set of one or more available audio outputs in the graphical user interface; and (E) after receiving a selection of one or more available audio outputs available for assignment to the first playback zone, causing the additional Multi-Player Playback Device to (i) implement a first logical player associated with the first playback zone, (ii) assign the selected one or more audio outputs to the first logical player, and (iii) configure the first logical player to play audio content via the selected one or more audio outputs.

### B. Application Programming Interface Examples

Example 21: A tangible, non-transitory computer-readable media comprising program instructions, wherein the program instructions, when executed by one or more processors, cause a Multi-Player Playback Device to perform functions comprising: (A) maintaining a configuration file that stores a plurality of settings of the Multi-Player Playback Device, wherein the configuration file is accessible by and editable via a set of application programming interfaces (APIs) implemented at the Multi-Player Playback Device, and wherein the plurality of settings comprises, for each audio output of the Multi-Player Playback Device, (i) whether the audio output is assigned to a logical player, and (ii) for each assigned audio output, (a) a logical player to which the audio output is assigned, (b) an audio channel assigned to the audio output, and (c) a playback zone to which the logical player is assigned; (B) receiving a current configuration request from a computing device separate from the Multi-Player Playback Device, wherein the current configuration request includes a request for one or more of the plurality of settings of the Multi-Player Playback Device; (C) after receiving the current configuration request from the computing device, (i) using a first API to access the configuration file, and (ii) transmitting current configuration information obtained from the configuration file to the computing device; (D) receiving a first playback zone creation command from the computing device, wherein the first playback zone creation command comprises a playback zone identifier for a first playback zone and at least one audio output assignment; and (E) after receiving the first playback zone creation command from the computing device, using a second API to create a first logical player for the first playback zone, wherein the first logical player includes the at least one audio output assignment.

Example 22: The tangible, non-transitory computer-readable media of Example 21, wherein the functions further comprise: (A) after creating the first logical player for the first playback zone and adding the one or more audio outputs corresponding to the one or more audio output assignments for the first playback zone to the first logical player for the first playback zone, receiving the current configuration request from the computing device again; and (B) after receiving the current configuration request again, using the first API to access the configuration file, and transmitting current configuration information obtained from the configuration file to the computing device, wherein the current configuration information obtained from the configuration file comprises, for each audio output of the Multi-Player Playback Device, (i) whether the audio output is assigned to a logical player, and (ii) for each assigned audio output, (a) a logical player to which the audio output is assigned, (b) an audio channel assigned to the audio output, and (c) a playback zone to which the logical player is assigned.

Example 23: The tangible, non-transitory computer-readable media of Example 21 (individually or in combination with any other suitable preceding Example), wherein the functions further comprise: (A) receiving an unassigned audio outputs request from the computing device; and (B) after receiving the unassigned audio outputs request from the computing device, (i) using a third API to access the configuration file, and (ii) transmitting a set of one or more unassigned audio outputs to the computing device, wherein the set of one or more unassigned audio outputs identifies audio outputs of the Multi-Player Playback Device that are available for assignment to a logical player.

Example 24: The tangible, non-transitory computer-readable media of Example 21 (individually or in combination with any other suitable preceding Example), wherein the functions comprise: (A) receiving an audio channel assignment from the computing device, wherein the audio channel assignment includes data identifying an audio channel assignment for an audio output of the first logical player of the first playback zone; and (B) after receiving the audio channel assignment for the audio output, using a fourth API to configure the audio output to play the audio channel assigned to the audio output.

Example 25: The tangible, non-transitory computer-readable media of Example 24 (individually or in combination with any other suitable preceding Example), wherein, for an individual audio output, the audio channel assignment for the audio output is one of: (i) a left front channel, (ii) a right front channel, (iii) a center front channel, (iv) a left surround channel, (v) a right surround channel, (vi) a subwoofer channel, (vii) a left stereo channel, or (viii) a right stereo channel.

Example 26: The tangible, non-transitory computer-readable media of Example 21 (individually or in combination with any other suitable preceding Example), wherein the functions further comprise: (A) receiving, from the computing device, an audio output identification command for an individual audio output of the Multi-Player Playback Device; and (B) after receiving the audio output identification command, causing the Multi-Player Playback Device to one or both (i) play an audio indication via a speaker connected to the individual audio output, (ii) activate an indicator light associated with a physical interface on the Multi-Player Playback Device corresponding to the individual audio output.

Example 27: The tangible, non-transitory computer-readable media of Example 26 (individually or in combination with any other suitable preceding Example), wherein causing the Multi-Player Playback Device play the audio indication via the speaker connected to the individual audio output comprises causing the Multi-Player Playback Device to play the audio indication for a duration of time sufficient for a user to confirm which speaker is connected to the individual audio output, and wherein causing the Multi-Player Playback Device to activate the indicator light associated with the physical interface on the Multi-Player Playback Device corresponding to the individual audio output comprises causing the indicator light to flash on and off for a duration of time sufficient for a user to confirm which physical interface corresponds to the individual audio output.

Example 28: The tangible, non-transitory computer-readable media of Example 21 (individually or in combination with any other suitable preceding Example), wherein the functions comprise: (A) receiving the current configuration request from the computing device again; (B) after receiving the current configuration request again, (i) using the first API to access the configuration file, and (ii) transmitting current configuration information obtained from the configuration file to the computing device; (C) receiving a second playback zone creation command from the computing device, wherein the second playback zone creation command comprises a playback zone identifier for a second playback zone and at least one audio output assignment; and (D) after receiving the second playback zone creation command, using the second API to create a second logical player for the second playback zone, wherein the second logical player includes the at least one audio output assignment.

Example 29: The tangible, non-transitory computer-readable media of Example 21 (individually or in combination with any other suitable preceding Example), wherein the functions comprise: (A) receiving a request from the computing device to add an additional audio output to the first playback zone, wherein the request includes an audio output assignment; and (B) after receiving the request from the computing device to add the additional audio output the first playback zone, using the fourth API to add the audio output corresponding to the audio output assignment for the first playback zone to the first logical player for the first playback zone.

Example 30: The tangible, non-transitory computer-readable media of Example 21 (individually or in combination with any other suitable preceding Example), wherein the functions comprise: (A) receiving an audio output deletion request from the computing device to remove a particular audio output from the first playback zone that was previously-added to the first playback zone, wherein the audio output deletion request includes an indication of the particular audio output to be deleted from the first playback zone; and (B) after receiving the audio output deletion request from the computing device to delete the particular audio output from the first playback zone, using the fourth API to delete the particular audio output from the first logical player for the first playback zone, wherein after deleting the particular audio output from the first logical player, the particular audio output is available for reassignment.

Example 31: The tangible, non-transitory computer-readable media of Example 21 (individually or in combination with any other suitable preceding Example), wherein the functions comprise: (A) receiving a playback zone deletion request from the computing device, wherein the playback zone deletion request includes an indication of the particular playback zone to be deleted from the Multi-Player Playback Device; and (B) after receiving a request from the computing device to delete the first playback zone, using a fifth API to delete the first logical player for the first playback zone from the configuration file, wherein after deleting the first logical player for the first playback zone from the configuration file, the audio outputs of the Multi-Player Playback Device that were assigned to the deleted first logical player are available for reassignment.

Example 32: A tangible, non-transitory computer-readable media comprising program instructions, wherein the program instructions, when executed by one or more processors, cause a first Multi-Player Playback Device to perform functions comprising: (A) maintaining a configuration file that stores a plurality of settings of the first Multi-Player Playback Device, wherein the configuration file is accessible by and editable via a set of application programming interfaces (API) implemented at the first Multi-Player Playback Device, and wherein the plurality of settings comprises, for each audio output of the first Multi-Player Playback Device, (i) whether the audio output is assigned to a logical player, and (ii) for each assigned audio output, (a) a logical player to which the audio output is assigned, (b) an audio channel assigned to the audio output, and (c) a playback zone to which the logical player is assigned; (B) receiving a current configuration request from a computing device separate from the first Multi-Player Playback Device, wherein the current configuration request includes a request for one or more of the plurality of settings of the first Multi-Player Playback Device; (C) after receiving the current configuration request from the computing device, (i) using a first API to access the configuration file, and (ii) transmitting current configuration information obtained from the configuration file to the computing device; (D) receiving a home theater playback zone creation command from the computing device, wherein the home theater playback zone creation command comprises a home theater playback zone identifier for a home theater playback zone and at least a second Multi-Player Playback Device with which to create the home theater playback zone; (E) after receiving the home theater playback zone creation command from the computing device, using a second API to create a logical player with the second Multi-Player Playback Device for the home theater playback zone; (F) receiving one or more audio output assignments for the home theater playback zone from the computing device; (G) after receiving the one or more audio output assignments for the home theater playback zone from the computing device, using a third API to associate the one or more audio outputs corresponding to the one or more audio output assignments for the home theater playback zone to the logical player for the home theater playback zone; and (H) for each of the one or more audio outputs added to the logical playback for the home theater playback zone, receiving a home theater audio channel assignment for the audio output from the computing device, and using the third API to configure the audio output to play the home theater audio channel assigned to the audio output.

Example 33: A Multi-Player Playback Device comprising: (i) one or more processors; and (ii) tangible, non-transitory computer-readable media comprising program instructions. In some examples, the program instructions, when executed by the one or more processors, cause the Multi-Player Playback Device to perform functions comprising: (A) maintaining a configuration file that stores a plurality of settings of the Multi-Player Playback Device, wherein the configuration file is accessible by and editable via a set of application programming interfaces (APIs) implemented at the Multi-Player Playback Device, and wherein the plurality of settings comprises, for each audio output of the Multi-Player Playback Device, (i) whether the audio output is assigned to a logical player, and (ii) for each assigned audio output, (a) a logical player to which the audio output is assigned, (b) an audio channel assigned to the audio output, and (c) a playback zone to which the logical player is assigned; (B) receiving a current configuration request from a computing device separate from the Multi-Player Playback Device, wherein the current configuration request includes a request for one or more of the plurality of settings of the Multi-Player Playback Device; (C) after receiving the current configuration request from the computing device, (i) using a first API to access the configuration file, and (ii) transmitting current configuration information obtained from the configuration file to the computing device; (D) receiving a first playback zone creation command from the computing device, wherein the first playback zone creation command comprises a playback zone identifier for a first playback zone and at least one audio output assignment; and (E) after receiving the first playback zone creation command from the computing device, using a second API to create a first logical player for the first playback zone, wherein the first logical player includes the at least one audio output assignment.

Example 34: The Multi-Player Playback Device of Example 33, wherein the program instructions, when executed by the one or more processors, cause the Multi-Player Playback Device to perform functions comprising: (A) after creating the first logical player for the first playback zone and add the one or more audio outputs corresponding to the one or more audio output assignments for the first playback zone to the first logical player for the first playback zone, receiving the current configuration request from the computing device again; and (B) after receiving the current configuration request again, using the first API to access the configuration file, and transmitting current configuration information obtained from the configuration file to the computing device, wherein the current configuration information obtained from the configuration file comprises, for each audio output of the Multi-Player Playback Device, (i) whether the audio output is assigned to a logical player, and (ii) for each assigned audio output, (a) a logical player to which the audio output is assigned, (b) an audio channel assigned to the audio output, and (c) a playback zone to which the logical player is assigned.

Example 35: The Multi-Player Playback Device of Example 33 (individually or in combination with any other suitable preceding Example), wherein the program instructions, when executed by the one or more processors, cause the Multi-Player Playback Device to perform functions comprising: (A) receiving an unassigned audio outputs request from the computing device; and (B) after receiving the unassigned audio outputs request from the computing device, (i) using a third API to access the configuration file, and (ii) transmitting a set of one or more unassigned audio outputs to the computing device, wherein the set of one or more unassigned audio outputs identifies audio outputs of the Multi-Player Playback Device that are available for assignment to a logical player.

Example 36: The Multi-Player Playback Device of Example 33, wherein the program instructions, when executed by the one or more processors, cause the Multi-Player Playback Device to perform functions comprising: (A) receiving an audio channel assignment from the computing device, wherein the audio channel assignment includes data identifying an audio channel assignment for an audio output of the first logical player of the first playback zone; and (B) after receiving the audio channel assignment for the audio output, using a fourth API to configure the audio output to play the audio channel assigned to the audio output.

Example 37: The Multi-Player Playback Device of Example 36 (individually or in combination with any other suitable preceding Example), wherein, for an individual audio output, the audio channel assignment for the audio output is one of: (i) a left front channel, (ii) a right front channel, (iii) a center front channel, (iv) a left surround channel, (v) a right surround channel, (vi) a subwoofer channel, (vii) a left stereo channel, or (viii) a right stereo channel.

Example 38: The Multi-Player Playback Device of Example 33 (individually or in combination with any other suitable preceding Example), wherein the program instructions, when executed by the one or more processors, cause the Multi-Player Playback Device to perform functions comprising: (A) receiving, from the computing device, an audio output identification command for an individual audio output of the Multi-Player Playback Device; and (B) after receiving the audio output identification command, causing the Multi-Player Playback Device to one or both (i) play an audio indication via a speaker connected to the individual audio output, (ii) activate an indicator light associated with a physical interface on the Multi-Player Playback Device corresponding to the individual audio output.

Example 39: The Multi-Player Playback Device of Example 38 (individually or in combination with any other suitable preceding Example), wherein causing the Multi-Player Playback Device play the audio indication via the speaker connected to the individual audio output comprises causing the Multi-Player Playback Device to play the audio indication for a duration of time sufficient for a user to confirm which speaker is connected to the individual audio output, and wherein causing the Multi-Player Playback Device to activate the indicator light associated with the physical interface on the Multi-Player Playback Device corresponding to the individual audio output comprises causing the indicator light to flash on and off for a duration of time sufficient for a user to confirm which physical interface corresponds to the individual audio output.

Example 40: The Multi-Player Playback Device of Example 33 (individually or in combination with any other suitable preceding Example), wherein the program instructions, when executed by the one or more processors, cause the Multi-Player Playback Device to perform functions comprising: (A) receiving the current configuration request from the computing device again; (B) after receiving the current configuration request again, (i) using the first API to access the configuration file, and (ii) transmitting current configuration information obtained from the configuration file to the computing device; (C) receiving a second playback zone creation command from the computing device, wherein the second playback zone creation command comprises a playback zone identifier for a second playback zone and at least one audio output assignment; and (D) after receiving the second playback zone creation command, using the second API to create a second logical player for the second playback zone, wherein the second logical player includes the at least one audio output assignment.

Example 41: The Multi-Player Playback Device of Example 33 (individually or in combination with any other suitable preceding Example), wherein the program instructions, when executed by the one or more processors, cause the Multi-Player Playback Device to perform functions comprising: (A) receiving a request from the computing device to add an additional audio output to the first playback zone, wherein the request includes an audio output assignment; and (B) after receiving the request from the computing device to add the additional audio output the first playback zone, using the fourth API to add the audio output corresponding to the audio output assignment for the first playback zone to the first logical player for the first playback zone.

Example 42: The Multi-Player Playback Device of Example 33 (individually or in combination with any other suitable preceding Example), wherein the program instructions, when executed by the one or more processors, cause the Multi-Player Playback Device to perform functions comprising: (A) receiving an audio output deletion request from the computing device to remove a particular audio output from the first playback zone that was previously-added to the first playback zone, wherein the audio output deletion request includes an indication of the particular audio output to be deleted from the first playback zone; and (B) after receiving the audio output deletion request from the computing device to delete the particular audio output from the first playback zone, using the fourth API to delete the particular audio output from the first logical player for the first playback zone, wherein after deleting the particular audio output from the first logical player, the particular audio output is available for reassignment.

Example 43: The Multi-Player Playback Device of Example 33 (individually or in combination with any other suitable preceding Example), wherein the program instructions, when executed by the one or more processors, cause the Multi-Player Playback Device to perform functions comprising: (A) receiving a playback zone deletion request from the computing device, wherein the playback zone deletion request includes an indication of the particular playback zone to be deleted from the Multi-Player Playback Device; and (B) after receiving a request from the computing device to delete the first playback zone, using a fifth API to delete the first logical player for the first playback zone from the configuration file, wherein after deleting the first logical player for the first playback zone from the configuration file, the audio outputs of the Multi-Player Playback Device that were assigned to the deleted first logical player are available for reassignment.

### VIII. Conclusions

The above discussions relating to Multi-Player Playback Devices, playback devices, controller devices, playback zone configurations, and media/audio content sources provide only some examples of operating environments within which functions and methods described below may be implemented. Other operating environments and configurations of media playback systems, Multi-Player Playback Devices, playback devices, and network devices not explicitly described herein may also be applicable and suitable for implementation of the functions and methods.

The description above discloses, among other things, various example systems, methods, apparatus, and articles of manufacture including, among other components, firmware and/or software executed on hardware. It is understood that such examples are merely illustrative and should not be considered as limiting. For example, it is contemplated that any or all of the firmware, hardware, and/or software aspects or components can be embodied exclusively in hardware, exclusively in software, exclusively in firmware, or in any combination of hardware, software, and/or firmware. Accordingly, the examples provided are not the only ways) to implement such systems, methods, apparatus, and/or articles of manufacture.

Additionally, references herein to “embodiment” means that a particular feature, structure, or characteristic described in connection with the embodiment can be included in at least one example embodiment of an invention. The appearances of this phrase in various places in the specification are not necessarily all referring to the same embodiment, nor are separate or alternative example configurations mutually exclusive of other example configurations. As such, the example configurations described herein, explicitly and implicitly understood by one skilled in the art, can be combined with other example configurations.

The specification is presented largely in terms of illustrative environments, systems, procedures, steps, logic blocks, processing, and other symbolic representations that directly or indirectly resemble the operations of data processing devices coupled to networks. These process descriptions and representations are typically used by those skilled in the art to most effectively convey the substance of their work to others skilled in the art. Numerous specific details are set forth to provide a thorough understanding of the present disclosure. However, it is understood to those skilled in the art that certain example configurations of the present disclosure can be practiced without certain, specific details. In other instances, well known methods, procedures, components, and circuitry have not been described in detail to avoid unnecessarily obscuring aspects of the example configurations. Accordingly, the scope of the present disclosure is defined by the appended claims rather than the foregoing description of example configurations.

When any of the appended claims are read to cover a purely software and/or firmware implementation, at least one of the elements in at least one example is hereby expressly defined to include a tangible, non-transitory medium such as a memory, DVD, CD, Blu-ray, and so on, storing the software and/or firmware.

What is claimed is:

1. A Multi-Player Playback Device comprising:
one or more processors; and
tangible, non-transitory computer-readable media comprising program instructions, wherein the program instructions, when executed by the one or more processors, cause the Multi-Player Playback Device to perform functions comprising:
maintaining a configuration file that stores a plurality of settings of the Multi-Player Playback Device, wherein the configuration file is accessible by and editable via a set of application programming interfaces (APIs) implemented at the Multi-Player Playback Device, and wherein the plurality of settings comprises, for each audio output of the Multi-Player Playback Device, (i) whether the audio output is assigned to a logical player, and (ii) for each assigned audio output, (a) a logical player to which the audio output is assigned, (b) an audio channel assigned to the audio output, and (c) a playback zone to which the logical player is assigned;
receiving a current configuration request from a computing device separate from the Multi-Player Playback Device, wherein the current configuration request includes a request for one or more of the plurality of settings of the Multi-Player Playback Device;
after receiving the current configuration request from the computing device, (i) using a first API to access the configuration file, and (ii) transmitting current configuration information obtained from the configuration file to the computing device;
receiving a first playback zone creation command from the computing device, wherein the first playback zone creation command comprises a playback zone identifier for a first playback zone and at least one audio output assignment;
after receiving the first playback zone creation command from the computing device, using a second API to create a first logical player for the first playback zone, wherein the first logical player includes the at least one audio output assignment.

2. The Multi-Player Playback Device of claim 1, wherein the program instructions, when executed by the one or more processors, cause the Multi-Player Playback Device to perform functions comprising:
after creating the first logical player for the first playback zone and adding one or more audio outputs corresponding to one or more audio output assignments for the first playback zone to the first logical player for the first playback zone, receiving the current configuration request from the computing device again; and
after receiving the current configuration request again, using the first API to access the configuration file, and transmitting current configuration information obtained from the configuration file to the computing device, wherein the current configuration information obtained from the configuration file comprises, for each audio output of the Multi-Player Playback Device, (i) whether the audio output is assigned to a logical player, and (ii) for each assigned audio output, (a) a logical player to which the audio output is assigned, (b) an audio channel assigned to the audio output, and (c) a playback zone to which the logical player is assigned.

3. The Multi-Player Playback Device of claim 1, wherein the program instructions, when executed by the one or more processors, cause the Multi-Player Playback Device to perform functions comprising:
receiving an unassigned audio outputs request from the computing device; and
after receiving the unassigned audio outputs request from the computing device, (i) using a third API to access the configuration file, and (ii) transmitting a set of one or more unassigned audio outputs to the computing device, wherein the set of one or more unassigned audio outputs identifies audio outputs of the Multi-Player Playback Device that are available for assignment to a logical player.

4. The Multi-Player Playback Device of claim 1, wherein the program instructions, when executed by the one or more processors, cause the Multi-Player Playback Device to perform functions comprising:
receiving an audio channel assignment from the computing device, wherein the audio channel assignment includes data identifying an audio channel assignment for an audio output of the first logical player of the first playback zone; and
after receiving the audio channel assignment for the audio output, using a fourth API to configure the audio output to play the audio channel assigned to the audio output.

5. The Multi-Player Playback Device of claim 4, wherein, for an individual audio output, the audio channel assignment for the audio output is one of: (i) a left front channel, (ii) a right front channel, (iii) a center front channel, (iv) a left surround channel, (v) a right surround channel, (vi) a subwoofer channel, (vii) a left stereo channel, or (viii) a right stereo channel.

6. The Multi-Player Playback Device of claim 1, wherein the program instructions, when executed by the one or more processors, cause the Multi-Player Playback Device to perform functions comprising:
receiving, from the computing device, an audio output identification command for an individual audio output of the Multi-Player Playback Device; and
after receiving the audio output identification command, causing the Multi-Player Playback Device to one or both (i) play an audio indication via a speaker connected to the individual audio output, (ii) activate an indicator light associated with a physical interface on the Multi-Player Playback Device corresponding to the individual audio output.

7. The Multi-Player Playback Device of claim 1, wherein the program instructions, when executed by the one or more processors, cause the Multi-Player Playback Device to perform functions comprising:
receiving the current configuration request from the computing device again;
after receiving the current configuration request again, (i) using the first API to access the configuration file, and (ii) transmitting current configuration information obtained from the configuration file to the computing device;
receiving a second playback zone creation command from the computing device, wherein the second playback zone creation command comprises a playback zone identifier for a second playback zone and at least one audio output assignment;
after receiving the second playback zone creation command, using the second API to create a second logical player for the second playback zone, wherein the second logical player includes the at least one audio output assignment.

8. The Multi-Player Playback Device of claim 1, wherein the program instructions, when executed by the one or more processors, cause the Multi-Player Playback Device to perform functions comprising:
receiving a request from the computing device to add an additional audio output to the first playback zone, wherein the request includes an audio output assignment; and
after receiving the request from the computing device to add the additional audio output the first playback zone, using a fourth API to add an audio output corresponding to the audio output assignment for the first playback zone to the first logical player for the first playback zone.

9. The Multi-Player Playback Device of claim 8, wherein the program instructions, when executed by the one or more processors, cause the Multi-Player Playback Device to perform functions comprising:
receiving an audio output deletion request from the computing device to remove a particular audio output from the first playback zone that was previously-added to the first playback zone, wherein the audio output deletion request includes an indication of the particular audio output to be deleted from the first playback zone; and
after receiving the audio output deletion request from the computing device to delete the particular audio output from the first playback zone, using the fourth API to delete the particular audio output from the first logical player for the first playback zone, wherein after deleting the particular audio output from the first logical player, the particular audio output is available for reassignment.

10. The Multi-Player Playback Device of claim 1, wherein the program instructions, when executed by the one or more processors, cause the Multi-Player Playback Device to perform functions comprising:
receiving a playback zone deletion request from the computing device, wherein the playback zone deletion request includes an indication of a particular playback zone to be deleted from the Multi-Player Playback Device; and
after receiving a request from the computing device to delete the first playback zone, using a fifth API to delete the first logical player for the first playback zone from the configuration file, wherein after deleting the first logical player for the first playback zone from the configuration file, the audio outputs of the Multi-Player Playback Device that were assigned to the deleted first logical player are available for reassignment.

11. A tangible, non-transitory computer-readable media comprising program instructions, wherein the program instructions, when executed by one or more processors, cause a Multi-Player Playback Device to perform functions comprising:
maintaining a configuration file that stores a plurality of settings of the Multi-Player Playback Device, wherein the configuration file is accessible by and editable via a set of application programming interfaces (APIs) implemented at the Multi-Player Playback Device, and wherein the plurality of settings comprises, for each audio output of the Multi-Player Playback Device, (i) whether the audio output is assigned to a logical player, and (ii) for each assigned audio output, (a) a logical player to which the audio output is assigned, (b) an audio channel assigned to the audio output, and (c) a playback zone to which the logical player is assigned;
receiving a current configuration request from a computing device separate from the Multi-Player Playback Device, wherein the current configuration request includes a request for one or more of the plurality of settings of the Multi-Player Playback Device;
after receiving the current configuration request from the computing device, (i) using a first API to access the configuration file, and (ii) transmitting current configuration information obtained from the configuration file to the computing device;
receiving a first playback zone creation command from the computing device, wherein the first playback zone creation command comprises a playback zone identifier for a first playback zone and at least one audio output assignment;
after receiving the first playback zone creation command from the computing device, using a second API to create a first logical player for the first playback zone, wherein the first logical player includes the at least one audio output assignment.

12. The tangible, non-transitory computer-readable media of claim 11, wherein the functions further comprise:
after creating the first logical player for the first playback zone and adding one or more audio outputs corresponding to one or more audio output assignments for the first playback zone to the first logical player for the first playback zone, receiving the current configuration request from the computing device again; and
after receiving the current configuration request again, using the first API to access the configuration file, and transmitting current configuration information obtained from the configuration file to the computing device, wherein the current configuration information obtained from the configuration file comprises, for each audio output of the Multi-Player Playback Device, (i) whether the audio output is assigned to a logical player, and (ii) for each assigned audio output, (a) a logical player to which the audio output is assigned, (b) an audio channel assigned to the audio output, and (c) a playback zone to which the logical player is assigned.

13. The tangible, non-transitory computer-readable media of claim 11, wherein the functions further comprise:
receiving an unassigned audio outputs request from the computing device; and
after receiving the unassigned audio outputs request from the computing device, (i) using a third API to access the configuration file, and (ii) transmitting a set of one or more unassigned audio outputs to the computing device, wherein the set of one or more unassigned audio outputs identifies audio outputs of the Multi-Player Playback Device that are available for assignment to a logical player.

14. The tangible, non-transitory computer-readable media of claim 11, wherein the functions comprise:
receiving an audio channel assignment from the computing device, wherein the audio channel assignment includes data identifying an audio channel assignment for an audio output of the first logical player of the first playback zone; and
after receiving the audio channel assignment for the audio output, using a fourth API to configure the audio output to play the audio channel assigned to the audio output.

15. The tangible, non-transitory computer-readable media of claim 11, wherein the functions further comprise:
receiving, from the computing device, an audio output identification command for an individual audio output of the Multi-Player Playback Device; and
after receiving the audio output identification command, causing the Multi-Player Playback Device to one or both (i) play an audio indication via a speaker connected to the individual audio output, (ii) activate an indicator light associated with a physical interface on the Multi-Player Playback Device corresponding to the individual audio output.

16. The tangible, non-transitory computer-readable media of claim 11, wherein the functions comprise:
receiving the current configuration request from the computing device again;
after receiving the current configuration request again, (i) using the first API to access the configuration file, and (ii) transmitting current configuration information obtained from the configuration file to the computing device;
receiving a second playback zone creation command from the computing device, wherein the second playback zone creation command comprises a playback zone identifier for a second playback zone and at least one audio output assignment;
after receiving the second playback zone creation command, using the second API to create a second logical player for the second playback zone, wherein the second logical player includes the at least one audio output assignment.

17. The tangible, non-transitory computer-readable media of claim 11, wherein the functions comprise:
receiving a request from the computing device to add an additional audio output to the first playback zone, wherein the request includes an audio output assignment; and
after receiving the request from the computing device to add the additional audio output the first playback zone, using a fourth API to add the audio output corresponding to the audio output assignment for the first playback zone to the first logical player for the first playback zone.

18. The tangible, non-transitory computer-readable media of claim 17, wherein the functions comprise:
receiving an audio output deletion request from the computing device to remove a particular audio output from the first playback zone that was previously-added to the first playback zone, wherein the audio output deletion request includes an indication of the particular audio output to be deleted from the first playback zone; and
after receiving the audio output deletion request from the computing device to delete the particular audio output from the first playback zone, using the fourth API to delete the particular audio output from the first logical player for the first playback zone, wherein after deleting the particular audio output from the first logical player, the particular audio output is available for reassignment.

19. The tangible, non-transitory computer-readable media of claim 11, wherein the functions comprise:
receiving a playback zone deletion request from the computing device, wherein the playback zone deletion request includes an indication of a particular playback zone to be deleted from the Multi-Player Playback Device; and
after receiving a request from the computing device to delete the first playback zone, using a fifth API to delete the first logical player for the first playback zone from the configuration file, wherein after deleting the first logical player for the first playback zone from the configuration file, the audio outputs of the Multi-Player Playback Device that were assigned to the deleted first logical player are available for reassignment.

20. A tangible, non-transitory computer-readable media comprising program instructions, wherein the program instructions, when executed by one or more processors, cause a first Multi-Player Playback Device to perform functions comprising:
maintaining a configuration file that stores a plurality of settings of the first Multi-Player Playback Device, wherein the configuration file is accessible by and editable via a set of application programming interfaces (API) implemented at the first Multi-Player Playback Device, and wherein the plurality of settings comprises, for each audio output of the first Multi-Player Playback Device, (i) whether the audio output is assigned to a logical player, and (ii) for each assigned audio output, (a) a logical player to which the audio output is assigned, (b) an audio channel assigned to the audio output, and (c) a playback zone to which the logical player is assigned;
receiving a current configuration request from a computing device separate from the first Multi-Player Playback Device, wherein the current configuration request includes a request for one or more of the plurality of settings of the first Multi-Player Playback Device;
after receiving the current configuration request from the computing device, (i) using a first API to access the configuration file, and (ii) transmitting current configuration information obtained from the configuration file to the computing device;
receiving a home theater playback zone creation command from the computing device, wherein the home theater playback zone creation command comprises a home theater playback zone identifier for a home theater playback zone and at least a second Multi-Player Playback Device with which to create the home theater playback zone;
after receiving the home theater playback zone creation command from the computing device, using a second API to create a logical player with the second Multi-Player Playback Device for the home theater playback zone;
receiving one or more audio output assignments for the home theater playback zone from the computing device;
after receiving the one or more audio output assignments for the home theater playback zone from the computing device, using a third API to associate one or more audio outputs corresponding to the one or more audio output assignments for the home theater playback zone to the logical player for the home theater playback zone; and
for each of the one or more audio outputs added to the logical playback for the home theater playback zone, receiving a home theater audio channel assignment for the audio output from the computing device, and using the third API to configure the audio output to play the home theater audio channel assigned to the audio output.
